(19) United States
(12) Patent Application Publication
(10) Pub. No.: US 2015/0135261 A1
(43) Pub. Date: May 14, 2015

(54) RELATIONSHIP BASED INFORMATION SHARING CONTROL SYSTEM AND METHOD OF USE

(71) Applicant: BOARD OF REGENTS OF THE UNIVERSITY OF TEXAS SYSTEM

(72) Inventors: Jae Hong Park, Helotes, TX (US); Ravinderpal Singh Sandhu, Helotes, TX (US); Yuan Cheng, San Antonio, TX (US)

(21) Appl. No.: 14/328,682

(22) Filed: Jul. 10, 2014

Related U.S. Application Data
(60) Provisional application No. 61/844,823, filed on Jul. 10, 2013.

(51) Int. Cl. H04L 29/06

(52) U.S. Cl. CPC H04L 63/10; H04L 63/08; H04L 63/20
USPC 726/1; 726/4

(57) ABSTRACT

User-to-user (U2U) relationship-based access control has become the most prevalent approach for modeling access control in online social networks (OSNs), where authorization is typically made by tracking the existence of a U2U relationship of particular type and/or depth between the accessing user and the resource owner. However, today's OSN applications allow various user activities that cannot be controlled by using U2U relationships alone. Disclosed herein is a relationship-based access control model for OSNs that incorporates not only U2U relationships but also user-to-resource (U2R) and resource-to-resource (R2R) relationships. Furthermore, while most access control approaches for OSNs only focus on controlling users' normal usage activities, disclosed herein is a model that also captures controls on users' administrative activities. Authorization policies are defined in terms of patterns of relationship paths on social graph and the hopcount limits of these paths.

### CROSS-REFERENCE TO RELATED APPLICATIONS

This application claims the benefit under Title 35 United States Code §119(e) of U.S. Provisional Patent Application Ser. No. 61/844,823; Filed: Jul. 10, 2013, the full disclosure of which is incorporated herein by reference.

### STATEMENT REGARDING FEDERALLY SPONSORED RESEARCH OR DEVELOPMENT

This invention was made with government support under grant nos. 0831452, CNS-1111925, and CNS-0831452 awarded by the National Science Foundation. The government has certain rights in the invention.

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a system and method of use directed to an information sharing control system. More specifically, the present invention relates to a system and method of use for a user-to-user, user-to-resource, and resource-to-resource relationship-based access system and method of use.

### BRIEF SUMMARY OF THE INVENTION

Access control in OSNs presents several unique characteristics different from traditional access control. In mandatory and role-based access control, a system-wide access control policy is typically specified by the security administrator. In discretionary access control, the resource owner defines access control policy. However, in OSN systems, users may want to regulate access to their resources and activities related to themselves, thus access in OSNs is subject to user-specified policies. Other than the resource owner, some related users (e.g., user tagged in a photo owned by another user, parent of a user) may also expect some control on how the resource or user can be exposed. To prevent users from accessing unwanted or inappropriate contents, user-specified policies that regulate how a user accesses information need to be considered in authorization as well. Thus, the system needs to collect these individualized partial policies, from both the accessing users and the target users, along with the system-specified policies and fuse them for the overall control decision.

In OSN, access to resources is typically controlled based on the relationships between the accessing user and the controlling user of the target found on the social graph. This type of relationship-based access control [10] takes into account the existence of a particular relationship or a particular sequence of relationships between users and expresses access control policies in terms of such user-to-user (U2U) relationships.

Facebook-like systems allow users to specify access control policy to related resources based on topology of the social graph, by choosing options such as “public”, “private”, “friend” or “friend of friend”. Circles in Google+ allow users to create customized relationships. In recent years, researchers have proposed more advanced relationship-based access control models, such as [1-9, 11]. Policies in [1-6, 8, 9] can be composed of multiple types of relationships. [4-6] also adopt the depth and the trust value of relationship to control the spread of information. Although only having the “friend” relationship type, [7] provides additional topology-based policies, such as known quantity, common friends and stranger of more than k distance. While these works have their own advantages, one of the common drawbacks they share is that they do not allow different relationship types and multiple possible types on each hop.

Contained herein is a novel user-to-user relationship-based access control (UURAC) model and a regular expression-based policy specification language which enable more sophisticated and fine-grained access control in OSNs. This is the first relationship-based access control model for OSNs with such capability.

### BACKGROUND OF THE INVENTION

Motivation and Related Work

This section discusses characteristics of access control in OSNs, related works, and differentiates disclosed herein unique approach and contributions.

Characteristics of Access Control for OSNs

Below, is discussed some essential characteristics [13, 14] that need to be supported in access control solutions for OSN systems.

Policy Individualization. OSN users may want to express their own preferences on how their own or related contents should be exposed. A system-wide access control policy such as found in mandatory and role-based access control, does not meet this need. Access control in OSNs further differs from discretionary access control in that users other than the resource owner are also allowed to configure the policies of the related resource. In addition, users who are related to the accessing user, e.g. parent to child, may want to control the accessing user's actions. Therefore, the OSN system needs to collectively utilize these individualized policies from users related to the accessing user or the target, along with the system-specified policies for control decisions.

User and Resource as a Target. Unlike traditional user access where the access is against target resource, activities such as poking and friend recommendations are performed against other users. User as a target is particularly crucial for access control in OSNs since policies for users can specify rules for incoming actions as well as outgoing actions.

User Policies for Outgoing and Incoming Actions. Notification of particular friends' activities could be bothersome and a user may want to block it. This type of policy is captured as incoming action policy. Also, a user may want to control her own or other users' activities. For example, a user may restrict her own access from any violent contents or a parent may not want her child to invite her coworker as a friend. This type of policy is captured as an outgoing action policy. In OSN, it is necessary to support policies for both types of actions.

Necessity for Relationship-based Access Control. Access control in OSNs is mainly based on relationships among users and resources. For example, only Alice's direct friends can access her blogs, or only user who owns the photo or tagged users can modify the caption of the photo. Depth is another significant parameter, since people tend to share resources with closer users (e.g., “friend”, or “friend of friend”).

Prior Access Control Models for OSNs

Fong et al [7] developed a formal algebraic model for access control in Facebook-like systems. This model generalizes the Facebook-style access control mechanism into two stages: reaching the search listing of the resource owner and accessing the resource. The model formalizes policies for accessing resources as well as policies for search, traversal and communications. The policy vocabulary supports expressing arbitrary topology-based properties, such as “k common friends” and “k clique”, which are beyond what Facebook offers.

In [8], Fong proposed a formal model for social computing applications, in which authorization decisions are based on the user-to-user relationships. This model employs a modal logic language for policy specification. Fong et al extended the policy language and formally characterized its expressiveness power [9]. In contrast to [7], this model allows multiple relationship types and directional relationships. Relationships and authorizations are articulated in access contexts and context hierarchy to support sharing of relationships among contexts. Bruns et al [1] later improved [8, 9] by using hybrid logic to enable better efficiency in policy evaluation and greater flexibility of atomic formulas.

Carminati et al [4-6] proposed a series of access control solutions for OSNs where the access rules are specified by the users at their discretion. The access requirements that the accessing user must satisfy are specified as type, depth, and trust metrics of the user-to-user relationships between the accessing user and the resource owner. The system features a centralized certificate authority that asserts the validity of the relationship path, while access control enforcement is carried out on decentralized user side.

In [2, 3], an access control model for OSNs is proposed by Carminati et al by utilizing semantic web technologies. Unlike many other works, this model exhibits different relationships between users and resources. It defines three kinds of access policies with the Web Ontology Language (OWL) and the Semantic Web Rule Language (SWRL), namely authorization, administration and filtering policies. Similar to [2, 3], Masoumzadeh et al [12] proposed ontology-based social network access control. Their model captures delegation of authority and empowers both users and the system to express finer-grained access control policies.

Comparison of Access Control Models for OSNs

The first four columns of Table 1 summarize the salient characteristics of the models discussed above. The fifth column gives these characteristics for the new UURAC model.

All the models deal only with U2U relationships, except [2, 3] also recognize U2R (user-to-resource) relationships explicitly. U2R relationships can be captured implicitly via U2U with the last hop being U2R.

TABLE 1
Comparison of Access Control Models for OSNs

| | | | Carminati | Carminati | |
|---|---|---|---|---|---|
| | Fong [7] | Fong [8, 9] | [6] | [2, 3] | UURAC |
| Relationship Category | | | | | |
| Multiple: Relationship Types | | ✓ | ✓ | ✓ | ✓ |
| Directional Relationship | | ✓ | ✓ | | ✓ |
| U2U Relationship | ✓ | ✓ | ✓ | ✓ | ✓ |
| U2R Relationship | | | | ✓ | |
| Model Characteristics | | | | | |
| Policy Individualization | ✓ | ✓ | ✓ | ✓ | ✓ |
| User & Resource as a Target | | | | (partial) | ✓ |
| Outgoing/Incoming Action Policy | | | | (partial) | ✓ |
| Relationship Composition | | | | | |
| Relationship Depth | 0 to 2 | 0 to n | 1 to n | 1 to n | 0 to n |
| Relationship Composition | f, f of f | exact type | path of | exact type | path pattern of |
| | | sequence | same type | sequence | different types |

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 are the model components of the relationship-based information sharing control system in accordance with embodiments of the disclosure;

FIG. 2 is the access control policy taxonomy of the relationship-based information sharing control system in accordance with embodiments of the disclosure;

FIG. 3 is a sample social graph in accordance with embodiments of the disclosure;

FIG. 4 is a DFA of the relationship-based information sharing control system in accordance with embodiments of the disclosure;

FIG. 5 is access of OSNs in accordance with embodiments of the disclosure;

FIG. 6 are the model components of the relationship-based information sharing control system in accordance with embodiments of the disclosure;

FIG. 7 is a sample social graph in accordance with embodiments of the disclosure;

FIG. 8 is a typical OSN architecture with TPA of current social networking platforms.

FIG. 9 is an architecture of the relationship-based information sharing control system in accordance with embodiments of the disclosure;

FIG. 10 is a physical system architecture of the relationship-based information sharing control system in accordance with embodiments of the disclosure;

FIG. 11 are the model components of the relationship-based information sharing control system in accordance with embodiments of the disclosure;

FIG. 12a is experiment 1: BFS vs DFS on hopcount in accordance with embodiments of the disclosure;

FIG. 12b is experiment 1: BFS vs DFS on hopcount in accordance with embodiments of the disclosure;

FIG. 12c is experiment 1: BFS vs DFS on hopcount in accordance with embodiments of the disclosure;

FIG. 13a is experiment 2: BFS vs DFS on node degree in accordance with embodiments of the disclosure;

FIG. 13b is experiment 2: BFS vs DFS on node degree in accordance with embodiments of the disclosure;

FIG. 13c is experiment 2: BFS vs DFS on node degree in accordance with embodiments of the disclosure;

FIG. 13d is experiment 2: BFS vs DFS on node degree in accordance with embodiments of the disclosure.

### DETAILED DESCRIPTION OF THE INVENTION

Developed and described herein is a novel UURAC model for OSNs, using regular expression notation. UURAC supports policy individualization, user and resource as a target, distinction of user policies for outgoing and incoming actions, and relationship-based access control. It incorporates greater generality of path patterns in its policy specifications than prior models, including the incorporation of inverse relationships. Also provided is an effective path checking algorithm for access control policy evaluation, along with proofs of correctness and complexity analysis. The numerous innovative teachings of the present invention will be described with particular reference to several embodiments (by way of example, and not of limitation).

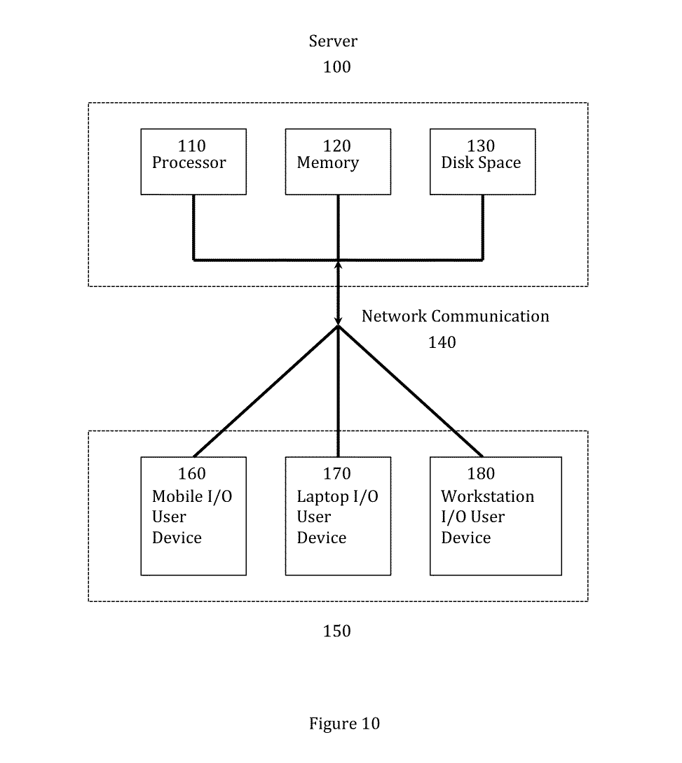

Reference is first made to FIG. 10, a system architecture diagram of the relationship-based information sharing control system in accordance with embodiments of the disclosure. The system described may be implemented on various system architectures such as but not limited to a client, client-server, and cloud architectures. One embodiment is presented in FIG. 10.

In one embodiment, the system and method of use for a relationship-based information sharing control system is comprised of a server or computing device 100, a network 140, and a user input/output (I/O) graphical user interface (GUI) or user device 150.

The server or computing device 100 is configured and comprised of the essential components needed for storing and managing the relationship based information sharing control models and policies as will be described shortly. Some of the items residing on the server may be comprised of but not limited to a processor 110, transitory computer readable storage medium 120, and non-transitory computer readable storage medium 130. Software or machine instructions also reside on the server or computing device 100 for processing and analyzing information to store, process, and enforce the relationship based sharing control models, policies, and algorithms.

The system utilizes a network 140 for communicating between components which may be wired or wireless. The user I/O interfaces or user devices 150 may be any interface which allows the user to interact with the relationship-based information sharing control system. These I/O interfaces or user devices 150 may be a workstation, laptop, mobile device, or any device allowing a user to interact with the system. By interact we mean the components 100, 150 are able to communicate with each other as an example and not a limitation, action requests and responses. The user I/O interfaces or user devices 150 may also be comprised of a local copy of the relationship-based information sharing control models, policies, and algorithms which can utilized locally in case of a network communications failure. Should a network communications failure occur, the user I/O device or user interface 150 may be configured to operate and function locally until network communications are restored.

In other embodiments, the system all resides on one computing device or I/O device. In another embodiment, the system may be partitioned to house the models and policies on one device and the user and resource data on another device.

UURAC Model Foundation

In this section, the foundation of UURAC including basic notations, access control model components and social graph model is described.

Basic Notations

We write Σ to denote the set of relationship type specifiers, where Σ={σ₁, σ₂, . . . , σₙ, σ₁⁻¹, σ₂⁻¹, . . . , σₙ⁻¹}. Each relationship type specifier σ is represented by a character recognizable by regular expression parser. Given a relationship type σᵢεΣ, the inverse of the relationship is σᵢ⁻¹εΣ.

We differentiate the active and passive forms of an action, denoted action and action⁻¹, respectively. If Alice pokes Bob, the action is poke from Alice's viewpoint, whereas it is poke⁻¹ from Bob's viewpoint.

Access Control Model Components

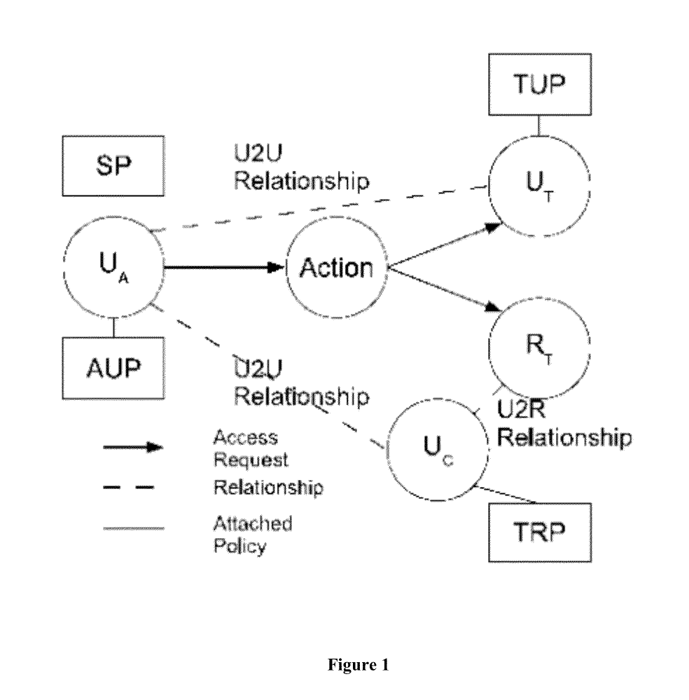

The model comprises five categories of components as shown in FIG. 1.

Accessing User (uₐ) represents a human being who performs activities. An accessing user carries access control policies and U2U relationships with other users.

Each Action is an abstract function initiated by accessing user against target. Given an action, it is action for the accessing user, but action⁻¹ for the recipient user or resource.

Target is the recipient of an action. It can be either target user (uₜ) or target resource (rₜ). Target user has her own policies and U2U relationship information, both of which are used for authorization decisions. Target resource has U2R relationship (i.e., ownership) with controlling users (u_{c}). An accessing user must have the required U2U relationships with the controlling user in order to access the target resource.

Access Request denotes an accessing user's request of a certain type of action against a target. It is modeled as a tuple <ua, action, target>, where uₐεU is the accessing user, target is the user or resource that uₐ tries to access, whereas actionεAct specifies from a finite set of supported functions in the system the type of access the user wants to have with target. If uₐ requests to interact with another user, target=uₜ, where uₜεU is the target user. If uₐ tries to access a resource owned by another user u_{c}, target is resource rₜεR where R is a finite set of resources in OSN.

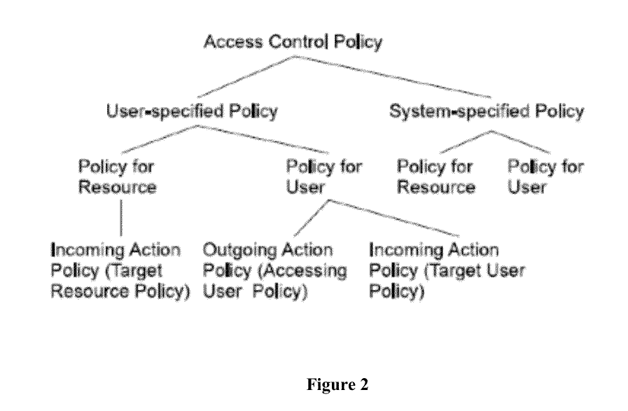

Policy defines the rules according to which authorization is regulated. As shown in FIG. 2, policies can be categorized into user-specified and system-specified policies, with respect to who defines the policies. System-specified policies (SP) are system-wide general rules enforced by the OSN system; while user-specified policies are applied to specific users and resources. Both user- and system-specified policies include policies for resources and policies for users. Policies for resources are used to control who can access a resource, while policies for users regulate how users can behave regarding an action. User-specified policies for a resource are called target resource policies (TRP), which are policies for incoming actions. User specified policies for users can be further divided into accessing user policies (AUP) and target user policies (TUP), which correspond to user's outgoing and incoming access (see examples in Section 2.1), respectively. Accessing user policies, also called outgoing action policies, are associated with the accessing user and regulate this user's outbound access. Target user policies, also called incoming action policies, control how other users can access the target user. Note that system-specified policies do not have separate policies for incoming and outgoing actions, since the accessor and target are explicitly identified.

Modeling Social Graph

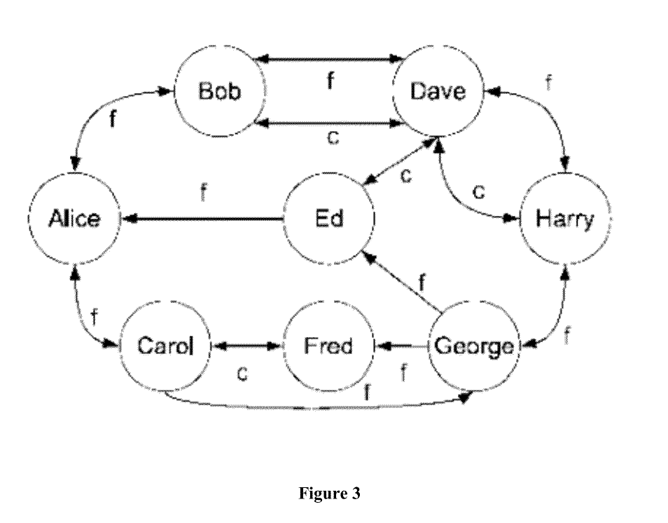

As shown in FIG. 3, an OSN forms a directed labeled simple graph¹ with nodes (or vertices) representing users and edges representing user-to-user relationships. We assume every user owns a finite set of resources and specifies access control policies for the resources and activities related to her. If an accessing user has the U2U relationship required in the policy, the accessing user will be granted permission to perform the requested action against the corresponding resource or user. ¹ A simple graph has no loops (i.e., edges which start and end on the same vertex) and no more than one edge of a given type between any two different vertices.

We model the social graph of an OSN as a triple G=<U, E, Σ>:
U is a finite set of registered users in the system, represented as nodes (or vertices) on the graph. We use the terms user and node interchangeably from now on.
Σ={σ₁, σ₂, . . . , σₙ σ₁⁻¹, σ₂⁻¹, . . . , σₙ⁻¹} denotes a finite set of relationship types, where each type specifier σ denotes a relationship type supported in the system.
E⊂U×U×Σ, denoting social graph edges, is a set of existing user relationships.

Since not all the U2U relationships in OSNs are mutual, we define the relationships E in the system as directed. For every σᵢεΣ, there is σᵢ⁻¹εΣ representing the inverse of relationship type σᵢ. We do not explicitly show the inverse relationships on the social graph, but assume the original relationship and its inverse twin always exist simultaneously. Given a user uεU, a user vεU and a relationship type σεΣ, a relationship (u, v, σ) expresses that there exists a relationship of type σ starting from user u and terminating at v. It always has an equivalent form (v, u, σ−1). G=<U, E, Σ> is required to be a simple graph.

UURAC Policy Specifications

This section defines a regular expression based policy specification language, to represent various patterns of multiple relationship types.

Path Expression Based Policy

The user relationship path in access control policies is represented by regular expressions. The formulas are based on a set Σ of relationship type specifiers. Each specification in this language describes a pattern of required relationship types between the accessing user and the target/controlling user. We use three kinds of wildcard notations that represent different occurrences of relationship types: asterisk (*) for 0 or more, plus (+) for 1 or more and question mark (?) for 0 or 1.

Graph Rule Specification and Grammar

An access control policy consists of a requested action, optional target resource and a required graph rule. In particular, graph rule is defined as (start, path rule), where start denotes the starting node of relation-ship path evaluation, whereas path rule represents a collection of path specs. Each path spec consists of a pair (path, hopcount), where path is a sequence of characters, denoting the pattern of relationship path between two users that must be satisfied, while hopcount limits the maximum number of edges on the path.

Typically, a user can specify one piece of policy for each action regard-ing a user or a resource in the system, and the path rule in the policy is composed of one or more path specs. Policies defined by different users for the same action against same target are considered as separate policies. Multiple path specs can be connected by disjunction or conjunction. For instance, a path rule (f*, 3)ν(E*, 5)ν(f c, 2), where f is friend and c is coworker, contains disjunction of three different pieces of path specs, of which one must be satisfied in order to grant access. Note that, there might be a case where only users who do not have particular types of relationships with the target are allowed to access. To allow such negative relationship-based access control, a boolean negation operator over path specs is allowed, which implies the non-existence of the specified pair of relationship type pattern path and hopcount limit hopcount following [symbol] . For example, [symbol] (f c+, 5) means the involved users should not have relationship of pattern f c+ within depth of 5 in order to get access.

TABLE 2
Grammar for graph rules

Graph Rule ::= “(” < Starting Node > “,” < Path Rule > “)”
PathRule ::= < PathSpecExp > | < PathSpecExp >< Connective >
< PathRule >
Connective ::= [symbol]
PathSpecExp ::= < PathSpec >| [symbol] < PathSpec >
PathSpec ::= “(” < Path > “,” < HopCount > “)”|“(” < EmptySet > “, ”
< Hopeount > “)”
HopCount ::= < Number >
Path ::= < TypeExp >|< TypeExp >< Path >
EmptySet ::=
TypeExp ::= < TypeSpecifier >| < TypeSpecfier >< Wildcard >
StartingNode ::= uₐ|uₜ|u_{c}
TypeSpecifier ::= σ₁|σ₂|..|σₙ|σ₁⁻¹|σ₂⁻¹|..|σₙ⁻¹|Σ where Σ = {σ₁,σ₂,..,σₙ,
σ₁⁻¹,σ₂⁻¹,..,σₙ⁻¹}
Wildcard ::= “ * ”|“?”|“ + ”
Number ::= [0 − 9]+

Each graph rule usually specifies a starting node, the required types of relationships between the starting node and the evaluating node, and the hopcount limit of such relationship path. A grammar describing the syntax of such policy language is defined in Table 2. Here, GraphRule stands for the graph rule to be evaluated. StartingNode can be either the accessing user uₐ, the target user uₜ or the controlling user u_{c}, de-noting the given node from which the required relationship path begins. Path represents a sequence of type specifiers from the starting node to the evaluating node. Path will typically be non-empty. If path is empty and hopcount=0 we assign the special meaning of “only me”. Wildcard captures the three wildcard characters, which facilitate specifying more powerful and expressive path expressions. Given a graph rule from the access control policy, this grammar specifies how to parse the expression and to extract the containing path pattern and hopcount from the expression.

User- and System-Specified Policy Specifications

User-specified policies specify how individual users want their resources or services related to them to be released to other users in the system. These policies are specific to actions against a particular resource or user. System-specified policies allow the system to specify access control on users and resources. Different from user policies, the statements in system policies are not specific to particular accessing user or target, but rather focus on the entire set of users or resources (see Table 3).

TABLE 3
Access Control Policy Representations

| | |
|---|---|
| Accessing User Policy | < action, (start, path rule)> |
| Target User Policy | < action⁻¹,(start, path rule)> |
| Target Resource Policy | < action⁻¹, rₜ, (start, path rule)> |
| System Policy for User | < action, (start, path rule)> |
| System Policy for Resource | < action, r.type, (start, path rule)> |

In accessing user policy, action denotes the requested action, whereas (start, path rule) expresses the graph rule. Similarly, action⁻¹ in target user policy and target resource policy is the passive form of the corresponding action applied to target user. Target resource policy contains an extra parameter rₜ, representing the resource to be accessed.

Considered herein are only U2U relationships in policy specification. In general, there could be one or more controlling users who have certain types of U2R relationships with the resource and possess policies for the corresponding target resource. For simplicity, we assume the only such U2R relationship is ownership. To access the resource, the accessing user must have the required relationships with the controlling user. The policies associated with the controlling users are defined on the basis of per action per resource. For instance, when querying read access request on rₜ, owner (rₜ) returns the list of users who have ownership with rt. Access to rₜ is under the authority of all the controlling users who have read policies for rₜ. Note that herein we are not introducing the policy administration model, so who can specify the policy is not discussed.

System-specified policies do not differentiate the active and passive forms of an action. System policy for users carries the same format as accessing user policy does. However, when specifying system policy for resources, one system-wide policy for one type of access to all resources may not be fine-grained and flexible enough. Sometimes we need to refine the scope of the resources that applied to the policies in terms of resource types r.type. Examples of resource type r.type are photo, blog post, status update, etc. Thus, <read, photo, (uc, f*, 4)> is a system policy applied to all read access to photos in the system.

Algorithm 1 AccessEvalution(uₐ, action ,target)

| | |
|---|---|
| 1: | (Policy Collecting Phase) |
| 2: | if target = uₜ then |
| 3: | AUP P ← uₐ's policy for action, TUP ← uₐ's policy for action^{—1}, |
| | SP ← system's policy for action |
| 4: | else |
| 5: | uₐ ← owner (rₜ), AUP ← uₐ's policy for action, TRP ← uₐ's policy |
| | for action⁻¹ an rₜ, SP ← sytem's policy for action, r.type |
| 6: | (Policy Evalution phase) |
| 7: | for all policies in AUP, TUP/TRP and SP do |
| 8: | Extract graph rules (start, path rule) from policies |
| 9: | for all graph rules extracted do |
| 10: | Determine the starting node, specified by start, where the path |
| | evalution starts |
| 11: | Determine the evaluating node which is the other user involved |
| | in access |
| 12: | Extract path rules path rules from graph rules |
| 13: | Extract each path spec path, hopcount from path rules |
| 14: | Path-check each path spec using Algorithm 2 |
| 15: | Evaluate a combined result based on conjunctive or |
| | disconjunctive connectives between path specs |
| 16: | Compose the final result from the result of each policy |

Algorithm 1 specifies how the access evaluation procedure works. When an accessing user uₐ requests an action against a target user uₜ, the system will look up uₐ's action policy, uₜ's action⁻¹ policy and the system-specified policy corresponding to action. When ua requests an action against a resource rₜ, the system will first find out the controlling user u_{c} via owner (rₜ) and retrieve all the corresponding policies. Although each user can only specify one policy per action per target, there might be multiple users specifying policies for the same pair of action and target. Multiple policies might be collected in each of the three policy sets: AUP, TUP/TRP and SP.

Example Given the following policies and social graph in FIG. 3:
Alice's policy PAlice: <poke, (ua (f*, 3))> <poke−1, (ut (f, 1))> <read, (ua, (Σ*, 5))> <read−1, file1, (uc, (cf*, 4))>
Harry's policy PHarry: <poke, (ua (cf*, 5)ν(f*, 5))> <poke−1, (ut (f*, 2))> <read−1, file2 (uc, [symbol] (p+2)>
System's policy PSys: <poke, (ua, (Σ*, 5))> <read, photo, (ua, (Σ*, 5))>

When Alice requests to poke Harry, the system will look up the following policies: <poke, (uₐ, (f*, 3))> from P_{Alice}, <poke−1, (uₜ, (f*, 2))> from P_{Harry}, and <poke, (uₐ, (Σ*, 5))> from P_{Sys}. When Alice requests to read photo file2 owned by Harry, the policies <read, (uₐ, (Σ*, 5))> from P_{Alice}, <_{read-1}, file2, (u_{c}, [symbol] (p+, 2)> from P_{Harry}, and <read, photo, (uₐ, (Σ*, 5))> from P_{Sys} will be used for authorization.

For all the policies in the policy sets, the algorithm first extracts the graph rule (start, path rule) from each policy. Once the graph rule is extracted, the system can determine where the path checking evaluation starts (using start), and then extracts every path spec path, hopcount (from path rules). Then, it runs a path-checking algorithm (see the next section) for each path spec. The path-checking algorithm returns a boolean result for each path spec. To get the evaluation result of a particular policy, we combine the results of all path specs in the policy using conjunction, disjunction and negation. At last, the final evaluation result for the access request is made by composing all the evaluation results of the policies in the chosen policy sets.

The existence of multi-user policies can result in decision conflicts. To resolve this, we can adopt a disjunctive, conjunctive, or prioritized approach. When a disjunctive approach is enabled, the satisfaction of any corresponding policy is sufficient for granting the requested access. In a conjunctive approach, the requirements of every involved policy should be satisfied in order that the access request would be granted. In a prioritized approach, if, for example, parents' policies get a priority over children's policies, the parents' policies overrule children's policies. While policy conflicts are inevitable in the proposed model, we do not discuss this issue in further detail here. For simplicity we assume system level policies are available to resolve conflicts in user-specified authorization policies and do not consider user-specified conflict resolution policies.

From user-specified policies we have shown that action policy starts from uₐ whereas action⁻¹ policy starts from uₜ. This is because at the time of policy configuration, users are not aware of who are the other participants in the action hence cannot specify graph rule starting from the other side. When hopcount=0 and path equals to empty, it has special meaning of “only me”. For instance, <poke, (uₐ, (Ø, 0))> says that uₐ can only poke herself, and <poke⁻¹, (uₜ, (Ø, 0))> specifies uₜ can only be poked by herself. The above two policies give a complementary expressive power that the regular policies do not cover, since regular policies are simply based on existing paths and limited hopcount.

As mentioned earlier, the social graph is modeled as a simple graph. Further we only allow simple path with no repeating nodes. Avoiding repeating nodes on the relationship path prevents unnecessary iterations among nodes that have been visited already and unnecessary hops on these repeating segments. On the other hand, this “no-repeating” could be quite useful when a user wants to expose her resource to farther users without granting access to nearer users. For example, in a professional OSN system such as LinkedIn, a user may want to promote her resume to users outside her current company, but does not want her coworkers to know about it. Note that the two distinct paths denoted by (f f f c) and (f c) may co-exist between a pair of users. The path specs f f f c Λ [symbol] f c allows the coworkers of the user's distant friends to see the resume, while the coworkers of the user's direct friends (f c) are not authorized.

In general, conventional OSNs are susceptible to the multiple-persona problem, where users can always create a second persona to get default permissions. In a default-denial system, a new persona initially has no permission to access others, thus allowing multiple new personas from the same user is safe to the existing users. Our approach follows the default-denial design, which means if there is no explicit positive authorization policy specified, there is no access permitted at all. Based on the default-denial assumption, negative authorizations in our policy specifications are mainly used to further refine permissions allowed by the positive authorizations specified (e.g., f*cΛ [symbol] f c). A single negative authorization without any positive authorization has the same effect as there is no policy specified at all. Nonetheless it is possible for the coworker of a direct friend to have a second persona that meets the criteria for coworker of a distant friend and thereby acquires access to the resume. Without strong identities we can only provide persona level control in such policies.

Path Checking Algorithm

In this section, we present the algorithms for determining if there exists a qualified path between two involved users in an access request.

As mentioned, in order to grant access, relationships between the accessor and the target/controlling user must satisfy the graph rules specified in access control policies regarding the given request. We formulate the problem as follows: given a social graph G, an access request <uₐ, action, target> and an access policy, the system decision module explores the graph and verifies the existence of a path between uₐ and target (or u_{c} of target) matching the graph rule <start, path rule>.

Path checking is performed by Algorithm 2, which takes as input the social graph G, the path pattern path and the hopcount limit hopcount specified bypath spec in the policy, the starting node s specified by start and the evaluating node t which is the other user involved, and returns a boolean value as output. Note that path is non-empty, so this algorithm only copes with cases where hopcount /=0. The starting node s and the evaluating node t can be either the accessing user or the target/controlling user, depending on the given policy. The algorithm starts by constructing a DFA (deterministic finite automata) from the regular expression path. The REtoDFA( ) function receives path as input, and converts it to a NFA (non-deterministic finite automata) then to a DFA, by using the well-known Thompson's Algorithm [16] and Subset Construction Algorithm (also known as Büchi's Algorithm) [15], respectively.

Algorithm 2 PathChecker(G, path, hopcount, s, t)

| | |
|---|---|
| 1: | DFA ← REtoDF A(path); current Path ← NIL; d ← 0 |
| 2: | stateHistory ← DFA starts at the initial state |
| 3: | if hopcount ≠ 0 then |
| 4: | return DFST(s) |

Algorithm 3 DFST(u)

| | |
|---|---|
| 1: | if d + 1 > hopcount then |
| 2: | return FALSE |
| 3: | else |
| 4: | for all (v, σ) where (u, v, σ) in G do |
| 5: | switch |
| 6: | case 1 v ∈ currentPath |
| 7: | break |
| 8: | case 2 v ∉ currentPath and v = t and DFA with transition σ is at |
| | accepting state |
| 9: | d ← d + 1; currentPath ← currentPath.(u, v, σ) |
| 10: | currentstate ← DFA takes tranistion σ |
| 11: | stateHistory ← stateHistory.(currentState) |
| 12: | return TRUE |
| 13: | case 3 v ∉ currentPath and v = t and transition σ is valid for |
| | DFA but DFA with transition σ is not at accepting state |
| 14: | break |
| 15: | case 4 v ∉ currentpath and v ≠ t and transition σ is invalid for |
| | DFA |
| 16: | break |
| 17: | case 5 v ∉ currentPath and v ≠ t and transition σ is valid for |
| | DFA |
| 18: | d ← d + 1; currentPath ← currentPath.(u,v,σ) |
| 19: | currnetstate ← DFA takes transition σ |
| 20: | stateHistory ← stateHistory.(currentState) |
| 21: | if (DFST(v)) then |
| 22: | return TRUE |
| 23: | else |
| 24: | break |
| 25: | if d = 0 then |
| 26: | return FALSE |
| 27: | else |
| 28: | d ← d − 1; currentPath ← currentPath\(u, v, σ) |
| 29: | previousState ← last element in stateHistory |
| 30: | DFA backs off the last taken transiton σ to previousState |
| 31: | stateHistory ← stateHistory\(previousState) |
| 32: | return FALSE |

The algorithm uses a depth-first search (DFS) to traverse the graph, because it requires only one running DFA and, correspondingly, one pair of variables keeping the current status and the history of exploration in a DFS traversal. Whereas, a breadth-first search (BFS) traversal has to maintain multiple DFAs and multiple variables simultaneously and switch between these DFAs back and forth constantly, which makes the costs of memory space and I/O operations proportional to the number of nodes visited during exploration. Note that DFS could avoid a target node for a longer time, even if the node is close to the starting node. If the hopcount is unlimited, a DFS traversal may pursue lengthy useless exploration. However, activities in OSN typically occur among people with close relationships. Hence, DFS with limited hopcount fits our model.

The variable current Path, initialized as N I L, holds the sequence of the traversed edges between the starting node and the current node. Variable stateHistory, initialized as the initial DFA state, keeps the history of DFA states during algorithm execution. The main procedure starts by setting d to 0 and launches the DFS traversal function DFST( ), given in Algorithm 3, from the starting node s.

Given a node u, if d+1 does not exceed the hopcount limit, it indicates that traversing one step further from u is allowed. Otherwise, the algorithm returns false and goes back to the previous node. If further traversal is allowed, then the algorithm picks up an edge (u, v, σ) from the list of the incident edges leaving u. If (u, v, σ) is unvisited, we get the node v on the opposite side of the edge (u, v, σ). Now we have five different cases. If v is on currentPath, we will never visit v again, because doing so creates a cycle on the path. Rather, the algorithm breaks out of for loop, and finds the next unchecked edges of u. When v is not on currentPath and v is the target node t and DFA taking transition a reaches an accepting state, we find a path between s and t matching the pattern Path. We increment d by one, concatenate edge (u, v, σ) to currentPath, and save the current DFA state to history. If v is the target node but DFA with transition a is not at an accepting state, then the path from s to v does not match the pattern. When v is not on currentPath and is not the target node, there are two cases depending on whether the transition type σ is a valid transition for DFA. If it is not, we break out of for loop and continue to check the next unchecked edge of u. Otherwise, the algorithm increments d by one, concatenates e to currentPath, moves DFA to the next state via transition type a, updates the DFA state history, and repeatedly executes DFST( ) from node v. If the recursive function call discovers a matching path, the previous call also returns true. Otherwise, it checks next edge of node u.

After all the outgoing edges of u have been checked, the algorithm has to step back to the previous node of u and reset all variables to the previous values. But if d=0, all the outgoing edges of the starting node are checked, thus the whole execution completes without a matching path.

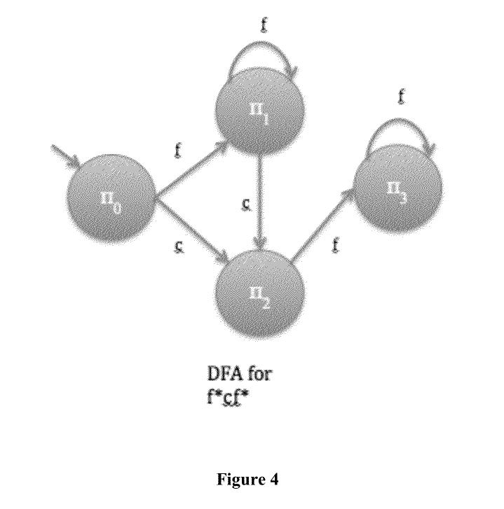

In FIG. 3, suppose user Harry owns a resource rₜ and expresses the target resource policy as (read⁻¹, rt, (f* cf*,3)), where read is the permitted action, (f* cf*, 3) is the path pattern and hopcount limit. Path pattern f* cf* means the accessing user and Harry must be either a pair of coworkers (c) or direct or indirect friend (f) of a pair of coworkers. Hopcount 3 constrains the distance between the two users to be within three hops. FIG. 4 shows the DFA accepting the path pattern f* cf*. If Alice requests read access to the resource owned by Harry, the algorithm starts exploration from node H (Harry) by checking all the edges leaving H. If it picks the edge (H, D, f) or (H, D, c) first, it will eventually find out that there exists a satisfiable path (H, D, f), (D, E, c), (E, A, f) or (H, D, c), (D, B, f), (B, A, f) that also moves the DFA from the starting state π0 to the accepting state π3 in three hops. (H, G, f), (G, F, f), (F, C, c), (C, A, f) also matches the path pattern, but it is invalid because it takes four hops to reach node A.

Suppose Harry specifies a target user policy for him as (poke⁻¹, (f+, 2)). This implies only his friends or indirect friends can poke him. Then, Bob, Dave, Ed, Fred and George can poke Harry because the paths between Harry and them contain relationship f and are within depth of two. Carol and Harry do not have friend relationship with Harry, while Alice is too far away from Harry.

Described herein is a UURAC model and a regular expression based policy specification language. We provided a DFS-based path checking algorithm and established its correctness and complexity. Correctness of the algorithm is proved by induction on hopcount. Due to the sparseness nature of social graph, given the constraints on relationship types and hopcount limit in policy, the complexity of the algorithm can be dramatically reduced. Proofs of correctness and complexity follow.

While the model described so far uses user-to-user relationships for authorization, it may be extended as a model to exploit user-to-resource and resource-to-resource relationships. The U2R and R2R applications will be described shortly.

A Proof of Correctness

Theorem 1. Algorithm 2 Will Halt with True or False.

Proof.

Base case (Hopcount=1): d is initially set to 0. Each outgoing edge from the starting node s will be examined once and only once. If taking an edge reaches the target node t and its type matches the language Path denotes (case 2), the algorithm returns true. If the edge type matches the prefix of an expression in L(Path) (lines 17-24), d increments to 1 followed by a recursive call to DFST( ). The second level call wills return false, since incremented d has exceeded Hopcount. In all other cases, the examined edge is discarded and d remains the same. Eventually, if a matching edge is not found, the algorithm will go through every outgoing edge from s and exit with false thereafter (lines 25-26).

Induction step: Assume when Hopcount=k (k≧1), Theorem 1 is true. When Hopcount is k+1, all the (k+1)th level recursive calls will examine every outgoing edge from the (k+1)th node on currentPath. If visiting an edge reaches t and the updated currentPath matches L(Path), the (k+1)th level call returns true and exits to the previous level, making all of the previous level calls all the way back to the first level exit with true as well. If an edge falls into case 5, d is incremented to k+2 and a (k+2)th level recursive call invokes, which will halt with false and return to the (k+1)th level as d has exceeded Hopcount. After all edges are examined without returning true, the algorithm will exit with false to the previous level. In the kth level, when Hopcount=k+1, edges without taking a recursive call are treated the same as they are when Hopcount=k. Since when Hopcount=k the theorem holds, the algorithm will terminate with true or false when Hopcount=k+1 as well.

Lemma 1.

At the start and end of each DFST( ) call, the DFA corresponding to Path is at currentState reachable from the starting state π₀ by transitions corresponding to the sequence of symbols in currentPath.

Proof.

The proof is straightforward. New edge is added to currentPath only when it reaches the target node (lines 8-12) or it may possibly lead to the target node by taking a recursive DFST ( ) call (lines 17-24). In both cases the DFA starting from πₒ will move to currentState by taking the transition regarding the edge. Removing the last edge on currentPath after all edges leaving the current node are checked always accompanies one step back-off of the DFA to its previous state (lines 28-32), which can eventually take the DFA all the way back to the starting state π₀.

Theorem 2.

If Algorithm 2 returns true, currentPath gives a simple path of length less than or equal to Hopcount and the string described by currentPath belongs to the language described by Path (L(Path)). If Algorithm 2 returns false, there is no simple path p of length less than or equal to Hopcount such that the string representing p belongs to L(Path).

Proof.

Base case (Hopcount=1): At first, d=0, currentPath=NIL, and the DFA is at the starting state π0. When d=0, case 1 requires that the edge being checked is a self loop which is not allowed in a simple graph. DFST ( ) only returns true in case 2, where edge (s, t, σ) to be added to currentPath finds the target node t in one hop. The transition a moves the DFA to an accepting state. Case 5 cannot return true, because incrementing d by one will exceed Hopcount in the recursive DFST ( ) run. When DFST( ) exits with true, due to Lemma 1, currentPath, which is (s, t, σ), can move the DFA from π0 to an accepting state π1, implying that σεL(Path). If the first DFST ( ) call returns false (lines 29-30), the algorithm has searched all the edges leaving node s. However, these examined edges either do not match the pattern specified by L(Path) (case 2 and 3), or may possibly match L(Path) but require more than one hop (case 5). Hence, Theorem 2 is true when Hopcount=1.

Induction step: Assume when Hopcount=k (k≧1), Theorem 2 is true. For the same G, Path, s and t, executions of DFST ( ) when Hopcount=k and k+1 only differ after invoking the recursive DFST ( ) call in case 5. If an edge being checked can make the algorithm return true when Hopcount=k, currentPath is a string of length≦k which is in L (Path). When Hopcount is k+1, the same currentPath gives the same string and is of length<k+1, thus making the function exit with true as well. The only difference between Hopcount=k and Hopcount=k+1 is that adding edges that lie in case 5 to currentPath and incrementing d by one may not exceed the larger Hopcount during the recursive call. If taking one of these edges leads to the target node and its corresponding transition moves the DFA to an accepting state, the algorithm will return true. The new currentPath gives a simple path of length k+1 that connects node s and t. The algorithm only returns true in these two scenarios. In both scenarios, based on Lemma 1, the DFA can reach an accepting state by taking the transitions corresponding to currentPath, so the string corresponding to currentPath is in L(Path). If the algorithm returns false when Hopcount=k, there is no simple path p of length≦k, where the string of symbols in p is in L(Path). When Hopcount is k+1, given the same G, such a path still does not exist. By taking a recursive DFST ( ) call in case 5, the algorithm will go through all 5 cases again to check all the edges leaving the new node. If the recursive call returns false, it means there is no simple path of length k+1 with its string of symbols in L(Path). Combining the results from all k+1 level recursive calls, there exists no simple path of length ≦k+1 with its string of symbols in L(Path). Hence, Theorem 2 is true when Hopcount=k+1.

In this algorithm, every possible path from s to t will be visited at most once until it fails to reach t, while every outgoing edge of a visited node may be checked multiple times during the search. In the extreme case, where every relationship type is acceptable and the graph is a complete directed graph, the overall complexity would be O(|V|^{Hopcount}). However, users in OSNs usually connect with a small group of users directly, thus the social graph is actually very sparse. We define the maximum and minimum out-degree of node on the graph as dmax and dmin, respectively. Then, the time complexity can be bounded between O(dmin^{Hopcount}) and O(dmax^{Hopcount}). Given the constraints on the relationship types and hopcount limit in the policies, the size of graph to be explored can be dramatically reduced. The recursive DFST( ) call terminates as soon as either a matching path is found or the hopcount limit is reached.

Beyond User-to-User Relationships

Online social networks (OSNs) have attracted a large amount of users to regularly connect, interact and share information with each other for different purposes. Users share a tremendous amount of content with other users in OSNs using various services. The explosive growth of sensitive or private user data that are readily available in OSNs has raised an urgent expectation for effective access control that can protect these data from unauthorized users in OSNs.

Access control in OSNs is typically based on the relationships among users in the social graph. That is, granting access to an accessing user is subject to the existence of a direct or indirect relationship of certain types between the accessing user and the controlling users of the target. Many existing OSN systems enforce a rudimentary and limited relationship-based access control mechanism, offering users the ability to choose from a pre-defined policy vocabulary, such as “public”, “private”, “friend” or “friend of friend”. Google+ and Facebook recently introduced customized relationships, namely “circle” and “friend list”, providing users richer options to differentiate distinctly privileged user groups. Meanwhile, more sophisticated relationship-based access control models have been proposed by researchers (see related works section). These proposals explore more flexible and expressive solutions than provided by current commercial OSNs, such as supporting multiple relationship types in policy languages or taking the trust value of relationships into account in the control of information dissemination. One common characteristic found in most of these commercial and academic solutions is that they mainly focus on user-to-user (U2U) relationships between accessing user and the resource owner, and at least implicitly assume ownership is the only manifestation of user-to-resource (U2R) relationships. However, this is not sufficient to capture many user activities found in today's OSN applications, where users can perform actions that create relationships between users and resources other than ownership. For example, tagging a friend on a photo will create U2R relationship between the photo and the tagged user which consequently may allow friends of the tagged user to access the photo. Hence the tagged user may want to control other related users' access to the photo. Likewise, users' actions can establish resource-to-resource (R2R) relationships such as photos under the same album, comments to a blog post, etc. To enable fully expressive relationship-based access control, it is necessary to exploit U2R and R2R relationships in addition to U2U relationships for authorization policies and decisions.

In OSN, users are allowed to configure access control policies for their own content and activities. Allowing U2R relationship-based access control further enables users to specify policies for contents related to them and activities of other related users. Since a change of relationships may result in a change of authorization, the creation and termination of relationships needs to be treated differently from usage activities to normal resources. Thus, access control in OSNs has to address the management of access control policies and relationships in addition to normal usage activities by means of U2U, U2R and R2R relationships. Although Carminati et al [22], [23] introduced a framework that allows system administrators to specify administrative policies in ontology-based representations, they did not provide a policy management model for managing policies and resolving policy conflicts. Most of the other relationship-based access control models do not incorporate users' administrative activities.

Since multiple users can express access control policies for a user or a resource, it is expected that there will be several policies applicable to the same access request which will inevitably raise conflicts. For example, Bob sets his policy so that he can get friendship request from anyone in the system, while at the same time policies defined by his parents may only allow him to receive such request from his friends of friends. To resolve such conflicts, it is necessary to introduce conflict resolution policies, which are (meta-)policies about how authorization policies are to be interpreted and how policy conflicts are resolved.

Previously discussed [27], we developed an access control model for OSNs based on U2U relationships, using regular expression notation in its policy specifications to express path patterns between the accessing user and the controlling user of the target. This model only addresses access control over normal usage activities. Already described is a graph traversal algorithm for path checking with correctness proof and complexity analysis. Building on this, we further describe herein a relationship-based access control model that utilizes not only U2U relationships but also U2R and R2R relationships in its scope. The model covers users' normal usage activities as well as administrative activities, which have only been rarely addressed in the art. The regular expression based policy specification language of [27] is extended here to be flexible and expressive enough to support various U2U, U2R and R2R relationship-based access control policies. Incorporated are simple system defined conflict resolution policies as a default solution for the inevitable authorization policy conflicts. By including U2U, U2R and R2R relationships in authorization decision process and controls on users' administrative activities, the proposed model significantly extends the previous U2U relationship based access control model of [27].

Related Works

Discussed now are some of the related works that focus on access control mechanisms for OSNs and policy conflict resolution in access control systems.

Access Control Models for OSNs

Inspired by research in trust and reputation systems, some early solutions proposed by Kruk et al [37] and Carminati et al [24], [25] identified aggregated trust value, denoting the level of relationship, along with relationship type and depth on a path from the resource owner to the accessing user as parameters for authorization. While Kruk's work only considers one relationship type, Carminati's work allows multiple relationship types but only supports trust computation of a relationship path of a single type at a time. Carminati et al also proposed a semi-decentralized architecture, where access rules are specified in terms of relationship type, depth and trust metrics by individual users in a discretionary way [26]. The system features a centralized certificate authority to assert the validity of relationship paths, while access control enforcement is carried out on the decentralized user side.

A formal model for access control in Facebook-like systems was developed by Fong et al [30], which treats access control as a two-stage process, namely, reaching the search listing of the resource owner and accessing the resource, respectively. Reachability of the search listings is a necessary condition for access. Although lacking support for directed relationships, multiple relationship types and trust metric of relationships, this model allows expression of arbitrary topology-based properties, such as “k common friends” and “k clique”, which are beyond what Facebook and other commercial OSNs offer.

Fong et al [31] proposed a formal ReBac [33] model for social computing applications, which employs a modal logic language for policy specification and composition. In [32], Fong et al later extended the policy language and studied its expressiveness. These two models allow multiple relationship types and directional relationships. Authorizations are based on U2U relationships between the accessing user and the resource owner, and relationships are articulated in contexts.

In [22], [23], Carminati et al proposed an access control framework which utilizes relationships among users and resources as the basis for access control and employs the Semantic Web Rule Language (SWRL) to define authorization, administration and filtering policies. The model described herein offers more complete policy administration by addressing policy management and conflict resolution. Another semantic web based approach described in [38] allows both users and the system to express policies based on access control ontologies.

Policy Conflict Resolution

There is literature on conflict resolution of access control policies, especially in distributed systems, database systems and collaborative environments. Simultaneous presence of conflicting policies can be resolved by various strategies, such as permissions-take-precedence [35], [36], denials-take-precedence [21], [35], [36], specificity precedence [20], [29], recency precedence, strong authorization overriding weak authorization [19], [20], [42], or explicit specification of policy priority [18], [28], [43], etc. Most conflicts discussed in this literature are conflicts between positive and negative authorizations (permissions vs. prohibitions) typically arising due to generality or specificity of the applicable policy in a hierarchy. However, in OSNs possible policy conflicts will likely arise due to policies specified by distinct users carry contrasting authorization.

In OSN systems, as long as each user can specify individual policies, policy conflicts become inevitable. [44] applied game theory to a solution for collective policy management in OSNs, where data resources may belong to multiple users. [34] proposed a formal model to address multi-party access control in OSNs with a policy conflict resolution mechanism based on voting scheme to deal with collaborative policies. In this approach, the release of a resource depends on the sensitivity scores assigned by each controlling user and the chosen decision making strategy, such as setting a sensitivity threshold, owner-overrides and full-consensus-permit. Although policy conflict resolution is not the main focus of this paper, it is necessary to explicitly express an unambiguous strategy, whether a conjunction, a disjunction or a prioritized order of relationships between the policy specifiers and the user or resource the policies apply to.

Beyond U2U Relationship-Based Access Control

In this section, described are limitations of U2U relationship based access control and build a taxonomy of user's access types in OSNs based on U2U, U2R and R2R relationships.

Limitation of U2U Relationship-based Access Control

In OSNs, users are encouraged to create profiles, add content onto their pages (e.g., photos, videos, blogs, status updates and tweets), and share these resource objects with other peers. OSNs offer their users various types of user interaction services, including chatting, private messaging, poking and social games. As OSN systems mature, various types of resources need to be protected, such as user sessions, relationships among users and resources, access control policies and events of users. As shown in FIG. 1(a), users can launch access requests against both resources (e.g., view a photo or create an access control policy) and users (e.g., invite another user to a game or poke another user).

Social graph represents a global mapping of all individual users and how they are connected in an OSN, where user is a node and a relationship between users is an edge. Access control in most existing OSNs are based on the topology of the social graph, so-called relationship-based access control. Typically, granting access permission to an accessing user is subject to the existence of a particular relationship or a particular sequence of relationships between the accessing user and the target user/resource owner, and access control policies are specified in terms of such U2U relationships. When a user requests access to a resource, current OSNs rely on an implicit relationship, namely ownership, between the resource and its owner, hence the authorization of such U2R access is still based on the underlying U2U relationships.

However, due to the various functionality offered by today's OSNs, there exist several different types of relationships between users and resources in addition to ownership. Consider an example where Bob posts a photo that contains Alice and Carol's images in it and tags them. OSNs usually allow only the owner Bob to have control on who can view the photo, regardless of whether or not Alice and Carol may wish to release their images. To enable Alice and Carol control capability on the photo, their relationships with the photo, which is not ownership, should be considered for authorization purposes. After the photo has been shared by Bob's friends several times, more and more users from different neighborhoods in the network come to view the photo and comment on it. When Dave reads through all the comments in Bob's photo and becomes curious about another user Eve who has commented recently, he decides to poke her to say hello. In this case, Dave and Eve are connected through the photo, not through another user (such as the owner of the photo Bob). Also, users may share or like the blog posts or videos posted by others, and gain the ability to determine how the shared/liked copy of the original content or the fact of sharing and liking activities can be seen by others. Consider another scenario where Betty finds a weblink originally posted by Ed interesting and then shares it with her friends. From her activity, she acquires the ability to decide how the weblink can be available to others. As users get increasingly involved in these activities in OSNs, current U2U relationship-based access control mechanism is not able to offer the appropriate control and requires extensions to bring U2R and R2R relationships into consideration.

In recent years, Facebook has gradually expanded the idea of social graph to so-called Open Graph as it launches new services such as photos and places, and includes these in the graph over time. Recently even further extensions to incorporate arbitrary activities and objects are being pushed so as to codify user behaviors effectively. These recent trends in commercial OSNs strengthen our belief that it is useful to include resources, such as objects and activities, in the social graph. By means of such an extended social graph, users and all of the resources related to users are interconnected through U2U, U2R, and even R2R relationships, allowing stronger expressive power of relationship-based access control policies

Taxonomy of Access Scenarios

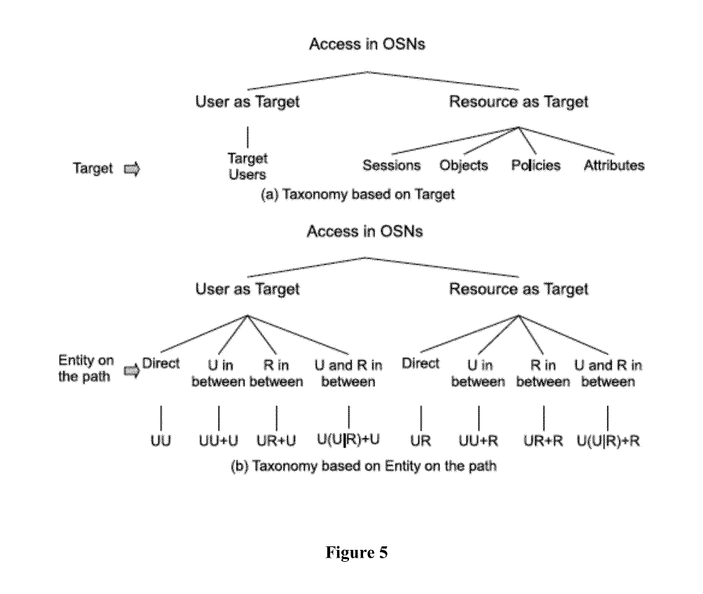

As shown in FIG. 5(b), in OSN, a user can access other users (user as a target) or resources (resource as a target). By means of U2U, U2R and R2R relationships, an accessing user and a target user can have a direct relationship or indirect relationships with user(s) in between, resource(s) in between or user(s) and resource(s) in between. Likewise, an accessing user and a target resource can also be characterized in terms of the entities on the relating path.

In the first two cases of accessing a target user, there is no resource involved. An accessing user should either have a particular direct U2U relationship (shown as UU) or a particular sequence of U2U relationships (shown as UU+U)2 with the target user. Examples of such access to a target user are that Alice's direct friends can poke her, and Bob's friends of friends can request friendship invitation to him. If resources are introduced onto the path between the accessing user and the target user, it brings in U2R and R2R relationships and leads to other possible combinations of relationships. For instance, “Users who are tagged in the same photo can visit each other's profile even though they are not friends” is a typical UR+U example that can be found in OSNs, in which case the photo actually links two unconnected users together. We can make even more complicated policies by connecting users through both users and resources (shown as U(U|R)+U). In the previous example, friends of one of the tagged users may be able to access another tagged user through their mutual friend and the photo.

Similarly, a user may access a resource that directly relates to her (shown as UR), or may find a resource through one or more users in the network (shown as UU+R). Most of the current commercial OSNs and the prior work [22], [26], [30]-[32] deal with these two cases with an implicit assumption of the existence of “own” relationship. When a user requests an access against resource, the system checks if there is a qualified relationship between the accessing user and the resource owner, and then determines the authorization. We believe that it is useful to distinguish different types of U2R relationships, such as “tag”, “share” and “like”, in the policy specifications rather than relying only on “own”. Incorporating R2R relationships and connecting resources on the path enables UR+R and U(U|R)+R cases, so that users may be able to access some resources that are connected to users' related resources. For example, if user Alice is tagged in one of Bob's photo, then Alice may get the privilege to view other photos in the same album without being Bob's contact of any type.

The above discussion indicates that allowing U2R and R2R relationships in access control gives users more complete and flexible expressive power than the currently prevailing U2U only approaches.

Relationship-Based Access Control Model Components and Characteristics

Components

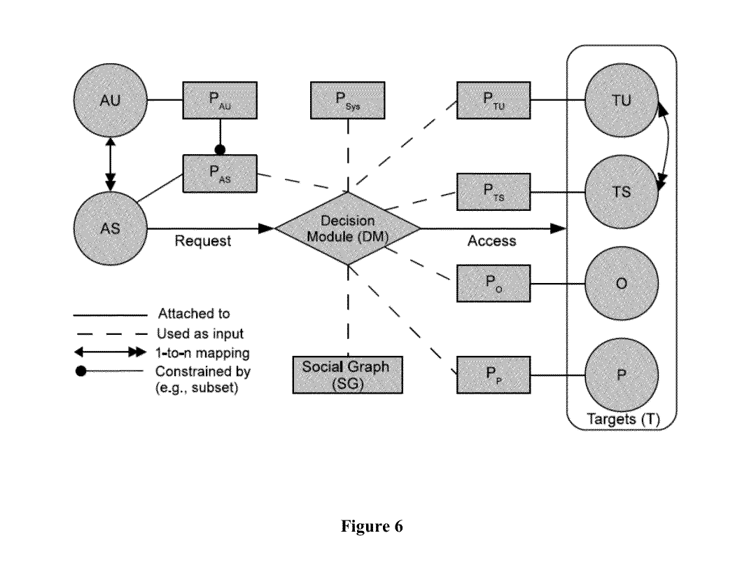

FIG. 6 shows a conceptual diagram for the relationship based access control model. It comprises six categories of basic components: users, sessions, resources, policies, social graph and decision module, as discussed below.

Users. A user represents a human being registered in an OSN system to whom authorization may be granted. Users maintain relationships with each other, own a number of resources, and perform various kinds of actions against resources and users in the system. Users can be identified as accessing users (AU) and target users (TU), based on the roles they play with respect to access. Accessing users are users who perform certain types of access against targets, carrying authorization policies (Accessing User Policies or P_{AU}). Target users are users against whom access is performed. Target users also carry authorization policies (Target User Policies or P_{TU}).

Sessions. A session is an active instance of a user who has logged into the OSN. Accessing users perform access through sessions (AS), while target users may or may not have a session instance (TS) at the time of access. In other words, some accesses can be placed only when a target user is online (e.g., chatting) while other accesses do not require this and can be placed on a target user who is not logged in at the time of the accesses (e.g., poking) The user-session distinction allows sessions to have different policies and attributes from those of the corresponding user by partially inheriting them possibly along with some other policies and attributes. This is depicted in FIG. 6 as “constrained by”. A user can have multiple sessions with differing access control policies, while a session is only associated with a single user. In general, all sessions are considered objects and can be created, suspended, or resumed by another session or by the user. Sessions are also called subjects in the access control literature. The term session was introduced in the role-based access control literature and has become widely used in that context.

Resources. Resources are non-user targets to be protected in access. They include target user's sessions (TS), objects (O) users shared in the system as well as access control policies (P). Because resources are not human beings, access control policies for resources are defined by users who possess the corresponding administrative privileges.

Policies. Access control policies are a set of rules that govern the ability of sessions (subjects) to access targets. Like in many computer systems, OSNs allow the system security administrators to define a central policy that is guaranteed to be enforced for all users and resources in the system, called system-specified policy (P_{Sys}). Additionally, users have the ability to express own preferences with respect to themselves or their related users and resources. Accessing user policy (P_{AU}), target user policy (P_{TU}), accessing session policy

(P_{AS}), object policy (P_{O}), policy for policy (P_{P})) are defined by users and applied to accessing users, target users, accessing sessions, objects and policies, respectively. System-specified policies consist of two types of policies, namely authorization policies and conflict resolution policies. Authorization policies allow the system and users to specify who is authorized to exercise which action on the user or resource, while conflict resolution policies specify how conflicts among authorization policies from multiple parties are to be solved. Assumed herein is that conflict resolution policies are specified entirely by the system administrators as part of P_{Sys}.

Social Graph (SG). Social graph denote connections among users and resources in the system. Although “relationships” on the graph usually refer to relationships among individual users in many OSN systems in practice and theory, they also can include U2R relationships and R2R relationships as we have argued above. U2U relationships are typically represented by the social graph. We extend the social graph to incorporate U2R relationships and R2R relationships as well, thus forming a network of users, sessions, objects as well as their access control policies.

Decision Module (DM). The access decision module in FIG. 6 consolidates all the necessary policies from P_{AS}, P_{TU}, P_{TS}, P_{O}, P_{P} and P_{Sys} as well as the relationships on the social graph, and makes a decision at the time of request. Access decision module can handle potential policy conflicts by consulting conflict resolution policies in PSys.

B. Characteristics

Three essential characteristics are identified that need to be addressed by OSN access control models, as follows.

Policy Individualization. As identified in [40], [41], unlike in traditional access control systems, OSNs allow individual users to express their own preferences over access to the content rather than having a single system-wide access control policy defined by the system security administrator. Moreover, users other than the resource owner are also able to configure policies for user and resource related to them. For example, parents of a child want to prescribe a boundary within which their child might perform access, and Alice wants to block her colleagues from seeing the party pictures which contain her image. The system needs to collect all of the related individual policies along with the system-specified policies for making access control decisions.

Policy Administration. In OSN, policy administration becomes very important since allowing individual users to specify policies requires the OSN to ensure that only the right users are authorized to specify policies. Our model enables users to specify policies for other users and resources as long as they meet the relationship requirement stated in the policies for the target policy. For example, the system-specified policy may allow users who have “own” or “tag” relationships with the resource to set the policy for that resource. Then the owner or tagged user can control the resource's policy and later modify it to enable or disable who can access the resource.

User-session Distinction. We know that a session is a process in execution on behalf of a user. A user can have multiple sessions with different sets of privileges by creating different degrees of access control policies with the original user's. The user-session distinction facilitates better security and privacy control by minimizing a session's privilege to an adequate level. It becomes especially useful in OSN environments as more and more smart devices and location-based applications are introduced into OSN world. Users logged in from different devices may have distinct access control policies and thus distinct privileges. Users with location-based services enabled may be offered extra functionality than ordinary users are. Much of the current literature in OSN access control does not distinguish a session from a user. We believe differentiating user and session is crucial for effective access control in OSNs.

Relationship-Based Access Control Model

In the following, we formally define an access control model for OSNs, expressing authorization policies and conflict resolution policies in terms of relationships existing among users and resources in the system.

Model Definition

We begin by identifying each component of the model. U is the current set of users, including accessing users (AU) and target users (TU). Associated with each user is a collection of sessions. S is the current set of sessions, which is composed of accessing sessions (AS) and target sessions (TS). R is the set of resources, including target sessions (TS), objects (O) and access control policies (P). We refer to target users and resources as targets, which are the targets of access. We write ACT={act₁, act₂, . . . , actₙ} which is the set of OSN supported actions, denoting the access modes a user or a session can execute in the system. Each action is defined in active form with accessing user or session as the actor and target users and/or resources as targets. For each action acti the passive form act−1 i represents the action from the target's perspective. The overall set of policies P in the OSN is categorized as follows.

*P_{AU}⊂P, P_{TU}⊂P, P_{AS}⊂P, P_{TS}⊂P, P_{O}⊂P, P_{P}⊂P and P_{Sys}⊂P are authorization policies for accessing user, target user, accessing session, target session, objects, policies and system-specified policies, respectively.

*AP_{Sys}⊂P_{Sys} and CRP_{Sys}⊂P_{Sys} represent system-specified authorization policies and conflict resolution policies, respectively.

The first two user-specified policies P_{AU} and P_{TU} are associated with and specified by the corresponding users, while rest of the user-specified policies are specified by users but associated with the resource or another user. The user who actually specifies a policy for other user or resource is called the controlling user (CU), who has a certain type of relationship with the user/resource to whom the policy applies.³ Accessing session policies are partially inherited from its corresponding accessing user's policies, but may have additional content specific to the session, such as location. System-specified policies, on the other hand, are expressed by the system and applied to all relevant activities across the system. While a resource is always the target of an access, a user, on the other hand, can participate both as an accessing user or a target user in an access with different access control requirements. Hence, the distinction between the active and passive forms of an action becomes significant. We write act and act⁻¹ as the active and passive form of an action act, respectively. Accessing user policies, accessing session policies and system-specified policies are indexed by act, and target user policies, target session policies, object policies and policies for policy are indexed by act⁻¹. Authorization policies specified by multiple users may possibly give conflicting results for a requested access. We introduce system-defined conflict resolution policies (CRP_{Sys}) to make unambiguous decisions for authorization policies specified by multiple parties with conflicting interests. The specification of policies is discussed below in part B of this section. ³ While these policies could be used to control an application's access to user data, in real world system, the similar policies as a whole can be used to evaluate an application's usages on a user's private data at the time of the user's initial access request to try out the application. If the data usages of the application modules satisfy the user's policies, the user's access to the application could be allowed. Otherwise, OSN may deny the user's request or warn the users while showing which policies are violated by the application.

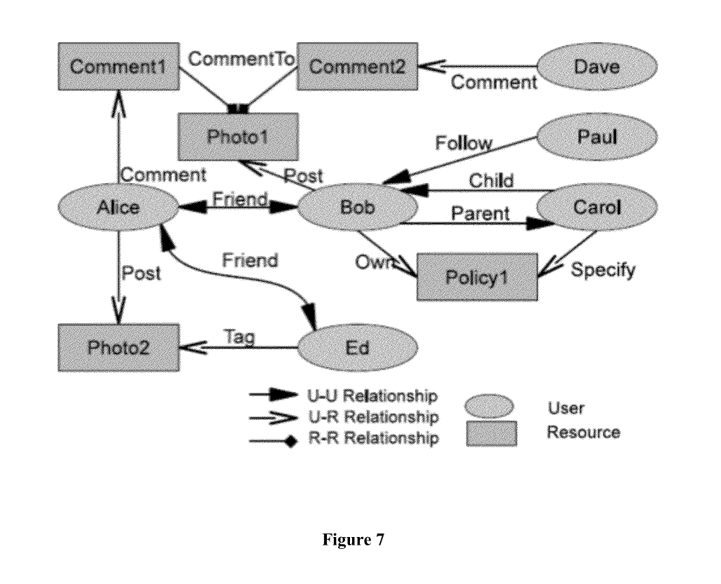

As depicted in FIG. 7, we abstract an OSN as a directed labeled simple graph, where each vertex represents a user or a resource, whereas each edge corresponds to a relationship among users and resources. The social graph of an OSN SG is formally denoted as a triple <V,E,Σ>:
V=U∪R is a finite set of vertices on the graph, representing registered users and their resources in the system.
Σ=Σu_{_{—}}ᵤ∪Σu_{_{—}}ᵣ∪Σr_{_{—}}ᵣ={σ₁, σ₂⁻¹, . . . , σₙ, σ₁⁻¹, σ₂⁻¹, . . . , σₙ, σ₁⁻¹}, denotes the set of relationship type specifiers in the system. Each relationship type specifier σ is represented by a string of characters. Given a relationship type σiεΣ, we write the inverse of the relationship σᵢ⁻¹εΣ. Relationships are further divided into three categories: U2U (U_U), U2R (U_R) and R2R (R_R) relationships. We express this formally as follows.
U_U relationships: U×Σᵤ_{_{—}}ᵤ×U,
U_R relationships: U×Σᵤ_{_{—}}ᵣ×R or R×Σᵤ_{_{—}}ᵣ×U,
R_R relationships: R×Σᵣ_{_{—}}ᵣ×R,

where Σᵤ_{_{—}}ᵤ⊂Σ, Σᵤ_{_{—}}ᵣ⊂Σ and Σᵣ_{_{—}}ᵣ⊂Σ.
*E=Eᵤ_{_{—}}ᵤ∪Eᵤ_{_{—}}ᵣ∪Eᵣ_{_{—}}ᵣ, where Eᵤ_{_{—}}ᵤ⊂Σᵤ_{_{—}}ᵤ×U,
Eᵤ_{_{—}}ᵣ⊂(U×Σᵤ_{_{—}}ᵣ×R)∪(R×Σᵤ_{_{—}}ᵣ×U), Eᵣ_{_{—}}ᵣ⊂
R×Σᵣ_{_{—}}ᵣ×R, represents the existing relationships among users and resources in the system.

Note that E is defined as directed, since not all of the relationships in OSNs are mutual. For every σᵢεΣ, there is σᵢ⁻¹εΣ_ representing the inverse of relationship type _i. Although not explicitly shown on the social graph, we assume the original relationship and its inverse twin always exist simultaneously. Given a vertex vᵢεV, a user v₂εV and a relationship type σεΣ, a relationship (v₁, v₂, σ) says that there exists a relationship of type a originating from vertex vᵢ and terminating at v₂. There always exists an equivalent form (v₂, v₁, σ⁻¹) at the same time.

It remains to formally define the concept of access request.
(s, act, T) represents an access request, where sεS indicates the accessing session, actεACT denotes the requested action and T⊂(2^{TU}^{_{∪}}^{R}−ø;) gives a non-empty set of target users and resources; The cardinality and types of the targets are determined by the action.

Policy Specifications

The notations used in the policy specification language are defined in Table 4, familiar from typical regular expression notation with the addition of hopcount limits and skipping. As described earlier, there are several types of access control policies: accessing user policy, accessing session policy, target user policy, target session policy, object policy, policy for policy, and system-specified policy. Here, system-specified policies comprise authorization policies and conflict resolution policies. System-specified authorization policy allows the system to express access control requirements that apply to the entire set of users or resources, while system specified conflict resolution policy deals with the potential conflicts of interest among the user-specified authorization policies.

TABLE 4
Policy Specification Notations

| | |
|---|---|
| Concatenation | Joins multiple characters σ ∈ Σ or Σ itself |
| (.) | end-to-end, denoting a series of occurrences of |
| | relationship types. |
| Asterisk (*) | Represents the union of the concatenation of |
| | σ with itself zero or more times. For example, |
| | friend* means direct or indirect friends of a |
| | $user or user herself . \sum * is {{⋃}_{i = 0}}^{∞} {\sum }^{i} , denoting$ |
| | the node itself or nodes with any connection |
| | on social graph |
| Plus (+) | Denotes cocatenating σ one or more times. |
| | Similarly for Σ+. |
| Question Mark | Represents occurrences of σ zero or one time. |
| (?) | coworker friend? means only cowrker or |
| | coworker's direct friends can access. Similarly |
| | for Σ? |
| Square Bracket | Contains a path rule: a sequence of relationship |
| ([ ]) | specifiers with an indicated hopcount limit. |
| Double Square | Denotes skipping of the path rule contained. |
| Bracket ([ [ ] ]) | The meaning of the skipping feature is |
| | discussed in the text. |
| Disjunctive | Indicates the disjunction of multiple path specs. |
| Connective ( [symbol] ) | |
| Conjunctive | Denotes the conjunction of multiple path specs. |
| Connective ( [symbol] ) | |
| Negation ( [symbol] ) | Implies the absence of the specified pair of |
| | relationship type sequence and hopcount. |

Authorization Policy (AP). Authorization policies are modeled in different formats as shown in Table 5. Accessing User Policy and Accessing Session Policy are represented as a pair <act, graph rule> and regulate how an access requester in access can behave. Here, act indicates the requested action while graph rule denotes the access rule based on social graph. Target User Policy, Target Session Policy, Object Policy and Policy for Policy are about how others can perform access on the target, so they use passive form act−1 instead of act because the target is always the entity to be accessed, whereas graph rule has the same meaning as in the previous policies. System-specified policies do not differentiate the active and passive form of an action, since they are not attached to a particular entity in action. However, it is likely that we need to refine the scope of the objects to which the policies apply, thus we bring object types o.type into policy specifications. Hence, system-specified policies are defined in two formats: <act, graph rule> for user and <act, o.type, graph rule> for resource. Note that o.type is optional and used only if target is an object.

TABLE 5
Authorization Policy

| | |
|---|---|
| Accessing User Policy | < act, graphrule > |
| Accessing Session Policy | < act, graphrule > |
| Target User Policy | < act, graphrule > |
| Target Session Policy | < act⁻¹, graphrule > |
| Object Policy | < act⁻¹, graphrule > |
| Policy tor Policy | < act⁻¹, graphrule > |
| System Policy for User | < act graphrule > |
| System Policy for Resource | < act, o.type, graphrule > |
| | where o.type is optional |

Table 6 defines the grammar for the graph rules, based on which each graph rule specifies a startingnode and a pathrule. Starting node stands for the user or resource where the policy evaluation begins, which can be the accessing user, the controlling user or the target. A path rule is composed of one or more path specs, with each spec stating the required sequence of relationship types and the corresponding hopcount limit for the sequence. Users are allowed to specify a more complicated and fine-grained policy for an action against a target by connecting multiple path specs with conjunctive connective “Λ” and disjunctive connective “_”. Also, negation “ [symbol] ” over path specs is used to imply the absence of the specified pattern of relationship types and hopcount limit as authorization requirements. Each path spec is denoted as a tuple (path, hopcount), where path represents from the starting node a sequence of relationship type expressions segmented by “[ ]” or “[[ ]]” with local hopcounts, denoting the pattern of relationship types required to grant authorization, whereas hopcount describes the maximum distance between the accessing user and the target on the graph. Within each path segment there is a local hopcount defining the maximum distance requirement for the particular piece of relationship type expression. In some policies, path can be left blank to indicate only the starting node can access. With the use of U2R and R2R relationships, the distance between two users on the graph may be growing significantly. The notion of distance in U2R and R2R relationships is somewhat different from that of U2U relationships. For example, suppose Alice and Bob are friends and Bob owns a photo and Dave is tagged to the photo. Here, the distance between Alice and Bob is 1 and distance of Bob and Dave is 2. While the distance between Alice and Dave is 3, this combined distance is not as meaningful as individual U2U and U2R/R2R distances. Therefore, we may want to omit the distance created by resources by introducing the “skipping” notation, denoted “[[ ]]”, which means that the local hopcount stated inside “[[ ]]” will not be counted in the global hopcount. For instance, in the path rule “([f*,3][[c*, 2]], 3)”, the local hopcount 2 for c* does not apply to the global hopcount 3, thus allowing f* to have up to 3 hops.

TABLE 6
Graph Rule Grammar

GraphRule → “(” StartingNode “,” PathRule“)”
PathRule → PathSpecExp|PathSpecExp Connective PathRule
Connective → [symbol]
PathSpaceExp → PathSpec | [symbol] PathSpec
PathSpec → “(” Path“,” HopCount“)”|“(” EmptySet“,” HopCount“)”
HopCount → Number
Path → [“[”TypeSeq“[”|“]”TypeSeq “,”HopCount“|”|“[[”TypeSeq “, ”
HopCount “]]”]+
EmptySet →
TypeSeq → TypeExp {“.”TypeExp }
TypeExp → TypeSpecifier |TypeSpecifier Wildcard
StartingNode → uₐ|u_{c}|t
TypeSpecifier → σ₁|σ₂|..|σₙ|σ₁⁻¹|σ₂⁻¹|..|σₙ⁻¹|Σ where Σ=
{σ₁,σ₂,..,σₙ,σ₁⁻¹,σ₂⁻¹,..,σₙ⁻¹}
Wildcard → “ * ”|“?”|“+”
Number → [0 − 9]+

Conflict Resolution Policies (CRP). Due to the nature of policy individualization, multiple policies applicable to authorization of an access request may result in decision conflicts in many scenarios. We assume that policies specified by the system will always be unambiguous so there are no conflicts within PSys. Conflict resolution policies are then responsible for interpreting how the potential policy conflicts within each category of PAS, PTU, PTS PO and PP can be resolved in terms of the precedence or connectives over relationship types. Relationship precedence is used to produce a collective result from multiple policies specified by users with different relationships to the policy holder. To resolve conflicts, we consider three simple and intuitive approaches: disjunctive, conjunctive or prioritized. In a disjunctive approach, satisfying any of the involved policies guarantees access. While for some sensitive contents, it is more meaningful to conjunctively query all the involved policies so that authorization is only allowed by satisfying the requirements of every policy. Whereas, if parental control is facilitated, parents' policies always get priority over children's policies. We write ν, Λ and > to denote disjunction, conjunction and prioritized order between relationship types, whereas the symbol @ represents a special relationship “null” that denotes “self”. Let us consider some examples of conflict resolution policies as follows.

<read⁻¹, (ownΛtag)>

Both the owner's and the tagged users' “read⁻¹” policies over the photo are honored.

<friend request, (parent>@)>

When child attempts friendship request to someone, parents' policies get precedence over child's own will.

<share⁻¹, (own ν tag ν share)>

A weblink is sharable if either the original owner, or any of the tagged users or shared users allows.

While evaluating an access request, if the decision module discovers two or more opposing policies from the same policy set, it looks up the corresponding conflict resolution policy for the action to determine how to reconcile the conflict. Note that conflict resolution policies only apply to the conflicting policies from the same policy category, the decision module still takes the conjunction of P_{AS}, P_{TU}, P_{TS}, P_{O}, P_{P} and AP_{Sys} to make a final decision.

Access Evaluation Procedure

Algorithm 4 specifies how the access evaluation procedure works. After a session of a user s requests an act against target(s) T, say (s, act, T), the access decision module first collectively assembles s's session policy about act, a collection of act⁻¹ policies from each target in T and the system-wide policies over act and object type, if target is an object. Once all the necessary policies are collected, the decision module extracts each path spec from the graph rules, determines the starting node and the evaluating node, and runs path checking for each path spec using the algorithm similar to one introduced in [27]. The evaluation result of each policy is derived from combining the result of each path spec in the policy. Due to possible conflicts between the results of multiple policies, the decision module looks up the system-defined conflict resolution policies to resolve conflicts and compose the final result, and then determines the access.

Hopcount Skipping

According to the classic idea of “six degrees of separation” and the results of “small world experiment” [39], [45], any pair of persons are distanced by about six people on average. A recent study by Backstrom et al [17] further indicates that on the current social graph of Facebook, the average distance has shrunk to 4.74. Therefore, the network of U2U relationships is characterized by short path lengths, and the hopcount limit in a practical policy is not likely to be a large number. In contrast, U2R and R2R relationships may exhibit a different characteristic. For example, comment may be followed up by a sequence of comments, which may take a long journey for the author of the first comment to reach the author of the last comment. For this and similar cases, we introduce the “skipping” of hopcount limit of resource-related relationships, which differentiate the global hopcount limit on U2U relationships only from the possible long distance of the resource-related relationships that are found in two entities involved in request.

Algorithm 4 AccessEvaluation(s, act, T)

| | |
|---|---|
| 1: | (Policy Collecting Phase) |
| 2: | s.P_{AS} (act) ← s's policy for act |
| 3: | if (T ∩ TU) ≠ then |
| 4: | $T . {P}_{TU} ( {act}^{- 1} ) ← {⋃}_{i = 1}^{\vert T ⋂ TU \vert} {tu}_{i} . {P}_{TU} ( {act}^{- 1} )$ |
| 5: | if (T ∩ TS) ≠ then |
| 6: | $T . {P}_{TS} ( {act}^{- 1} ) ← {⋃}_{j = 1}^{\vert T ⋂ TS \vert} {ts}_{j} . {P}_{TS} ( {act}^{- 1} )$ |
| 7: | if (T ∩ O) ≠ then |
| 8: | $T . {P}_{O} ( {act}^{- 1} ) ← {⋃}_{k = 1}^{\vert T ⋂ O \vert} {o}_{k} . {P}_{O} ( {act}^{- 1} )$ |
| 9: | if (T ∩ P) ≠ then |
| 10: | $T . {P}_{P} ( {act}^{- 1} ) ← {⋃}_{l = 1}^{\vert T ⋂ P \vert} {p}_{l} . {P}_{P} ( {act}^{- 1} )$ |
| 11: | if (T ∩ O) ≠ then |
| 12: | ${P}_{Sys} ( act ) ← {⋃}_{k = 1}^{\vert T ⋂ O \vert} {P}_{Sys} ( {act}^{- 1} , {o}_{k} . type )$ |
| 13: | else |
| 14: | P_{Sys} (act) ← system's policy for act |
| 15: | (Policy Evaluation Phase) |
| 16: | for all policies in s.P_{AS} (act), T.P_{TU} (act⁻¹), T.P_{TS} (act⁻¹), |
| | T.P_{O} (act⁻¹), T.P_{P} (act⁻¹) and P_{Sys} (act) do |
| 17: | Extract graph rules (start, path rule) from policies |
| 18: | Get the controlling user uₒ, if the policy is not specified by s or any t ∈ T |
| 19: | for all graph rules extracted do |
| 20: | Determine the starting node, specified by start, where the path evaluation |
| | starts |
| 21: | if graph rule is extracted from s.P_{AS} (act) and P_{Sys} (act) then |
| 22: | if start = s then |
| 23: | uₒ and every t ∈ T becomes the evaluating node |
| 24: | else |
| 25: | every t ∈ T becomes the evaluating node |
| 26: | else |
| 27: | s becomes the evaluating node |
| 28: | Extract path rules path rules from graph rules |
| 29: | Extract each path spec path, hopcount from path rules |
| 30: | Path-check each path spec for each pair of starting and evaluating node |
| 31: | Evaluate a combined result based on conjunctive or disjunctive connectives |
| | between path specs |
| 32: | Compose the final result from the result of each policy using CRP_{Sys} |

Use Cases

Given the social graph depicted in FIG. 3, below we show how access control of these examples can be realized within the model.

### Example 1

Run into a new acquaintance in a photo. Alice and Dave are

strangers. Dave realizes that Alice and him both commented on Bob's photo, so he decides to poke her to say hello:

(Dave, poke, Alice)

We need the following policies to determine authorization:

*Dave's P_{AS}(poke):

<poke, (uₐ, ([Comment] [[CommentToCommentTo⁻¹, 2]] [Comment⁻¹], 2))>

*Alice's P_{TU}(poke⁻¹): <poke⁻¹, (t, ([Comment]

[[CommentTo•CommentTo⁻¹, 2]] [Comment⁻¹], 2))>

*P_{Sys}(poke):

<poke, (uₐ, ([Σu_r] [[Σr_r*, 2]] [Σu_r], 2))>

The comments from Alice and Dave are connected through Bob's photo with two

R2R relationships. Dave's policy says that he is free to poke his fellow commenter, while Alice allows her fellow commenter to poke her. The system facilitates many kinds of participating users (e.g., comment, like, share, etc.) to poke each other.

### Example 2

View a photo where a friend is tagged. Bob and Ed are friends of

Alice, but not friends of each other. Alice posted a photo and tagged Ed on it. Later, Bob sees the activity from his news feed and decides to view the photo:

(Bob, read, Photo2)

In this example, Bob is trying to access a resource through his friend Alice.

Whether his request can be granted or not depends on the corresponding policies from himself, the target resource and the system.

*Bob's P_{AS}(read):

<read, (uₐ, ([Σu_u*, 2] [[Σu_r, 1]], 2)

*Photo2's P_{O}(read⁻¹) by Alice: <read⁻¹,

(t, ([post⁻¹, 1] [friend*, 3], 4))>

*Photo2's P_{O}(read⁻¹) by Ed: <read⁻¹,

(u_{c}, ([friend], 1))>

*AP_{Sys}(read): <read, (ua, ([Σu_u*, 5] [[Σu_r, 1]], 5)>

*CRP_{Sys}(read): <read⁻¹, (own>tag)>

Bob, as the access requester, allows himself to read any resource that has a direct relationship with his contacts within two hops. Note that “[[ ]] indicates that the local hopcount “1” is not counted in the global hopcount limit “2”. Alice is the original owner of the photo and Ed's image is on it, so based on our default policy, both of them are able to express their own preferences on how the photo should be exposed to others. Alice decides to share the photo with all her direct and indirect friends within three hops, while Ed prefers to keep his privacy and only wants his direct friends to see it. The system, on the other hand, specifies a more liberal rule to promote sharing that allows a user to access resource that relates to his contacts within five hops. We notice that Alice and Ed's authorization policies are apparently in conflict, which needs to be resolved. CRP_{Sys}(read) says that owner's policy takes precedence over tagged user's, so the decision module will ignore Ed's policy and only consider Alice's policy. A system may configure CRP_{Sys}(read) with conjunction or disjunction of the owner's and tagged users' policies for different decisions.

### Example 3

Friend recommendation. Alice is a friend of Bob, Paul follows Bob,

while Alice and Paul are strangers. Bob would like to recommend Alice and Paul to be friends:

(Bob, suggest_friend, Alice, Paul)

Policies applied to this example are shown as follows:

*Bob's P_{AS}(suggest_friend): <suggest_friend, (uₐ, ([Σu_u*], 2))>

*Alice's P_{TU}(suggest_friend⁻¹): <suggest_friend⁻¹, (t, ([friend], 1))>

*Paul's P_{TU}(suggest_friend⁻¹): <suggest_friend⁻¹, (t, ([friend], 2))>

*P_{Sys}(suggest_friend): <suggest_friend, (uₐ, ([Σ*], 2))̂(t, ([Σ*], 2))>

The access request contains two targets Alice and Paul, so we need target user policies from both of them. Bob can suggest friends for his contacts within two hops. Alice welcomes friend recommendation from her direct friends, while Paul allows his friends of friends to do that. The system-specified policy is more liberal, allowing users with any relationship of two hops to be able to suggest friends (e.g., two people who commented on the same photo).

### Example 4

Parental control of policies. The system features parental control such as allowing parents to configure their children's policies. The policies are used to control the incoming or outgoing activities of children, but are subject to the parents' will. For instance, Bob's mother Carol requests to set some policy, say Policy1 for Bob:

(Carol, specify_policy, Policy1)

The following policies are used to make access decision:

*Carol's P_{AS} (specify_policy): <specify_policy, (uₐ, ([own], 1)ν([child•own], 2))>

*Policy1's P_{P} (specify_policy⁻¹) by Bob: <specify_policy⁻¹, (t, ([own⁻¹], 1)>

*P_{Sys} (specify_policy): <specify_policy, (uₐ, ([own], 1)ν([child•own], 2))>

*CRP_{Sys} (specify_policy): <specify_policy, (parent Λ@)>

Carol's policy offers her the ability to define her and her child's policies. Bob only allows himself to manage his own policies. The system enables parental control with the child's consent, so that parents can control their children's policies.

Further developed herein is an access control model for OSNs that provides finer-grained access control for users' usage and administrative access by utilizing user-to-user, user-to resource and resource-to-resource relationship-based policies. These policies are specified in terms of relationship path patterns between the accessing user and the target together with hopcount limit of the relationships. Specifically, we describe the skipping of some relationship path expression in the policy specification in order to offer more expressive policies. The decision modules of the system determine authorizations by retrieving different policies from the accessing session, the target and the system, and then making a collective decision. To address policy conflicts, we apply conflict resolution policies over relationship precedence. The model may be extended to incorporate attribute-based controls. The path checking algorithm of U2U relationships may also be extended to cover the U2R and R2R relationships.

Preserving User Privacy from Third-Party Applications in Online Social Networks

To offer richer functionality, many online social networks (OSNs) have launched social networking platforms that enable third-party developers to contribute applications to the social network through the use of APIs (application programming interfaces). With the support of OSN platforms, third-party applications (TPAs) have become highly popular in a very short period of time.

The emergence of TPAs also poses severe privacy risks to users. TPAs need to consume users' and their friends' data to provide extra functionality to users. Under the current circumstance, TPAs usually receive privileges equal to the TPA users with respect to social graph traversal, and thereby gain access to an abundance of users' information regardless of the actual legitimate needs. Moreover, these applications are available via OSNs but are running on external servers outside the OSN's control. Once they acquire the data, they can use or dispose it in whatever way they want without user or OSN consent. There is no control regarding the usage of user data once it is released to the TPA. The developers of TPAs can aggregate such data and accrue benefit by using or selling the data. The most common approach adopted by existing OSNs is a simple all-or-nothing strategy: a user must agree to allow the application to access some subsets of her profile information before installing and using it. Thus, it is difficult for users to know and control how their information is accessed by those various external parties. The only choice for the user to not provide such data is to not use the application. In particular, TPA providers access the con-tact list of the TPA users and fetch information about the friends of the users, even though those friends did not install the application themselves or consent to this access.

Most previous research on access control in OSNs concentrates on access between regular users in the system, leaving the issues of TPAs out of scope. However, TPAs do not behave like a regular user. They have the ability to aggregate a huge volume of information from their users and can do anything with the collected data without any controls or consent from users or OSNs. OSNs need effective means to prevent privacy leakage for users, in addition to the terms of services and limitation of their APIs. This is likely to be in both OSNs' and TPAs' interests as more users are likely to use privacy preserving OSNs and TPAs.

The issue of inappropriate exposure of user's information to TPAs is addressed. Described is an access control framework that provides flexible and fine-grained controls on how TPAs can access OSN user's data. For this purpose, we classify TPAs into three categories: running outside of OSN, running inside of OSN, and hybrid where some modules are running inside of OSN while others are running outside. The fundamental idea of our approach is to constrain and consume the private information within the OSN system but only allowing privacy-nonsensitive information to be sent outside the OSN for necessary functionality. Therefore, applications or functions running outside the OSN may only receive privacy-nonsensitive data, while those running inside may consume raw private data under the surveillance of the OSN system but are not allowed to transmit the data outside. We also define a relationship-based access control policy language to the framework that allows users to specify how TPAs can access their data in terms of the relationships among users and applications.

This section provides an overview of OSN platforms, describes the privacy issues in those platforms, and reviews the previous literature on these issues.

Social Networking Platforms

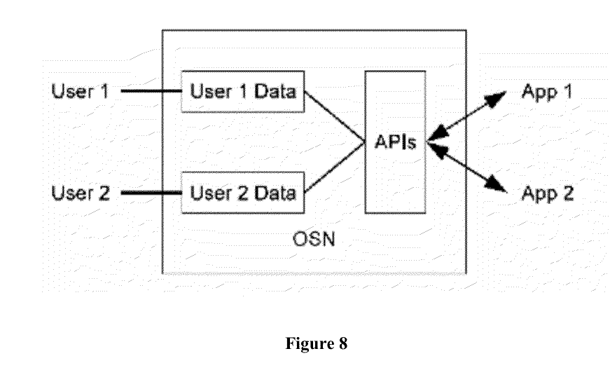

Many of the popular OSNs have released web APIs to allow third-party developers and websites to implement their own services, which can utilize and aggregate user information and activities in OSNs. FIG. 8 presents a typical architecture of current social networking platforms, where TPAs are designed in accordance with APIs and can access user data through APIs. Typically, these applications are integrated in an OSN site but rely on their own external server for running the application.

The Facebook Platform and Google's OpenSocial are two of the leading forces in the business of social networking platforms. The Facebook Platform [46] is a proprietary software environment for launching TPAs in Facebook. The core of Facebook Platform is the Graph API, which forms the primary way of retrieving and posting data in Facebook. It allows developers to define objects and actions in the social graph, and to create new instances of objects and actions. Google's OpenSocial [47] is an open source cross-platform competitor to the Facebook Platform for building social applications. It defines a common API for applications across multiple websites, through which OSNs can grant applications access to the social graph as well as messaging service and update feeds. Its greatest advantages over Facebook Platform is its interoperability within the context of multiple OSNs.

Privacy Issues with Current Platforms

On current platforms, for an OSN user to install an application, a dialog is displayed to her showing that the application requests an access to a list of her profile data. Different from access control policies for user-to-user interactions, the user cannot express her privacy preferences for data that are accessed by applications. In fact, many OSNs currently only provide an all-or-nothing policy when it comes to application-to-user interactions, without letting OSN users specify which information TPAs can access. Thus, even if the application only needs one piece of profile data, the user has to agree to grant the application full access to her profile data; otherwise, she cannot use the application at all. Recently, some OSNs offer users more customized privacy management regarding TPAs than before, where users are allowed to opt-in or opt-out some categories of profile data. However, the essential problem still remains. First, the coarse-grained privacy control does not support users to specify access control policies for each piece of data users own, nor does it distinguish different types of actions application can exercise on data. Second, users are not aware of what kind of data the application really needs. Applications can still ask for more data than they really need, which simply violates the principle of least privilege. We believe it is more appropriate to mediate access on a per request basis rather than approve access in advance during the time of installation. Third, some permissions are given by user's friend who installed the application, without user's knowledge. This poses a serious exposure to those users who are not willing or interested to use the applications.

TPAs run on their own servers or other hosting services that are beyond the control of OSN systems. Once applications get user information, they can aggregate the information for their own use, or sell it to other external parties. There exists no enforcement to police how applications and their developers use user data. The large number of privacy leakage incidents by applications in recent years raises OSN users' concerns on this matter, and suggests them not to completely trust these third-party applications.

It is difficult for user to know and control the various entities who can gain access to their information and to limit such flow without losing the various features brought by these third-party entities.

Related Works

There has been considerable work seeking to resolve the privacy issues regarding TPAs. Table 7 below summarizes the characteristics of some solutions proposed recently.

TABLE 7
Comparison With Previous Solutions

| | | Antho. | Singh | | | Besmer | Egele | |
|---|---|---|---|---|---|---|---|---|
| | Felt [54] | [48] | [59] | Viswa. [60] | Shehab [58] | [49] | [53] | ours |
| Communication Intercepter | X | X | | | | | X | |
| Information Flow Control | | | X | X | | | | |
| Data Generalization | | | | | X | | | |
| User Specified Privacy Preference | | X | | | X | X | X | X |
| User-To-Application Policy Model | | | | | | X | | X |
| Separating Components of Application | | | X | X | | | | X |

All communication between applications and data in OSNs is encapsulated by APIs. However, current APIs are not designed with the purpose of access control in mind, letting TPAs access user data without obstruction. To prevent TPAs from directly interacting with user data through APIs, several proposed proxy designs intercept all requests from TPAs, exert users' privacy preference on data retrieved from the OSN, and then return the sanitized or dummy data to TPAs [48, 53, 54]. The enforcement of such designs varies from server-side proxy to client-side plug-in, according to the trusted entities the designs rely on.

Singh et al [59] presented xBook framework to prohibit untrusted applications from leaking users' private information. TPAs are hosted on trusted xBook platform, which confines application execution and mediates information flow between different application components. Inspired by xBook, the system proposed by Viswanath et al [60] enforces sandbox structures on both server and client sides to restrict information flow from users to application developers. Our work shares a common design strategy with these two systems by separating applications into multiple components and restricting the information flow between components.

A number of researchers seek to support user-specified privacy preference over what information can be accessed by TPAs. The collaborative privacy management (CPM) framework [48] allows users to define privacy configurations and share them with others. In the approach presented by Shehab et al [58], users can choose to opt-in, opt-out, or generalize the application requested data to reflect their access preferences for the applications. PoX [53] uses a dedicated Facebook application to store access control lists for users, which indicate what application should be allowed to access what pieces of information. These proposals contrast with our novel approach in that they do not offer a complete access control policy model for users to specify their privacy preferences. Besmer et al [49] introduced a new application-to-user policy that restricts application's access to user information while still allowing desirable functionality, which is most similar to ours. However, in addition to the policy model, we also describe a framework that separates application components for finer-tuned information flow controls.

The Framework

In this section, described is an access control framework that en-forces better privacy preservation for users against third-party applications. Our goal is to prevent TPAs from learning user's private information while still maintaining the functionality of the applications.

Overview

As discussed earlier, existing access control mechanism gives applications too much freedom in accessing user's information. A survey conducted by Felt et al [54] indicated that 91% of the 150 top Facebook applications have unnecessary access to user's private data, violating the principle of least privilege. On the other hand, completely limiting the applications from user data or providing fake data to them may harm the functionality of applications or even their own business models.

To achieve a balance between application functionality and user privacy, we first describe taxonomy of user's information based on the value for applications and users, as shown in Table 8.

TABLE 8
Strategy

| Data Classification | Strategy |
|---|---|
| unnecessary & private | do not permit |
| unnecessary & non-sensitive | user's choice |
| essential & non-sensitive | transmittable outside of OSN |
| essential & private | processable with OSN |

User information can be classified into four categories. The first row indicates data that is inessential for application but of significance to user privacy. It is definitely unnecessary for TPAs to acquire such data, thus requests for the data will not be permitted in any circumstance. If the data is not necessary for running of application and is not private (Row 2), disclosing it does not breach privacy and the decision is up to user's own choice. For data essential for application, however, we need a special scheme to ensure the functionality without privacy leakage. Unlike other approaches that do not trust the OSN systems [57], we assume the OSN systems are always trustworthy with respect to user privacy, but TPA server may not be. User's private information should be kept away from these untrustworthy external servers. Among the data that is essential for application functionality, some are of less privacy concerns and thus accessible by untrustworthy external entities (Row 3), while others are sensitive private information that require proper protection against external entities (Row 4).

The premise of our approach is that running an application may not require user's private information, and even if it requires it not every function of the application needs the private information. Therefore, to preserve user privacy and application functionality, our fundamental strategy is to leave private data within OSN system and to allow external servers of TPAs to retrieve non-private data.

The Design

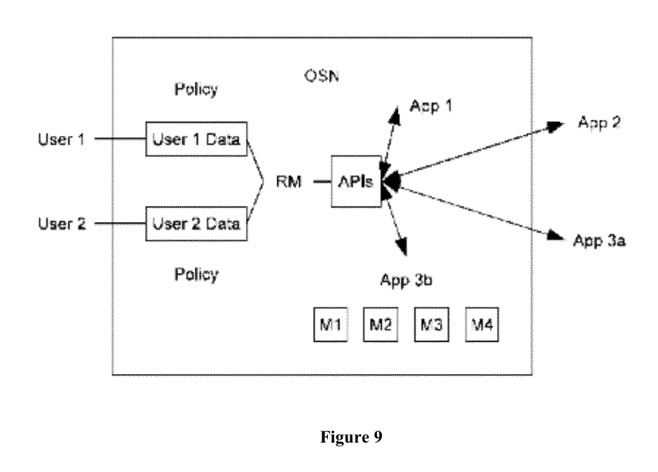

Described is an access control framework, which modifies the current architecture of FIG. 8 to accommodate our strategy. As shown in FIG. 9, the architecture of the proposed framework has a major distinction from the current architecture: in our framework, applications can be divided into two components, internal component and external component. An application requires a set of functional modules. These functional modules can run as either internal or external components. The modules running as an internal component can receive necessary information only through OSN API, hence are trusted not to transmit any sensitive information to the TPA server. The modules running as an external component are managed by the TPA developer, hence not trusted. TPA developers can decide whether a functional module should be in an internal or external component based on what kind of data the modules consume and, if users' private data is used by the module, whether the users' private data need to be stored at the TPA server or not. If a module utilizes privacy sensitive information but the corresponding application does not need to collect users' private information in its server, it should be the TPA developers' (and even OSN providers') interest to let the module reside within OSN as this is likely to attract more privacy-aware users to try this application.

As mentioned earlier, FIG. 9 exhibits three different forms of applications based on the component types used: the one entirely running inside OSN (e.g., App 1), the one entirely running on external server (e.g., App 2), and a hybrid that includes both internal and external components (e.g., App 3). In the current architecture, OSN systems only provide APIs for TPAs to access user's information. Almost all of the existing TPAs are hosted on their own external servers, and therefore belong to the second category. However, if OSNs accommodate our design framework, the majority of TPAs are likely to operate in the hybrid form where internal components run the functions that utilize users' privacy sensitive information but do not need to store this information at TPA server, while the remaining functions are kept at external server.

Apart from the separation of application functions, the framework also includes three primary components: reference monitor (RM), API and policies. In FIG. 9, Apps can request certain in-formation only through APIs which limit the apps' communication capability. The RM evaluates the requests received by the APIs then approves or denies them according to the corresponding policies. In this framework, application policies are specified by the resource owner. We will describe our policy model in detail in the next section.

The Application Components

As mentioned earlier, in this framework, the majority of TPAs are likely to run in hybrid form, consisting of both internal and external components. The internal and external components of an application are hosted on servers with different trustworthiness, and can access various user information with different privacy sensitivity. Hence, the communications between these components needs to be precisely managed to prevent unnecessary information leakage. In the proposed social networking platform, the internal and external components can communicate with each other only through OSN-specified APIs which allows only certain types of pre-defined communications.

Between the internal and external components, we define three types of communications: communications with system calls, non-private data and private data. The communication using system calls is a mechanism used by both internal and external functional modules for sending a message (e.g., a function call) to other components. It is used to trigger and handle specific events, and does not contain information about users. In this framework, we allow two-way system call communications between the components. A non-private data communication refers to a message transmission between application components where the message contains non-sensitive information fetched from users, such as keystrokes, mouse clicks, or puzzle results. This type of communication needs to be used if the messages that need to be shared cannot be transmitted using a system call. A communication with private data, on the other hand, is a message transmission between internal and external components that includes users' private information.

Note that internal modules typically require to access users' private data as that is why they reside inside the OSN. As internal components reside in the trusted OSN servers, users are more likely to allow the internal components to access users' private information. Here, we assume all internal modules are evaluated by the hosting OSN and their functional behaviors (such as what kind of data can be released to external components) are verified. As shown in FIG. 9, the internal components can be further divided into six types of modules, based on the criteria shown in Table 9. In Table 9, internal modules are classified using two main criteria. The columns show that internal modules can be created/provided by either OSN provider or TPA developer, while the rows show two types of communications based on what kind of messages can be transmitted.

TABLE 9
Module Types In Internal Components

| | OSN provided | 3rd-party provided |
|---|---|---|
| Communication w/ | M1 | M2 |
| system calls | | |
| Communication w/ | M3 | M4 |
| non-private data | | |

Module Type 1 (M1):

OSN systems may offer their own functional modules to fulfill some tasks for applications, such as gadgets and widgets. This type of module is trusted as it is created by the OSN system, and thus most likely to be allowed to access users' private information. It can communicate with other application components through system calls, but any communication related to user data is disallowed.

Module Type 2 (M2):

Just like M1, this type of module can receive and send system calls with the components on external servers, but is not allowed to transmit any customized messages to the components outside. The difference between M2 and M1 is that M2 is provided by third-party developers rather than the OSN system. This can be the case when an application needs an internal module that is not available by OSN but can communicate with external component using only system calls provided by OSN API. The above two modules can be used to perform tasks in which users' private information is needed and communication between internal and external components can be done using system calls only. One motivating example is the notification sending scenario, where an external component triggers a request, and then an internal component can take over and fulfill the job and request job status information back to the external component without letting the external component know the information about the actual notification recipients.

Module Type 3 and 4 (M3, M4):

In addition to system call, these two types of module can send privacy-nonsensitive information to the external parties. For examples, such modules can record users' keystrokes and mouse clicks during the game, and send them back to external server. While a sanitized form of users' private data could be considered as non-private data and belong in these types, sanitization issues are outside of this paper's scope.

We have identified four possible types of modules for the internal component. While application developers can choose any combination of them to construct the internal component of their application, it is also possible to see these types in a hierarchy as M1 and M2 could be considered more privacy preserving than M3 and M4 depending on the available system calls. For simplicity, we do not consider any ordering of the modules. The proposed social networking platform can mediate information flow in any overt channel between the components, according to user's policies.

Theoretically, while there could be modules that do not need to communicate with external components, we believe this type of internal modules are less realistic hence. Likewise, one can also consider internal modules that can overtly transmit user's private data to TPA server. However, this approach does not preserve user privacy.

The Policy Model

Most OSNs offer access control policies for regulating user-to-user interactions, which are usually based on relationships between users in the social graph. Many researchers including ourselves also proposed a number of relationship-based access control [56] solutions that can improve the current approach from different aspects [50-52, 55]. At the same time, the prevailing approach of ad-dressing application-to-user interactions in existing social network platforms is rudimentary and course-grained to say the least. For example, in Facebook, users now can select what kind of information they are willing to share or not share with third party applications in general. But for a specific application, the only thing users can do is to approve all access the application requests during the installation stage, or otherwise deny the request and terminate the installation.

The most unique characteristic that distinguishes OSNs from other systems is that users and data objects in OSNs are interconnected through different types of relationships in the social graph. Installing and using an application can be also viewed as an establishment of a special relationship between user and application. Hence, it is intuitive to apply relationship-based access control to govern application-to-user interactions. Inspired by our previous work about user-to-user interactions [51, 52], we describe a policy model for controlling application's access in OSNs in terms of relationships.

Relationship-Based Policies

Social graph depicts the relationships between users in OSNs, and it can be extended to include resources as well. Information sharing and social interactions among users are typically based on such graph. Social networking platforms would also benefit from the social graph by taking advantage of the social relationships to offer a richer experience for users. The platform would allow an application to traverse the social graph to access information owned by the application user's friends² through the application user. Thus, applications are able to reach users that have not installed the application at all. ² Here, by “friends”, we mean people who have any direct user-to-user relationship with the user, instead of people who specifically maintain a “friend” relationship with the user.

In most existing OSNs, access control for user-to-user interactions is based on the topology of the social graph, where granting access permission is subject to the existence of a particular relationship or a sequence of relationships between the access requester and the target or the owner of the target, and the access control policies are specified in terms of such relationships. We can apply this paradigm of access control to application-to-user interactions by connecting applications to the social graph and considering application-to-user relationship for relationship-based access control.

Our framework comes with a policy model that allows users to specify how applications can access information owned by themselves and their friends in terms of the relationships between the application and the users. The available relationships for users to choose from include “install” relationship between the application and the users, in addition to all other user-to-user relationships among users in OSNs. Basically, users can use a combination of these relationships to govern applications' access to resource.

As mentioned earlier, applications can access the friends' information of an application user without consent from the friends, and sometimes, beyond the application user's expectation as well. Effectively, users have delegated the rights to decide which applications can be trusted to their friends. To resolve the problem, some OSN sites now offer users the ability to select categories of information that can be disclosed to applications that they have not in-stalled in case their friends use those applications. However, this mechanism is still far from user's expectation for fine-grained access control. To this end, the proposed framework considers policies of both the application users and their friends regarding the application's access. Although most current APIs only allow applications to access direct friends of their users, our policy language actually supports the extension to multiple hops of relationships for more expressive policies.

Policy Specification

The system models an application's access request to user information as a tuple <requester, action, target>, where requester indicates the application that launches the access request, action denotes the type of access the requester wants to exercise, whereas target represents the target object of the access. A target can be the user executing the application (i.e., application user), the application user's friend, or a data object owned by one of them. The set of supported actions is determined by the API of the social networking platform. The granularity of target objects is chosen based on the system designer's decision, possibly varying from data object to data type.

Access control policies for application-to-user interactions are composed of four elements:

<action, target, (start, path rule), 2^{Module Type}>,

where action specifies the type of access, and target is an optional parameter only for access against resource, denoting the resource to be accessed. It remains blank when the requested access is against a user.

For the third element, start is the position where access evaluation begins, which can be either the target user indicated in the request, the owner of the target object (denoted as owner), or the application requesting access (denoted as requester). A path rule is composed of one or more relationship paths, with each representing the required pattern of relationship between the involved parties in order to grant access. For example, install represents the relationship between the application and the application user, “install•friend” denotes the relationship between the application and the friend of the application user, whereas “Ø” indicates no explicit relationship path but the starting node itself is allowed. Given a pair (start, path rule), if start is the target user or resources owner, the reference monitor checks if the requester (i.e., application) can be reached via relationship path specified in path rule. If start is the requester, the reference monitor then evaluates from the requester to see the relationship path between the requester and the target user or resource owner.

The last parameter 2^{Module Type} indicates the set of application module types that is allowed to access, where ModuleType is a set composed of M1, M2, M3, M4 and external. It enables the resource owner to specify different policies for different application modules regarding the same pair of action and target. For example, user Alice may allow some internal modules of an application (see App 3b in FIG. 9) she installed to access her birthday, but disapproves the external component of the application to access (see App 3a in FIG. 2) the same data.

### EXAMPLES

Below we show two examples to elaborate how users can use the policy model to control application's access in OSNs.

### Example 1

### App Request Notification

Once a user has installed and used an application, the application may start sending app re-quests to the user's friends or suggesting new applications to the user. The notification of such requests is annoying to many people. In general, users usually tend to hide their identities from applications they do not know. In this case, the following policies may help user Alice and her friends keep their privacy with respect to app requests:
For applications she installed #1: <app request, _, (target user, install), {M1, M2, M3, M4, external}>
For applications she installed #2: <app request, _, (requester, install•friend), {M1, M2}>
For applications her friends installed: <app request, _, (target user, friend•install), {M1, M2}>

The first policy applies to requests such as <AppX, app request, Alice>, saying that applications she installed are allowed to send her app requests about activity updates and suggestions for new applications. The pair (target user, install) expresses the applications that she installed. The second policy states that only the M1 or M2 modules of the applications she installed are allowed to send app requests to her friends. Here, (requester, install•friend) identifies users who are friends of the application user (i.e., Alice). The last one regulates whether applications her friends installed can send her notification of app requests. In this case, (target user, friend•install) identifies the applications installed by Alice's friends. The last two policies both deny the external component of the applications to identify users or access users' information who did not have them installed. Instead, the M1 or M2 modules can fulfill the task of sending out such requests without letting the external part learn the identities of those recipients.

### Example 2

### Access User's Profile Information

Among the data that users put or generate in OSNs, some contains private information about users and should be safeguarded within the trusted OSN environment, while others may be appropriate for less trustworthy parties to access. For example, Bob prefers not to release his date of birth, relationship status, and email address to game applications he or his friends installed. On the other hand, the game application requires his age for customer survey, and normal key strokes and mouse moves during playing for proper functionality. To balance privacy and functionality, he expresses his preference through the following policies:
Policy about Bob's date of birth: <access, date of birth, (owner, install), {M1, M2}>
Policy about Bob's key strokes: <access, keystrokes, (owner, install), {external}>
Policy about Bob's email address for applications his friends installed: <access, email address, (owner, friend•install), {M1, M2, M3, M4}>

The policy about Bob's date of birth allows the M1 and M2 modules of the application to access the data but denies any re-quest from other internal modules and the external component. Key strokes in the game contains information that may need to be processed (possibly with significant computation) that is not likely to be done within OSN systems but more likely to be done at TPA, therefore is allowed to be accessed by the external component of the application. Similarly, the third policy indicates that only the M1-M4 modules of the applications that Bob's friends installed are allowed to access Bob's email address. This policy is used together with his friend's policy when an application his friend installed requests to access his email address. Since there is no overt flow of private information between the internal modules and external components in the proposed framework, email address that the internal component accesses is not going to be transmitted to the external component.³

Described herein is an access control framework for social networking platforms, preventing users' private information from leaking to external parties. Our design splits third-party applications into internal and external components, allowing the internal components to access private information but keeping it away from the external ones. We provided a simple policy model for application-to-user policies to regulate application's access. Users can specify different policies for different components of the same application, enabling more flexible and finer-grained control. Though the approach does not eliminate privacy issues completely, it offers users greater controllability for their privacy against TPAs while allowing necessary features for the applications.

Relationship-based access control (ReBAC) has been adopted as the most prominent approach for access control in online social net-works (OSNs), where authorization policies are typically specified in terms of relationships of certain types and/or depth between the access requester and the target. However, using relationships alone is often not sufficient to enforce various security and privacy requirements that meet the expectation from today's OSN users. Disclosed herein we integrate attribute-based policies into relationship-based access control. The proposed attribute-aware ReBAC enhances access control capability and allows finer-grained controls that are not available in ReBAC. The policy specification language for the user-to-user relationship-based access control (UURAC) model proposed in [66] is extended to enable such attribute-aware access control. We also present an enhanced path-checking algorithm to determine the existence of the required attributes and relationships in order to grant access.

Authorization decisions in traditional access control models (e.g., discretionary access control, mandatory access control, role-based access con-trol, etc.) are primarily based on identities, group or role memberships, and security labels, etc. However, they fail to cope with the scalability and dynamicity of online social networks (OSNs). In OSNs, it is not practical for users to specify all the users who can access their information in a traditional way. Instead, Relationship-based Access Control (ReBAC) [67, 69] has emerged as the most prevalent access control mechanism for OSNs. With ReBAC, resource owners can specify access control of their information based on their relationships with others, without knowing the user name space of the entire network or all their possible direct or indirect contacts. Accordingly, relationship-based access control has been recognized as a key requirement for security and privacy in OSNs [70], and has been commonly adopted in real world OSN systems since it keeps the balance between ease-of-use and flexibility.

Despite its popularity in both theory and practice, current ReBAC is still far from perfect. Most ReBAC systems merely focus on type, depth or strength of the relationships, lacking support for some topology-based and history-based access control policies that are of rich social significance. For example, they cannot express policies such as “at least five common friends” or “friendship request pending” that require global or contextual information of the social graph. In addition to relationships, attributes of users (such as age, location, identity) also need to be taken into account when determining access. Without introducing attributes, policies like “a common friend named Tom” cannot be described in current ReBAC languages. We combine these attributes of users and relationships with ReBAC to provide users more versatile and flexible access control on their data.

Disclosed herein are the benefits of incorporating attribute-based access control (ABAC) into an existing ReBAC model. A new policy specification is disclosed based on the previous UURAC policy language [66], addressing the access requirements in terms of the attributes of users, relationships and social graphs. Several examples are provided to show the usage of the proposed attribute-aware ReBAC policy language. The path-checking algorithm for finding a qualified path in [66] is also extended to simultaneously check whether the attribute-based requirements are satisfied. We briefly compare the complexity of the algorithm with the original UURAC algorithm, and discuss the changes.

Background and Motivation

In this section, we review existing ReBAC literature followed by discussion on potential benefits of adding attribute-based policies to ReBAC.

ReBAC

Access control based on interpersonal relationships has become the de facto standard solution for OSNs in practice. This is called relationship-based access control (ReBAC) [70]. A number of ReBAC solutions have been proposed in the literature. From these solutions, we can identify at least three decision factors of relationship type, relationship depth, and relationship strength (e.g., trust) that are used in ReBAC.

Some solutions proposed to associate trust with ReBAC, allowing people to specify the strength of their connections by assigning trust values to relationships. Carminati et al. proposed a series of ReBAC models for OSNs, where trust level, type and depth of the user-to-user relationships are identified as decision factors for authorization [63, 64]. In their work, trust values of multiple relationships of the same type on a path can be calculated to form an indirect trust between users that are not directly connected. In [62], Carminati et al. introduced a semantic web based Re-BAC solution, which defines authorization, administration and filtering policies to control the access. Another semantic web-based approach proposed by Masoumzadeh et al. allows both users and the system to express policies based on access control ontologies [75].

Fong et al. presented a Facebook-like access control model, featuring four types of policies that cover four different aspects of access in OSNs [68]. The four policies can regulate user search, traversal of the social graph, communication between users, and normal access to objects owned by users. The model mimics the privacy setting used in Facebook at the time of the paper was written. As such it lacks support for multiple types and depth of relationships. Fong et al. also built a formal ReBAC model for social computing applications on top of a modal logic language specification [67]. This model enables support for multiple types and direction of relationships. The model has been subsequently extended for improved flexibility and effiency [61, 69].

Cheng et al. proposed a user-to-user relationship-based access control (UURAC) model with a regular expression-based policy specification language [66]. User-to-resource and resource-to-resource relationships are added to the model in their subsequent work on the URRAC model [65]. Both models are founded on the characteristics identified in Activity Control (ACON) [76, 77].

Beyond Relationships

ReBAC takes advantage of the structure of OSN systems and offers users a simple and effective way for configuring their access control policies. However, ReBAC suffers from two shortcomings. First, most of the ReBAC models rely on the type, depth, or strength of relationships, but cannot exploit more complicated topological information contained in the social graph. For example, many ReBAC proposals can determine whether there exists a qualified relationship path on the graph, but their policy languages cannot express requirements on multiple occurrences of such paths. Second, ReBAC generally lacks support for various contextual information of users and relationships available in OSNs. Such contextual information also called attributes can be utilized for finer-grained access control. In addition to the normal relationship information, some of the attribute examples are user's name, age, role, location, trust in other users, duration of relationships, and so on. Let us consider two examples of attribute-based policies that are applied on ReBAC.

Common friends. The very nature of OSNs encourages new connections. To help users expand their connections, OSNs normally suggest some new connection candidates to a user based on number of common friends they share, for example. This is typically used as a tool for social promotion, but it can be applied to access control as well. Alice can allow a user who is not currently her friend but shares a certain number of common friends with her to access some of her contents. She can also specify that Bob must be a common friend of her and an access requester in order for the requester to get access. In regular ReBAC system, these policies cannot be expressed as they only check the existence of certain relationships but do not count the number of such relationships. Also, due to lack of support for node attributes, ReBAC policies are not able to distinguish particular users on the relationship paths.

Transitive trust. Consider a scenario where relationships are associated with an attribute of trust value, which denotes the strength of connection between two users. Since each user only knows a few direct friends, it is expected that more users are likely to be connected indirectly through their existing connections. Trust values between direct connections are used to compute the transitive trust, indicating the strength of such indirect relationships. A line of research has been addressing the area of trust in OSNs [71, 72, 74], where trust is combined with relationship type and depth as parameters to determine access. However, many limitations can be found in these works. Some only consider a single relationship type, others consider the case of multiple types but lack support for trust comparison and calculation between different types or paths. If we treat trust as an attribute of relationships, it can be mixed with other attributes of users and thus enable finer-grained access control policies, despite the multiple relationship types or paths.

Preliminaries

The UURAC model introduced by Cheng et al. [66] captures user-to-user relationships in OSNs for authorization purpose, and defines a regular expression-based policy specification language. We briefly summarize UU-RAC model as our model is based on it.

Basic Notations

In UURAC, Σ={σ₁, σ₂, . . . , σₙ, σ₁⁻¹, σ₂⁻¹, . . . , σₙ⁻¹} denotes the set of relationship types. Given a relationship type σᵢεΣ, the inverse of the relationship is σᵢ⁻¹εΣ. An action has an active form and a passive form, denoted action and action⁻¹, respectively. If Alice pokes Bob, the action is poke from Alice's viewpoint, whereas it is poke⁻¹ from Bob's viewpoint.

UURAC Model Components

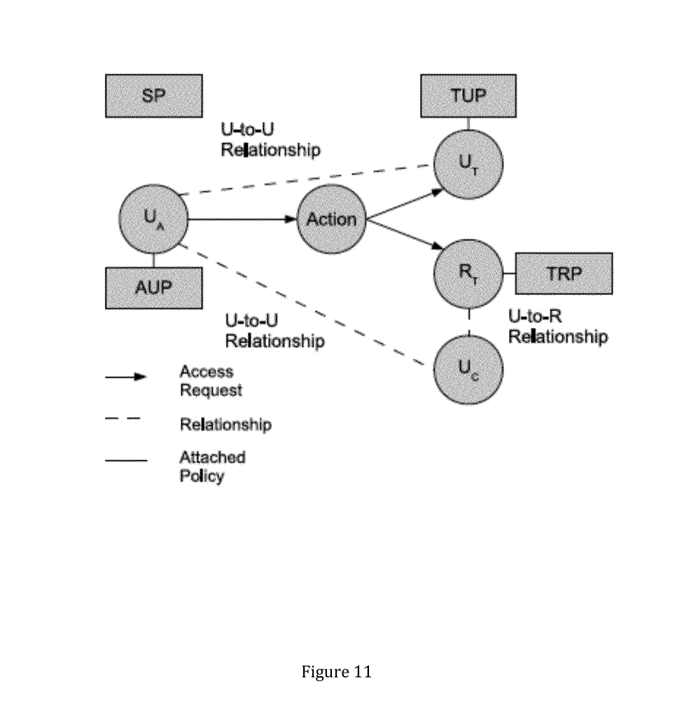

The UURAC model components are illustrated in FIG. 11. Accessing user (uₐ) represents an acting user who requests an access to a target and carries accessing user policies (AUP) which controls the accessing user's access to targets. Each action represents an operation initiated by an accessing user against a target. An action is denoted as action for the accessing user but action⁻¹ for the target. The targets can be either target user (uₜ) (e.g., a user pokes another user) or target resource (rₜ). There is also a controlling user (u_{c}) who controls an access to a resource that has user-to-resource (U2R) relationship with her such as the owner of the resource. An access to a target user is controlled based on the target user policies (TUP) that are configured using user-to-user (U2U) relationships between the target user and the access requesters, while an access to a target resource is controlled based on target resource policies (T RP) that are configured using U2U relationships between the controlling user and the access requester.

An access request <uₐ, act, target> denotes the initiation of an access, where actεAct specifies the type of access requested by the accessing user on the target. If uₐ requests to interact with another user, target is uₜεU. If uₐ tries to access a resource owned by another user u_{c}, target is resource rₜεR where R is a finite set of resources in OSN.

A policy defines the rules that determine how authorization is regulated. Policies can be either system-specified or user-specified. System-specified policies (SP) are system-wide rules enforced by the OSN system while user-specified policies are applied to specific users or resources. User-specified policies include AUP, TUP, and TRP.

Social Graph

As shown in FIG. 3, OSN is abstracted as a directed labeled simple graph, where each node indicates a user and each edge corresponds to a U2U relationship. The social graph of an OSN is modeled as a triple G=<U, E, E> where
U is a finite set of registered users in the system, represented as nodes on the graph,
Σ={σ₁, σ₂, . . . , σₙ, σ₁⁻¹, σ₂⁻¹, . . . , σₙ⁻¹} denotes a finite set of relationship types, where each type specifier a denotes a relationship type supported in the system, and
E⊂U×U×Σ, denoting social graph edges, is a set of existing user relationships.

For every σᵢεΣ, there is σᵢ⁻¹εΣ representing the inverse of relationship type σᵢ. We require that the original relationship and its inverse twin always exist on the social graph simultaneously. Given a user uεU, a user vεU and a relationship type σεΣ, a relationship (u, v, σ) expresses that there exists a relationship of type σ starting from user u and terminating at v. It always has an equivalent form (v, u, σ⁻¹).

UURAC_{A} Model

In this section, the UURAC model is extended to facilitate attribute-aware ReBAC policy specification and enforcement.⁴ ⁴We reiterate that in UURAC only user-to-user relationships are considered so re-sources can only occur as the target of a relationship path. The relationship path itself can only include users.

Attributes in OSNs

OSNs maintain a massive amount of data about attributes of users and resources. Users keep profile information as required by the OSNs, such as name, age, gender, etc. When a piece of resource is uploaded to the OSN, the resource provider is also able to attach some metadata about the resource. Policies can be defined based on this attribute information associated with users and resources. However, the majority of ReBAC systems have focussed on some particular aspects of relationships, such as type, depth, and strength. This makes ReBAC relatively simple and efficient, but also limits the use of ReBAC in terms of control capability. In recent years, studies on attribute-based access control (ABAC) have shown that various contextual information of user, resource, and computing environment could be utilized for highly flexible and finer-grained controls [73, 78, 79]. However, current ABAC solutions are not likely to be readily usable on top of a ReBAC in OSNs. While typical ABAC models only consider the attributes of accessing user, target resource and sometimes computing environment, attribute-aware ReBAC needs to specify which attributes and whose attributes (i.e., user attributes, relationship attributes) on the relationship path between accessing users and target/controlling users should be examined.

For attribute-aware ReBAC, we identify three types of attributes: node (user/resource) attribute, edge (relationship) attribute and count attribute, as follows.

Node attributes. Users and resources are represented as nodes on the social graph. Users carry attributes that define their identities and characteristics, such as name, age, gender, etc. Resource attributes may include title, owner, date, etc.

Edge attributes. Each edge is associated with attributes that describe the characteristics of the edge. Such attributes may include relationship weights, types, and so on.

Both edge attributes and node attributes can apply to a single object or multiple objects. An example of attributes for multiple edges is the transitive trust between two nodes that are not directly connected. For instance, trust values of two or more edges need to be considered to calculate overall trust between accessing user and target/controlling user. Attributes describing multiple nodes are more commonly seen in OSNs, such as average age, common location, or common alma mater between people. Relevant node and edge attributes can be also assembled to enable policy combinations. For instance, Alice may specify a policy saying that “only users who have more than 0.5 trust with Bob can access.”

Count attribute. Count attribute neither describes nor is associated with any node or edge. It depicts the occurrence requirement for the attribute-based path specification, specifying the lower bound of the occurrences of such path.

Attribute-Based Policy Formulation

Attribute-based policy specifies access control requirements that are related to the attributes of users and their relationships. Here, we formally define the basic attribute-based policy language.
N and E are nodes and edges, respectively;
NAₖ (1≦k≦K) and EA₁(1≦l≦L) are the pre-defined attributes for nodes and edges, respectively, where K is the number of node attributes and L is the number of edge attributes;
ATTR(n) and ATTR(e) are attribute assignments for node n and edge e, respectively, where ATTR(n)εNA₁×NA₂× . . . ×NA_{K}, and AT T R(e)εEA₁×EA₂× . . . ×EA_{L}. Each attribute has only single value for its domain.

On the relationship path between two users in OSNs, there may exist many other users connected with different relationships. Each user or relationship carries attributes, which can be utilized for specifying access control rules. In some cases, the attributes of all users or relationships on the path need to be considered. Sometimes, attributes of only certain users or relationships are used. As shown in Table 10, we use the universal quantifier ∀ and the existential quantifier ∃ to denote “all” and “at least one” user(s) or relationship(s), respectively. The notation [ ] is used to represent ranges in the relationship path while { } denotes a set of users/relationships located at a specific distance in the path between accessing user and target/controlling user. In order to express a range or exact position on the path, we use plus and minus signs to indicate the forward (from the start) and backward directions (from the end), followed by a number that denotes the position from the front or the back. Note that indicator for users starts from 0 while indicator for relationships be-gins from 1. For example, for users, +0 means the starting user and −1 represents the second last user on the path; while for relationships, +1 indicates the first relationship on the path and −2 means the second last. The plus-minus sign in the last two rows denotes the forward or backward direction rather than its normal mathematical meaning.

TABLE 10
Attribute Quantifiers

| | |
|---|---|
| ∀ [+m, −n] | All entities from the m^{th} to the n^{th} last, m + n ≦ h where m |
| | and n are non-negative integers and h is a hopcount limit |
| ∀ [+m, +n] | All entities from the m^{th} to the n^{th}, m ≦ n ≦ h |
| ∀ [−m, −n] | All entities from the m^{th} last to the n^{th} last, h ≧ m ≧ n |
| ∃ [+m, −n] | One entity from the m^{th} to the n^{th} last, m + n ≦ h |
| ∃ [+m, +n] | One entity from the m^{th} to the n^{th}, m ≦ n ≦ h |
| ∃ [−m, −n] | One entity from the m^{th} last to the n^{th} last, h ≧ m ≧ n |
| ∀ {2^{{±N}}} | All entities in this set |
| ∃ {2^{{±N}}} | One entity in this set |

An attribute-base policy rule is composed of a quantifier specifying the quantity of certain node/edge attributes, a boolean function of these node/edge attributes f(ATTR(N), ATTR(E)), and a count attribute predicate count≧i, as follows.

<quantifier, f(ATTR(N), ATTR(E)), count≧i>

Note that the quantifier is applied to a node/edge function, but not to the count attribute predicate. For instance, R1 specifies a rule saying that “there must be at least five common connections between the requester and the owner, whose occupation is student”. In R2 and R3, the count attribute predicate is not used and this is shown as ‘ ’, which indicates count≧1 in default. Here, the policy contains a rule indicating that “a user who is connected through adults whose addresses are ‘Texas’ can access”. R3 requires that on a path between the accessing user and target/controlling user, users in three specific distances must be adults.
R1: <∃[+1, −1], occupation(u)=“student”, count≧5>
R2: <∀[+1, −1], (age(u)≧18)Λ(address(u)=“Texas”),_>
R3: <∀{+1, +2, −1}, (age(u)≧18),_>

Policy Specifications

Attribute-based policies are applied on certain relationship paths between accessing user and target/controlling user. For this, we extend the regular expression-based policy specification language proposed in [66]. Table 4 defines a list of notations used in the policy specification language.

Attribute-aware UURAC policies include two parts: a requested action, and a graph rule that conditions the access based on the social graph. As shown in Table 11, we identify several different types of policies.

TABLE 11
Access Control Policy Representations

| | |
|---|---|
| Accessing User Policy | (act, graphrule) |
| Target User Policy | (act⁻¹, graphrule) |
| Target Resource Policy | (act⁻¹, u_{c}, graphrule) |
| System Policy for User | (act, graphrule) |
| System Policy for Resource | (act, (r.typename, r.typevalue), graphrule) |

Actions are denoted in the passive form act⁻¹ in target user policy and target resource policy, since target user/resource is always the recipient of the action. Target resource policy has an extra parameter u_{c}, indicating the controlling user of the resource. The differentiation of active and passive form of an action does not apply to system-specified policies, as these policies are not associated with any particular entity in action. However, when specifying a system policy for a resource, we can optionally refine the resource in terms of resource type (r.typename, r.typevalue).

Table 12 defines the syntax for the graph rules using Backus-Naur Form (BNF). Each graph rule specifies a startingnode and a pathrule. Starting node denotes the user where the policy evaluation starts. A path rule represents a collection of path specs. Each path specification consists of a pair (path, hopcount) that specifies the relationship path pattern between two users and the maximum number of edges on the path, which need to be satisfied in order to get access. Multiple path specifications can be connected with conjunctive “Λ” and disjunctive “ν” connectives. “ν” over path specifications denotes absence of the specified pair of relationship pattern and hopcount limit. The pattern of relationship path represents a sequence of type specifiers from the starting node to the evaluating node.

Unlike in UURAC, we add a new term AttPolicy to the grammar to facilitate attribute-based policies. It can be found either after the whole path specification (path, hopcount) or a segment of the path pattern path. The one that applies to (path, hopcount) is called global attribute-based policy. When it follows a segment of path, it is a local attribute-based policy that only applicable for this segment. For simplicity, the examples hereafter only use global attribute-based policies.

We now show how attribute-based rules can be applied to some examples within UURAC_{A}.

### Example 1

Node attribute and count attribute policy. Alice wants to reveal her profile to users who share at least five common student friends. She can specify the following policy for her friends of friends:
P1: <profile access, (uₐ, ((ff, 2): ∀[+1, −1], occupation(u)=“student”, count≧5))>

If she wants to allow someone who shares a common friend Bob with her to see her profile, the policy can be represented as follows:
P2: <profile access, (uₐ, ((ff, 2): ∀[+1, −1], name(u)=“Bob”,))>

For P1, the system needs to find paths that match (ff, 2) and check the occupation attribute of users on the paths. If there exist at least five such paths, uₐ is allowed to see the profile information of the target.

TABLE 12
Grammar For Graph Rules

GraphRule → “(” StartingNode“,” PathRule“)”
PathRule → AttPathSpecExp |AttPathSpecExp Connective PathRule
AttPathSpecExp → PathSpecExp |PathSpecExp“ : ” AttPolicy
Connective → [symbol]
PathSpecExp → PathSpec | [symbol] PathSpec
PathSpec → “(”AttPath “,” HopCount“) ”|“(” EmptySet“, ” HopCount“)”
HopCount → Number
AttPath → Path |Path “ : ” AttPolicy
Path → TypeSeq |TypeSeq Path
EmptySet →
TypeSeq → AttTypeExp |AttType Exp“.”Typeseq
AttTypeExp → TypeExp |TypeExp“ : ” AttPolicy
TypeExpe → TypeSpecifier |TypeSpecifier Wildcard
AttPolicy → use dedicated parser to process
StartingNode → uₐ|uₜ|u_{c}
TypeSpecifier → σ₁|σ₂|...|σₙ|σ₁⁻¹ |σ₂⁻¹ |...|σₙ⁻¹ |Σ
Wildcard → “ * ”|“?”|“ + ”
Number → [0 − 9]+

For P2, once a (ff, 2) path is found and the name of the user on the path equals to Bob, the system would grant access.

### Example 2

Edge attribute policy. Alice grants users to access Photo1 if the user is

within 3 hops away and can reach her on a path with a minimum 0.5 trust value of friend relationships on each hop. Such policy is specified as follows:
P3: <read, Photo1, (uₐ, ((f*, 3): ∀[+1, −1], trust(r)≧0.5,))>

The system will check each edge on the path to ensure its trust value meets the requirement, before granting access.

### Example 3

Capturing a UURAC policy. The following policy only contains

relationship-based requirements (f*, 3), where node/edge attributes and count attribute are both empty:
P4: <poke, (uₐ, (f*, 3): ∃[+0, −0],_,_))>

The UURAC_{A} model is seamlessly compatible with the UURAC model. The example 3 shows how UURAC policy can be captured in UURAC_{A}.

Algorithm
Algorithm 5 AccessEvaluation(uₐ, act, target)

| | |
|---|---|
| 1: | (Policy Collecting Phase) |
| 2: | if target = uₜ then |
| 3: | AUP ← uₐ's policy for act, TUP ← uᵢ's policy for act⁻¹, SP ← system's policy for |
| | act |
| 4: | else |
| 5: | uₐ ← owner(rt), AUP ← uₐ's policy for act, TRP → uₐ's act⁻¹ on rₜ, SP ← |
| | system's policy for act, r.type |
| 6: | (Policy Evaluation Phase) |
| 7: | for all policy in AUP, TUP/TRP and SP do |
| 8: | Extract graph rules (start, path rule) from policy |
| 9: | for all graph rule extracted do |
| 10: | Determine the starting node, specified by start, where the path evaluation starts |
| 11: | Determine the evaluating node which is the other user involved in access |
| 12: | Extract path rules path rule from graph rule |
| 13: | Extract each path spec path, hopcount and/or attribute rule attpolicy from path |
| | rules |
| 14: | Simultancously path-check each path spec and evaluate the corresponding attribute |
| | rule using Algorithm 2 |
| 15: | Evaluate a combined result based on conjunctive or disjunctive connectives between |
| | path specs |
| 16: | Compose the final result from the result of each policy |

This section addresses the access evaluation of UURAC_{A}. UURAC [66] provides a path-checking algorithm to find a qualified path between the access requester and the target (or the resource owner) that meets the ReBAC requirements. To enforce attribute-based policies, the access evaluation should incorporate attribute-based policies during path-checking One may run attribute checking on the result paths found by the UU-RAC algorithm. However, this is likely to be inefficient. Disclosed herein is a modified path-checking algorithm to incorporate an attribute-based policy evaluation on the fly during path finding process.

Access Evaluation Procedure Access requests can be evaluated as described in Algorithm 10. For an access request (uₐ, act, target), the system fetches uₐ's policy about act, target's act⁻¹ policy and the system-specified policy for act. The decision module extracts path specification (path, hopcount) and attribute-based rules attpolicy from these policies. It runs the path-checking algorithm to determine the result for each policy. During path-checking, the decision module also needs to keep track of all of the involved attributes and make sure they satisfy the attribute-based policies. Finally, the results of all chosen policies in evaluation are composed into a single result. The existence of multi-user policies may raise policy conflicts. To resolve this, we can adopt the conflict resolution policy proposed in [5], which is based on a disjunctive, conjunctive, or prioritized strategy.

Algorithm 6 DFSPathchecker(G, path, hopcount, s, t, globalattpol)

| | |
|---|---|
| 1: | DFA ← REtoDFA(path); currentPath ← NIL; d ← 0 |
| 2: | stateHistory ← DFA starts at the initial state |
| 3: | Extract the quantifier symbol and interval/set information from |
| | globalattpol |
| 4: | Get the required rules from attributes of edges and nodes f(ATTR(E), |
| | ATTR(N)) |
| 5: | Fetch the requirements of count attribute “count ≧ i”. |
| | If it is omitted, “count ≧ 1”. |
| 6: | Assign temporary space for attributes according to the size of the |
| | interval/set and the hopcount limit |
| 7: | Initialize counter count ← 0 |
| 8: | if hopcount ≠ 0 then |
| 9: | return DFST(s) |

Algorithm 3 DFST(u)

| | |
|---|---|
| 1: | if d + 1 > hopcount then |
| 2: | return FALSE |
| 3: | else |
| 4: | for all (v, σ) where (u, v, σ) or G do |
| 5: | switch |
| 6: | case 1 v ∈ currentPath |
| 7: | break |
| 8: | case 2 v ∉ currentPath and v = t and DFA with transition σ is |
| | at accepting state |
| 9: | if v and (u, v, σ) is within the range specified by quantifier |
| | then |
| 10: | attrList ← attrlist.(ATTR(v), ATTR(u, v, σ)) |
| 11: | if f(ATTR(v), ATTR(u, v, σ)) = TRUE then |
| 12: | count ← count + 1 |
| 13: | if count ≧ i then |
| 14: | d ← d + 1; currentPath ← currentpath.(u, v, σ) |
| 15: | currentState ← DFA takes transition σ |
| 16: | stateHistory ← stateHistory.(currentState) |
| 17: | return TRUE |
| 18: | else |
| 19: | attrList ← attrList\(ATTR(v), ATTR(u, v, σ)) |
| 20: | else |
| 21: | d ← d + 1; currentPath ← currentPath.(u, v, σ) |
| 22: | currentState ← DFA takes transition σ |
| 23: | stateHistory ← stateHistory.(currentState) |
| 24: | return TRUE |
| 25: | break |
| 26: | case 3 v ∉ currentPath and v = t and transition σ is valid for |
| | DFA but DFA with transition σ is not at accepting state |
| 27: | break |
| 28: | case 4 v ∉ currentPath and v = t and transition σ is invalid |
| | for DFA |
| 29: | break |
| 30: | case 5 v ∉ currentPath and v ≠ t and transition σ is |
| | invalid for DFA |
| 31: | break |
| 32: | case 6 v ∉ currentPath and v ≠ t and transition σ is |
| | valid for DFA |
| 33: | d ← d + 1; currentPath ← currentPath.(u, v, σ) |
| 34: | currentState ← DFA takes transition σ |
| 35: | stateHistory ← stateHistory.(currentState) |
| 36: | if (DFST(v)) then |
| 37: | return TRUE |
| 38: | else |
| 39: | d ← d − 1; currentPath ← currentPath\(u, v, σ) |
| 40: | attrList ← attrList\(ATTR(v), ATTR(u, v, σ) |
| 41: | previousState ← last element in stateHistory |
| 42: | DFA backs off the last taken transition σ to previousState |
| 43: | stateHistory ← stateHistory\(previousState) |
| 44: | return FALSE |

Attribute-aware Path Checking Algorithm. The path-checking algorithm, as shown in Algorithm 6, uses a depth-first search (DFS) strategy to traverse the social graph G from a starting node s. The mission is to find relationship paths between the starting node s and the evaluating node t, that satisfy the policy. The pair of path pattern path and hopcount limit hopcount specifies the relationship-based requirements, whereas globalattpol indicates the attribute-based rules.

Let us consider the example policy P1: <profile access, (uₐ, ((ff, 2): ∃[+1, −1], occupation(u)=“student”, count≧5))>. The grammar extracts the starting node uₐ and splits the relationship-based rules (ff, 2) and the attribute-based rules “∃[+1, −1], occupation(u)=“student”, count≧5”. Algorithm 6 then constructs a DFA (deterministic finite automata) from the regular expression ff. This is done by the function REtoDFA( ). Variables currentPath and stateHistory are initialized to NIL and the initial DFA state, respectively. The attribute-based rule is divided into three parts: “∃[+1, −1]”, “occupation(u)=‘student’” and “count≧5”. “∃[+1, −1]” quantifies the whole path between the access requester and the target (or the resource owner) to which the following node attribute function applies. “occupation(u)=‘student’” is a function of node attributes that checks the occupation of the users on the path. The count attribute predicate “count≧5” specifies the required number of qualified relationship paths. To store the attribute values of nodes and edges during traversal in this example, we need space for attributes of 1 node and 2 edges. In general, if the interval is [+a, −b] and the hopcount limit is c, we need to assign space for attributes of (c−a−b+1) nodes and (c−a−b) edges.

After setting the hopcount indicator d to 0, Algorithm 6 launches the DFS traversal function DFST( ) shown in Algorithm 7, from the starting node. Given the node u, the algorithm first makes sure taking one step forward does not violate the hopcount limit. Otherwise, it has to exit and return to the previous node. If further traversal is allowed, the algorithm starts to pick an edge (u, v, σ) from the collection of all incident edges leaving u one by one. According to the path pattern ff in the example, at the first step, the algorithm specifically looks for an unvisited edge of type f terminating at a node other than the evaluating node (case 6). If such edge is found, let's say (uₐ, u₁, f), the algorithm increments d by 1, adds the edge to currentPath, moves the DFA from the initial state by taking transition f and updates the DFA state history accordingly. It also adds the corresponding attributes of edge (uₐ, u₁, f) and node u₁ to the attribute list attrList for later evaluation, since uᵢ is 1 hop away from uₐ and thus is within the range [+1, −1]. The algorithm then continues to run DFST( ) on the new node u₁. From node u₁, it repeats the previous process again by checking the hopcount limit and picking new incident edges. Since the hopcount limit is 2, the algorithm has to find an unvisited edge of type f that terminates at t (case 2). Once the edge (uᵢ, t, f) is discovered, the algorithm goes on to find the corresponding attributes for evaluation. [+1, −1] indicates that we also need to check the attributes of the second last node on the path, which is u₁. Since we already added u₁'s attributes to the list, the algorithm simply runs attribute function f (ATTR(u₁)) to see if it satisfies the requirements. If yes, we then check the count attribute, which is count in this case. The policy says it requires five qualified paths, thus the algorithm has to increment the counter and return to the previous node to search for another 4 paths. If (uₐ, u₁, f)(u₁, t, f) is the fifth path we found, DFST(u₁) should return true and all its previous DFST( ) calls as well. Eventually, it makes Algorithm 6 to return true, indicating we found the necessary amount of paths that satisfy the policy. If the node/edge attributes do not match the requirements, the algorithm removes the attributes from the list (line 18-19) and try the next edge. After finishing edge searching at this level and returning to the previous DFST( ) call (line 38-43), it has to drop the edge and reset all variables to the previous values. Algorithm 2 returns false after all incident edges leaving uₐ have been unsuccessfully searched. The proof of correctness of this algorithm is fundamentally the same as the algorithm for UURAC[66]. The new algorithm neither brings in more edges to be considered nor increases the depth of recursive traversal to be taken. Hence, its complexity is still bounded between O(dmin^{Hopcount}) and O(dmax^{Hopcount}), where dmin and dmax stand for the minimum and maximum out-degree of node, and Hopcount denotes the hopcount limit. Attribute-base check introduces additional overhead when the algorithm finds a possible qualified path. The overhead costs are proportional to the amount of attributes as well as the type of attribute functions considered in the policy, which is not related to the structure of the social graph.

Users and resources in online social networks (OSNs) are interconnected via various types of relationships. In particular, user-to-user relationships form the basis of the OSN structure, and play a significant role in specifying and enforcing access control. Individual users and the OSN provider should be enabled to specify which access can be granted in terms of existing relationships. Described herein is a novel user-to-user relationship-based access control (UURAC) model for OSN systems that utilizes regular expression notation for such policy specification. Access control policies on users and resources are composed in terms of requested action, multiple relationship types, the starting point of the evaluation, and the number of hops on the path. Described are two path checking algorithms to determine whether the required relationship path between users for a given access request exists, and provide proofs of correctness and complexity analysis.

Online social networks (OSNs) have become ubiquitous in daily life and have tremendously changed how people connect, interact and share information with each other. Users share an enormous amount of content with other users in OSNs for a variety of purposes. The sharing and communications are based on social connections among users, namely relation-ships. Since most users join OSNs to keep in touch with people they already know, they often share a large amount of sensitive or private information about themselves. Given the rising popularity of OSNs and the explosive growth of information shared on them, OSN users are exposed to potential threats to secu-rity and privacy of their data. Security and privacy incidents in OSNs have increasingly gained attention from both media and research community [81], [94]. These incidents highlight the need for effective access control that can protect data from unauthorized access in OSNs.

Access control in OSNs presents several unique characteristics different from traditional access control. In mandatory and role-based access control, a system-wide access control policy is typically specified by the security administrator. In discretionary access control, the resource owner defines access control policy. However, in OSN systems, users expect to regulate access to their resources and activities related to themselves. Thus access in OSNs is subject to user-specified policies. Other than the resource owner, some related users (e.g., user tagged in a photo owned by another user, parent of a user) may also expect some control on how the resource or user can be exposed. To prevent users from accessing unwanted or inappropriate content, user-specified policies that regulate how a user accesses information need to be considered in authorization as well. Thus, the system needs to collect these individualized partial policies, from both the accessing users and the target users, along with the system-specified policies and fuse them for the collective control decision.

In OSN, access to resources is typically controlled based on the relationships between the accessing user and the controlling user of the target found on the social graph. This type of relationship-based access control [95] takes into account the existence of a particular relationship or a particular sequence of relationships between users and expresses access control policies in terms of such user-to-user (U2U) relationships.

Most existing OSN systems enforce a rudimentary and limited relationship-based access control mechanism, offering users the ability to choose from a pre-defined policy vocabulary, such as “public”, “private”, “friend” or “friend of friend”. Google+ and Facebook introduced customized relationships, namely “circle” and “friend list”, providing users richer options to differentiate distinctly privileged user groups. Mean-while, researchers have proposed more advanced relationship-based access control models, such as [82], [84]-[86], [88], [89], [91]-[93], [97]. Policies in [82], [84]-[86], [88], [89], [91], [92] can be composed of multiple types of relationships. [86], [88], [89] also adopt the depth and the trust value of relationship to control the spread of information. Although only having the “friend” relationship type, [92] provides additional topology-based policies, such as known quantity, common friends and stranger of more than k distance. While these works have their own advantages, one of the common drawbacks they share is that they do not allow different relationship types and multiple possible types on each hop.

Described herein is a novel user-to-user relationship-based access control (UURAC) model, allowing users the ability to express more sophisticated and fine-grained access control policies in terms of type pattern and depth of relationships among users in the network. Type pattern captures the pattern of relationship types along the relationship path from the accessing user to the target user. We adopt a regular expression-based approach for policy specification. Sequence of characters and wild card notations are employed to denote relationship paths, which express indirect relationships among users, such as f*, f+, cf?, etc.

The use of regular expression and multiple relationship types give the policy language the ability to specify more general policies than previous models did.

Characteristics of Access Control for OSNs

OSN is becoming the most prevalent manifestation of user-generated content platforms. Photos, videos, blogs, web links and other kinds of information are posted, shared and commented by OSN users. Various types of user interactions, including chatting, private messaging, poking, social games, etc., are also embedded into these systems. Below, we discuss some essential characteristics [100], [101] that need to be supported in access control solutions for OSN systems.

Policy Individualization. OSN users may want to express their own preferences on how their own or related contents should be exposed. A system-wide access control policy such as we find in mandatory and role-based access control, does not meet this need. Access control in OSNs further differs from discretionary access control in that users other than the resource owner are also allowed to configure the policies of the related resource. In addition, users who are related to the accessing user, e.g. parent to child, may want to control the accessing user's actions. Therefore, the OSN system needs to collectively utilize these individualized policies from users related to the accessing user or the target, along with the system-specified policies for control decisions.

User and Resource as a Target. Unlike traditional user access where the access is against target resource, activities such as poking and friend recommendations are performed against other users.

User Policies for Outgoing and Incoming Actions.

Notification of a particular friends' activities could be bothersome and a user may want to block it. This type of policy is captured as incoming action policy. Also, a user may want to control her own or other users' activities. For example, a user may restrict her own access from all violent content or a parent may not want her child to invite her co-worker as a friend. This type of policy is captured as an outgoing action policy. In OSN, it is necessary to support policies for both types of actions.

Necessity for Relationship-based Access Control.

Typically, the number of users in an OSN is very large and the amount of resources they own is usually even larger. Moreover, the relationships among users are changing frequently and dynamically. A user may not be able to know either the user name space of the entire network or all her possible direct or indirect contacts. Therefore, it is infeasible for her to specify access control policies for all of the possible accessing users. Even if she knows them all, it takes enormous amount of time for her to explicitly specify policies for all of them one by one as in discretionary access control. Role-based access control does not fit well in this situation either, because privileged user groups are different for each user. Thus different users' privileged user groups cannot be assigned to a unified set of roles. Overall using traditional access control approaches is cumbersome and inadequate for OSN systems.

Instead, access control in OSNs is mainly based on relationships among users and resources. For example, only Alice's direct friends can access her blogs, or only user who owns the photo or tagged users can modify the caption of the photo. Depth is another significant parameter, since people tend to share re-sources with closer users (e.g., “friend”, or “friend of friend”).

Prior Access Control Models for OSNs

The large and complex collections of user data in OSNs require usable and fine-grained access control solutions to protect them [95], [96]. Gates [95] discusses the access control requirements for OSN environments, where he argues that one of the key requirements is relationship-based access control.

A formal model for access control in Facebook-like systems was developed by Fong et al [92], which treats access control as a two-stage process, namely, reaching the search listing of the resource owner and accessing the resource, respectively. Reachability of the search listings is a necessary condition for access. Although lacking support for directed relationships, multiple relationship types and trust metric of relationships, this model allows expression of arbitrary topology-based properties, such as “k common friends” and “k clique”, which are beyond what Facebook and other commercial OSNs offer.

In [91], Fong proposed a formal model for social computing applications, in which authorization decisions are based on user-to-user relationships. This model employs a modal logic language for policy specification. Fong et al extended the policy language and formally characterized its expressive power [93]. In contrast to [92], this model allows multiple relation-ship types and directional relationships. Relationships and authorizations are articulated in access contexts and context hierarchy to support sharing of relation-ships among contexts. Bruns et al [82] later improved [91], [93] by using hybrid logic to enable better efficiency in policy evaluation and greater flexibility of atomic formulas.

Inspired by research in trust and reputation systems, some early solutions proposed by Kruk et al [97] and Carminati et al [87], [88] identified aggregated trust value, denoting the level of relationship, along with relationship type and depth on a path from the resource owner to the accessing user as parameters for authorization. While Kruk's work only considers one relationship type, Carminati's work allows multiple relationship types but only supports trust computation of a relationship path of a single type at a time. Carminati et al also proposed a semi-decentralized architecture, where access rules are specified in terms of relationship type, depth and trust metrics by indi-vidual users in a discretionary way [89]. The system features a centralized certificate authority to assert the validity of relationship paths, while access control enforcement is carried out on the decentralized user side.

In [84], [85], an access control model for OSNs utilizes semantic web technologies. Unlike other works, this model exhibits different relationships between users and resources. It defines three kinds of access policies with the Web Ontology Language (OWL) and the Semantic Web Rule Language (SWRL), namely authorization, administration and filtering policies. Similar to [84], [85], Masoumzadeh et al [98] proposed ontology-based social network access control. Their model captures delegation of authority and empowers both users and the system to express finer-grained access control policies.

Comparison of Access Control Models for OSNs

The first four columns of Table 13 summarize the salient characteristics of the models discussed above. The fifth column gives these characteristics for the new UURAC model.

TABLE 13
Comparison Of Access Control Models For OSNs

| | Fong [92] | Fong [91], [93] | Carminati [89] | Carminati [84], [85] | UURAC |
|---|---|---|---|---|---|
| Relationship Category | | | | | |
| Multiple Relationship Types | | ✓ | ✓ | ✓ | ✓ |
| Directional Relationship | | ✓ | ✓ | | ✓ |
| U2U Relationship | ✓ | ✓ | ✓ | ✓ | ✓ |
| U2R Relationship | | | | ✓ | |
| Model Characteristics | | | | | |
| Policy Individualization | ✓ | ✓ | ✓ | ✓ | ✓ |
| User & Resounce as a Target | | | | (partial) | ✓ |
| Outgoing/Incoming Action Policy | | | | (partial) | ✓ |
| Relationship Composition | | | | | |
| Relationship Depth | 0 to 2 | 0 to n | 1 to n | 1 to n | 0 to n |
| Relationship Composition | f, f of f | exact type | path of same | exact type | exact type sequence, |
| | | sequence | type | sequence | path pattern of |
| | | | | | different types |

All the models deal only with U2U relationships, except [84], [85] also recognize U2R (user-to-resource) relationships explicitly. U2R relationships can be captured implicitly via U2U with the last hop being U2R.

UURAC Model Foundation

In this section, we develop the foundation of UURAC including basic notations, access control model components and social graph model.

Basic Notations

We write Σ to denote the set of relationship type specifiers, where Σ={σ₁,σ₂, . . . , σₙ,σ₁⁻¹,σ₂⁻¹, . . . , σₙ⁻¹}. Each relationship type specifier σ is represented by a character recognizable by the regular expression parser. Given a relationship type σᵢεΣ, the inverse of the relationship is σᵢ⁻¹εΣ.

We differentiate the active and passive forms of an action, denoted action and action⁻¹, respectively. If Alice pokes Bob, the action is poke from Alice's viewpoint, whereas it is poke⁻¹ from Bob's viewpoint.

Access Control Model Components

The model comprises five categories of components as shown in FIG. 11.

Accessing User (uₐ) represents a human being who performs activities. An accessing user carries access control policies and U2U relationships with other users.

Each Action is an abstract function initiated by accessing user against target. Given an action, we say it is action for the accessing user, but action⁻¹ for the recipient user or resource.

Target is the recipient of an action. It can be either target user (uₜ) or target resource (rₜ). Target user has her own policies and U2U relationship information, both of which are used for authorization decisions. Target resource has U2R relationship (i.e., ownership) with controlling users (u_{c}). An accessing user must have the required U2U relationships with the control-ling user in order to access the target resource.

Access Request denotes an accessing user's request of a certain type of action against a target. It is modeled as a tuple <uₐ, action, target>, where uₐεU is the accessing user, target is the user or resource that uₐ tries to access, whereas actionεAct specifies from a finite set of supported functions in the system the type of access the user wants to have with target. If uₐ requests to interact with another user, target=uₜ, where uₜεU is the target user. If uₐ tries to access a resource owned by another user u_{c}, target is resource rₜεR where R is a finite set of resources in OSN.

Policy defines the rules according to which authorization is regulated. As shown in FIG. 2, policies can be categorized into user-specified and system-specified policies, with respect to who defines the policies. System-specified policies (SP) are system-wide general rules enforced by the OSN system; while user-specified policies are applied to specific users and resources. Both user- and system-specified policies include policies for resources and policies for users. Policies for resources are used to specify who can access the resources, while policies for users regulate how users can behave regarding an action. User-specified policies for a resource are called target resource policies (TRP), which are policies for incoming actions. User-specified policies for users can be further divided into accessing user policies (AUP) and target user policies (TUP), which correspond to user's outgoing and incoming access, respectively. Accessing user policies, also called outgoing action policies, are associated with the accessing user and regulate this user's outbound access. Target user policies, also called incoming action policies, control how other users can access the target user. Note that system-specified policies do not have separate policies for incoming and outgoing actions, since the accessor and target are explicitly identified.

As shown in FIG. 3, an OSN forms a directed labeled simple graph⁵ with nodes (or vertices) rep-resenting users and edges representing user-to-user relationships. We assume every user owns a finite set of resources and specifies access control policies for the resources and activities related to her. If an accessing user has the U2U relationship required in the policy, the accessing user will be granted per-mission to perform the requested action against the corresponding resource or user. ⁵ There could be combinations of multiple resource types in one policy, but for illustration, we only show one resource type per policy.

We model the social graph of an OSN as a triple G=<U, E, Σ>:
U is a finite set of registered users in the system, represented as nodes (or vertices) on the graph.

We use the terms user and node interchangeably from now on.
Σ={σ₁, σ₂, . . . , σₙ σ₁⁻¹, σ₂⁻¹, . . . , σₙ⁻¹} denotes a finite set of relationship types, where each type specifier a denotes a relationship type supported in the system.
E⊂U×U×Σ, denoting social graph edges, is a set of existing user relationships.

Since not all the U2U relationships in OSNs are mutual, we define the relationships E in the system as directed. For every σᵢεΣ, there is σᵢ⁻¹εΣ representing the inverse of relationship type σᵢ. We do not explicitly show the inverse relationships on the social graph, but assume the original relationship and its inverse twin always exist simultaneously. Given a user uεU, a user vεU and a relationship type σεΣ, a relationship (u, v, σ) expresses that there exists a relationship of type a starting from user u and terminating at v. It always has an equivalent form (v, u, σ⁻¹). G=<U, E, Σ> is required to be a simple graph.

UURAC Policy Specifications

Path Expression Based Policy

The user relationship path in access control policies is represented by regular expressions. The formulas are based on the set Σ of relationship type specifiers. Each specification in this language describes a pattern of required relationship types between the accessing user and the target/controlling user. We use three kinds of wildcard notations that represent different occurrences of relationship types: asterisk (*) for 0 or more, plus (+) for 1 or more and question mark (?) for 0 or 1.

Graph Rule Specification and Grammar

An access control policy consists of a requested action, optional target resource and a required graph rule.

In particular, graph rule is defined as (start, path rule), where start denotes the starting node of relationship path evaluation, whereas path rule denotes a collection of path specs. Each path spec consists of a pair (path, hopcount), where path is a sequence of characters, denoting the pattern of relationship path between two users that must be satisfied, while hopcount limits the maximum number of edges on the path.

Typically, a user can specify one piece of policy for each action regarding a user or a resource in the system, and the path rule in the policy is composed of one or more path specs. Policies defined by different users for the same action against same target are considered as separate policies. Multiple path specs can be connected by disjunction or conjunction. For instance, a path rule (f*, 3)ν(Σ*, 5) ν(fc, 2), where f is friend and c is co-worker, contains disjunction of three different pieces of path specs, of which one must be satisfied in order to grant access. Note that, there might be a case where only users who do not have particular types of relationships with the target are allowed to access. To allow such negative relationship-based access control, a boolean negation operator over path specs is allowed, which implies the non-existence of the specified pair of relationship type pattern path and hopcount limit hopcount following ν. For example, ν(fc+, 5) means the involved users should not have relationship of pattern fc+ within depth of 5 in order to get access.

Each graph rule usually specifies a starting node, the required types of relationships between the starting node and the evaluating node, and the hopcount limit of such relationship path. A grammar describing the syntax of this policy language is defined in Table 14.

TABLE 14
Grammar for graph rules

GraphRule ::= “(” < StartingNode > “,” < PathRule > “)”
PathRule ::= < PathSpecExp > | < PathSpecExp > < Connective >
< PathRule >
Connective ::= [symbol]
PathSpecExp ::= < PathSpec > | [symbol] < PathSpec >
PathSpec ::= “(” < Path > “,” < HopCount > “)”|“(” < EmptySet >
“,” < Hopcount > “)”
HopCount ::= < Number >
Path ::= < TypeExp > | < TypeExp > < Path >
EmptySet ::=
TypeExp ::= < TypeSpecifier > | < TypeSpecifier > < Wildcard >
StartingNode ::= uₐ|u₁|u_{c}
TypeSpecifier ::= σ1|σ2|..|σn|σ₁⁻¹|σ₂ ⁻¹|..|σₙ⁻¹|Σ = where Σ =
{σ1, σ2, .., σₙ,σ₁⁻¹,σ₂⁻¹, .., σₙ^{-‘}}
Wildcard ::= “*”|“?”|“ + ”
Number ::= [0 − 9]+

Here, GraphRule stands for the graph rule to be evaluated. StartingNode can be either the accessing user uₐ, the target user uₜ or the controlling user u_{c}, denoting the given node from which the required relationship path begins. Path represents a sequence of type specifiers from the starting node to the evaluating node. Path will typically be non-empty. If path is empty and hopcount=0 we assign the special meaning of “only me”, which is the only allowed case for empty path. Wildcard captures the three wildcard characters, which facilitate specifying path expressions more efficiently and effectively. Given a graph rule from the access control policy, this grammar specifies how to parse the expression and to extract the containing path pattern and hopcount from the expression.

User- and System-Specified Policy Specifications

User-specified policies specify how individual users want their resources or services related to them to be released to other users in the system. These policies are specific to actions against a particular resource or user. System-specified policies allow the system to specify access control on users and resources. Different from user policies, the statements in system policies are not specific to particular accessing user or target, but rather focus on the entire set of users or resource types (see Table 15).

TABLE 15
Access Control Policy Representations

| | |
|---|---|
| Accessing User Policy | <action, (start, path rule)> |
| Target User Policy | <action⁻¹ , (start, path rule)> |
| Target Resource Policy | <action⁻¹ , (start, path rule)> |
| System Policy for User | <action, (start, path rule)> |
| System Policy for Resource | <action, (r.typename, r.typevalue), |
| | (start, path rule)> |

In accessing user policy, action denotes the requested action, whereas (start, path rule) expresses the graph rule. Similarly, action⁻¹ in target user policy and target resource policy is the passive form of the corresponding action applied to target user. Target resource policy contains an extra parameter u_{c}, representing the controlling user of the resource.

This section considers only U2U relationships in policy specification. In general, there could be one or more controlling users who have certain types of U2R relationships with the resource and specify policies for the corresponding target resource. To access the resource, the accessing user must have the required relationships with the controlling users. The policies associated with the target resources are defined on the basis of per action per controlling user. For instance, when querying read access request on rₜ, all of rₜ's target resource policies need to be considered in evaluation. Each policy specifies a controlling user, with whom the accessing user must have the required relationship.

System-specified policies do not differentiate the active and passive forms of an action. System policy for users has the same format as accessing user policy. However, when specifying system policy for resources, one system-wide policy for one type of access to all resources may not be fine-grained and flexible enough. Sometimes we need to refine the scope of the resources that applied to the policies in terms of resource types (r.typename, r.typevalue).⁵ Examples of types are (filetype, photo), (filetype, statusupdate), (location, Texas), etc. Thus, <read, (filetype, photo), (u_{c}, f*, 4)> is a system policy applied to all read access to photos in the system. When dealing with system policy for resources, we can determine the controlling user of the resource through some U2R relationships, such as ownership (as shown in FIG. 11).

Access Evaluation Procedure

Algorithm 8 specifies how the access evaluation procedure works. When an accessing user uₐ requests an action against a target user uₜ, the system will look up uₐ's action policy, uₜ's action⁻¹ policy and the system-specified policy corresponding to action. When uₐ requests an action against a resource rₜ, the system will retrieve all the corresponding policies of rₜ. Although each user can only specify one policy per action per target, there might be multiple users specifying policies for the same pair of action and target. Multiple policies might be collected in each of the three policy sets: AUP, TUP/TRP and SP.

Algorithm 8 AccessEvaluation(uₐ, action, target)

| | |
|---|---|
| 1: | (Policy Collecting Phase) |
| 2: | if target = uₜ then |
| 3: | AUP ← uₐ's policy for action, TUP ← uₜ's policy |
| | for action⁻¹, SP ← system's policy for action, |
| 4: | else |
| 5: | AUP ← uₐ's policy for action, TRP ← rₜ's |
| | policy for action⁻¹, SP ← system's policy for |
| | action, (r.typename,r.typevalue) |
| 6: | (Policy Evaluation Phase) |
| 7: | for all policy in AUP, TUP/TRP and SP do |
| 8: | Extract graph rules (start, path rule) from policy |
| 9: | for all graph rule extracted do |
| 10: | Determine the starting node, specified by start, |
| | where the path evaluation starts |
| 11: | Determine the evaluation node which is the other |
| | user involved in access |
| 12: | Extract path rules path rule from graph rule |
| 13: | Extract each path spec path, hopcount from path |
| | rule |
| 14: | Path-check each path spec using Algorithm 2 |
| 15: | Evaluate the combined result based on conjuctive |
| | or disjunctive connectives between path specs and |
| | negation on individual path specs |
| 16: | Compose the final result from the result of each policy |

Example Given the following policies and social graph in FIG. 3:
Alice's policy P_{Alice}: <poke, (uₐ, (f*, 3))>

<poke⁻¹, (uₜ, (f, 1))> <read, (uₐ, (Σ*, 5))>
Harry's policy P_{Harry}: <poke, (uₐ, (cf*, 5)ν(f*, 5))> <poke⁻¹, (uₜ, (f*, 2))>
Policy of file2 P_{file2}: <read⁻¹, Harry, (u_{c}, [symbol] (p+, 2)>
System's policy P_{Sys}: <poke, (uₐ, (Σ*, 5))> <read, (filetype, photo), (uₐ, (Σ*, 5))>

When Alice requests to poke Harry, the system will look up the following policies: <poke, (uₐ, (f*, 3))> from P_{Alice}, <poke⁻¹, (uₜ, (f*, 2))> from P_{Harry}, and <poke, (uₐ, (Σ*, 5))> from P_{Sys}. When Alice requests to read photo file2 owned by Harry, the policies <read, (uₐ, (Σ*, 5))> from P_{Alice}, <read⁻¹, Harry, (u_{c}, ν(p+, 2)> from P_{file2},and <read, photo, (uₐ, (Σ*, 5))> from P_{Sys} will be used for authorization.

For all the policies in the policy sets, the algorithm first extracts the graph rule (start, path rule) from each policy. Once the graph rule is extracted, the system can determine where the path checking evaluation starts (using start), and then extracts every path spec path, hopcount (from path rule). Then, it runs a path-checking algorithm (see the next section) for each path spec. The path-checking algorithm returns a boolean result for each path spec. To get the evaluation result of a particular policy, we combine the results of all path specs in the policy using conjunction, disjunction and negation. At last, the final evaluation result for the access request is made by composing all the evaluation results of the policies in the chosen policy sets.

The existence of multi-user policies can result in decision conflicts. To resolve this, the system can adopt a disjunctive, conjunctive, or prioritized approach. When a disjunctive approach is enabled, the satisfaction of any corresponding policy is sufficient for granting the requested access. In a conjunctive approach, the requirements of every involved policy should be satisfied in order that the access request would be granted. In a prioritized approach, if, for example, parents' policies get priority over children's policies, the parents' policies overrule children's policies. While policy conflicts are inevitable in the proposed model, we do not discuss this issue in further detail here. For simplicity we assume system level policies are avail-able to resolve conflicts in user-specified authorization policies and do not consider user-specified conflict resolution policies.

One observation from user-specified policies is that action policy starts from uₐ whereas action⁻¹ policy starts from uₜ. This is because action is done by uₐ while action⁻¹ is from uₜ's perspective. When hopcount=0 and path equals to empty, it has special meaning of “only me”. For instance, <poke, (uₐ, (Ø, 0))> says that uₐ can only poke herself, and <poke⁻¹, (uₜ, (Ø, 0))> specifies uₜ can only be poked by herself. The above two policies give a complementary expressive power that the regular policies do not cover, since regular policies are simply based on existing paths and limited hopcount.

As mentioned earlier, the social graph is modeled as a simple graph. Further we only allow simple path with no repeating nodes. Avoiding repeating nodes on the relationship path prevents unnecessary iterations among nodes that have been visited already and unnecessary hops on these repeating segments. On the other hand, this “no-repeating” could be quite useful when a user wants to expose her resource to farther users without granting access to nearer users. For example, in a professional OSN system such as LinkedIn, a user may want to promote her resume to users outside her current company, but does not want her co-workers to know about it. Note that the two distinct paths denoted by fffc and fc may co-exist between a pair of users. Simply specifying fffc in the policy does not avoid someone who also has fc relationship with the owner from accessing the resume. In contrast, fffc Λ [symbol] (fc) allows the co-workers of the user's distant friends to see the resume, while the co-workers of the user's direct friends fc are not authorized.

In general, conventional OSNs are susceptible to the multiple-persona problem, where users can always create a second persona to get default permissions. The system follows in an embodiment the default-denial design, which means if there is no explicit positive authorization policy specified, there is no access permitted at all. Based on the default-denial assumption, negative authorizations in our policy specifications are mainly used to further refine permissions allowed by the positive authorizations specified (e.g., f* cΛ [symbol] (fc)). A single negative authorization without any positive authorization has the same effect as there is no policy specified at all, but it is still useful to restrict future addition of positive policies. Nonetheless it is possible for the co-worker of a direct friend to have a second persona that meets the criteria for co-worker of a dis-tant friend and thereby acquires access to the resume. Without strong identities we can only provide persona level control in such policies.

Algorithms

Disclosed herein re two algorithms for determining if there exists a qualified path between two involved users in an access request, based on depth-first search (DFS) and breadth-first search (BFS) strategies. Then, we provide proofs of correctness and complexity analysis for both algorithms.

As mentioned, in order to grant access, relation-ships between the accessor and the target/controlling user must satisfy the graph rules specified in access control policies regarding the given request. We formulate the problem as follows: given a social graph G, an access request <uₐ, action, target> and an access policy, the system decision module explores the graph and verifies the existence of a path between uₐ and target (or u_{c} of target) matching the graph rule <start, path rule>.

As shown in Algorithm 9 and 11, the path checking algorithm takes as input the social graph G, the path pattern path and the hopcount limit hopcount specified by path spec in the policy, the starting node s specified by start and the evaluating node t which is the other user involved, and returns a boolean value as output. Note that path is non-empty, so this algorithm only copes with cases where hopcount 6=0. The starting node s and the evaluating node t can be either the accessing user or the target/controlling user, depending on the given policy. The algorithm starts by constructing a DFA (deterministic finite automata) from the regular expression path. The REtoDFA( )function receives path as input, and converts it to an NFA (non-deterministic finite automata) then to a DFA, by using the well-known Thompson's Algorithm [103] and Subset Construction Algorithm (also known as Buchi's” Algorithm) [102], respectively.

Depth-First Search

Using DFS to traverse the graph requires only one running DFA and, correspondingly, one pair of variables keeping the current status and the history of exploration in a DFS traversal. Whereas, a BFS traversal has to maintain multiple DFAs and multiple variables simultaneously and switch between these DFAs back and forth constantly, which makes the costs of memory space and I/O operations proportional to the number of nodes visited during exploration. Note that DFS could take a long traversal to find a target node, even if the node is close to the starting node. If the hopcount is unlimited, a DFS traversal may pursue a lengthy useless exploration. However, as activities in OSNs typically occur among people with close relationships, DFS with limited hopcount can minimize such unnecessary traversals.

Algorithm 9 DFSPathChecker(G, path, hopcount, s, t)

| | |
|---|---|
| 1: | DFA ← REtoDFA(path);currentPath ← N I L; d ← 0 |
| 2: | stateHistory ← DFA starts at the initial state |
| 3: | if hopcount ≠ 0 then |
| 4: | return DFST(s) |

In Algorithm 9, the variable currentPath, initialized as NIL, holds the sequence of the traversed edges between the starting node and the current node. Variable stateHistory, initialized as the initial DFA state, keeps the history of DFA states during algorithm execution. The main procedure starts by setting the current traversal depth d to 0 and launches the DFS traversal function DFST( ) in Algorithm 10 from the starting node s.

In Algorithm 10, given a node u, if d+1 does not exceed the hopcount limit, it indicates that traversing one step further from u is allowed. Otherwise, the algorithm returns false (line 2) and goes back to the previous node (line 26). If further traversal is allowed, then the algorithm picks up an edge (u, v, σ) from the list of the incident edges leaving u. If (u, v, σ) is unvisited, we get the node v on the opposite side of the edge (u, v, σ). Now we have six different cases. If v is on currentPath, we will never visit v again, because doing so creates a cycle on the path. Rather, the algorithm breaks out of the current for loop, and finds the next unchecked edges of u.

Algorithm 10 DFST(u)

| | |
|---|---|
| 1: | if d + 1 > hopcount then |
| 2: | return FALSE |
| 3: | else |
| 4: | for all (v, σ) where (u, v, σ) in G do |
| 5: | switch |
| 6: | case 1 v ∈ currentPath |
| 7: | break |
| 8: | case 2 v ∉ currentPath and v = t and DFA with |
| | transition σ is at accepting state |
| 9: | d ← d + 1; currentPath ← currentPath.(u, v, σ) |
| 10: | currentState ← DFA takes transition σ |
| 11: | stateHistory ← stateHistory.(currentState) |
| 12: | return TRUE |
| 13: | case 3 v ∉ currentPath and v = t and transition σ |
| | is valid for DFA but DFA with transition σ is not |
| | at accepting state |
| 14: | break |
| 15: | case 4 v ∉ currentPath and v = t and transition σ |
| | is invalid for DFA |
| 16: | break |
| 17: | case 5 v ∉ currentPath and v ≠ t and transition σ |
| | is invalid for DFA |
| 18: | break |
| 19: | case 6 v ∉ currentPath and v ≠ t and transition σ |
| | is valid for DFA |
| 20: | d ← d + 1; currentPath ← currentPath.(u, v, σ) |
| 21: | currentState ← DFA takes transition σ |
| 22: | stateHistory ← stateHistory.(currentState) |
| 23: | if (DFST(v)) then |
| 24: | return TRUE |
| 25: | else |
| 26: | d ← d − 1; currentPath ← currentPath\(u, v, σ) |
| 27: | previousState ← last element in stateHistory |
| 28: | DFA backs off the last taken transition σ to |
| | previousState |
| 29: | stateHistory ← stateHistory\(previousState) |
| 30: | return FALSE |

When v is not on currentPath and v is the target node t, we check if the transition σ belongs to the set of valid transitions for DFA. If the transition is valid and if DFA taking the transition σ reaches an accepting state, we find a path between s and t matching the pattern Path (case 2). We increment d by one, concatenate edge (u, v, σ) to currentPath, and save the current DFA state to history. If DFA with transition σ is not at an accepting state, then the path from s to v does not match the pattern (case 3). If the transition is invalid for DFA, we try the next edge (case 4). When v is not on currentPath and is not the target node, there are two cases depending on whether the transition type σ is a valid transition for DFA. If it is not, we break out of the for loop and continue to check the next unchecked edge of u (case 5). Otherwise, the algorithm increments d by one, concatenates e to currentPath, moves DFA to the next state via transition type σ, updates the DFA state history, and repeatedly executes DFST( ) from node v (case 6). If the recursive function call discovers a matching path, the previous call also returns true. Otherwise, the algorithm has to step back to the previous node of u, reset all variables to the previous values, and check the next edge of node u. However, if d=0, all the outgoing edges of the starting node are checked, thus the whole execution completes without a matching path.

Breadth-First Search

Starting from an initial node, a BFS traversal aims to expand and examine all nodes of a graph from inside out until it finds the goal. A FIFO (first in, first out) queue is created with the starting node as the first element. All the nodes of a level need to be added to the queue, and will be dequeued before the nodes of their child level. Similar to the DFS traversal, we need to create a running DFA and set up the corresponding variables for the search. However, to find a matching path, a BFS traversal has to maintain the DFA state and other variables for every possible path it examines, resulting in a multiple number of DFAs and variables simultaneously. Although BFS may naturally consume more computational resources, it has advantage over its DFS counterpart as it never wastes time on a lengthy unsuccessful exploration.

As shown in Algorithm 11, we create a DFA from the regular expression pattern, enqueue the starting node s, and initialize the variable currentPath, stateHistory and d of s to NIL, the initial DFA state and 0, respectively. The algorithm continues when the queue is not empty, and dequeues the first node of the queue for further exploration. Given a node q, if d+1 does not exceed the hopcount limit, the algorithm moves on to examine the incident outgoing edges of q. All edges can be classified into the same six cases as in the abovementioned DFS algorithm. For an edge (u, v, σ), only when v is not on currentPath and v is the target node t and DFA taking a valid transition σ reaches an accepting state, we find a path between q and t matching the pattern Path (case 2). We then update the corresponding variables for node v and exit the algorithm with true. If v is not on currentPath and is not the target node, we check the validity of the transition σ. If the transition is valid, we will take the transition, update the variables of v, and enqueue node v into the queue for later examination (case 6). In all other cases, a successful exploration will not possibly occur, thus the edges are dropped. After checking all edges within the hopcount limit, the algorithm terminates with false if no matching path is found.

Proof of Correctness

Theorem 5.1:

Algorithm 10 and 11 will halt with true or false.

Proof:

Base case (Hopcount=1): d is initially set to 0. Each outgoing edge from the starting node s will be examined once and only once. If taking an edge reaches the target node t and its type matches the language Path denotes (case 2), both algorithms return true. In Algorithm 10, if the edge type matches the prefix of an expression in L(Path) (case 6), d increments to 1 followed by a recursive call to DFST( ). The second level call will return false, since incremented d has exceeded Hopcount. In all other cases, the examined edge is discarded and d remains the same. In Algorithm 11, if the edge type matches the prefix of an expression in L(Path) (case 6), the new node v is added to the queue with an incremented d. When v is dequeued later, the new edge will be dropped as the updated d has exceeded Hopcount. In all other cases, the examined edge is discarded and d remains the same. Eventually, if a matching edge is not found, both algorithms will go through every outgoing edge from s and exit with false thereafter.

Induction step: Assume when Hopcount=k (k≧1), Theorem 5.1 is true.

In Algorithm 3, when Hopcount is set to k+1, all the (k+1)th level recursive calls will examine every outgoing edge from the (k+1)th node on currentPath. If visiting an edge reaches t and the updated currentPath matches L(Path), the (k+1)th level call returns true and exits to the previous level, making all of the previous level calls all the way back to the first level exit with true as well. If an edge falls into case 6, d is incremented to k+2 and a (k+2)th level recursive call invokes, which will halt with false and return to the (k+1)th level as d has exceeded Hopcount. After all edges are examined without returning true, the algorithm will exit with false to the previous level. In the kth level, when Hopcount=k+1, edges without taking a recursive call are treated the same as they are when Hopcount=k. Since when Hopcount=k the theorem holds, the algorithm will terminate with true or false when Hopcount=k+1 as well.

In Algorithm 11, when Hopcount increases to k+1, all of the edges leaving kth level nodes are examined in the same way as before. If there exists a qualifying path between s

Algorith11 BFS PatchChecker(G, path, hopcount, s, t)

| | |
|---|---|
| 1: | DFA ← REtoDFA(path) |
| 2: | if hopcount ≠ 0 then |
| 3: | create queue Q |
| 4: | create node s; s.DFA ← DFA; s.currentPath ← |
| | N I L; s.d ← 0; s.stateHistory ← DFA starts at the |
| | initial state |
| 5: | enqueue s onto Q |
| 6: | while Q is not empty do |
| 7: | dequeue a node from Q into q |
| 8: | if q.d + 1 > hopcount then |
| 9: | break |
| 10: | else |
| 11: | for all(v, σ) where (q, v, σ) in G do |
| 12: | switch |
| 13: | case 1 v ∈ currentPath |
| 14: | break |
| 15: | case 2 v ∉ currentPath and v = t and DFA |
| | with transition σ is at accepting state |
| 16: | create node v (clone from q) |
| 17: | v.previousState ← v.currentState |
| 18: | v.currentState ← DFA takes transition σ |
| 19: | v.d + + |
| 20: | v.currentPath adds (q, v, σ) |
| 21: | v.stateHistory adds currentState |
| 22: | return TRUE |
| 23: | case 3 v ∉ currentPath and v = t and |
| | transition σ is valid for DFA but DFA with |
| | transition σ is not at accepting state |
| 24: | break |
| 25: | case 4 v ∉ currentPath and v = t and |
| | transition σ is invalid for DFA |
| 26: | break |
| 27: | case 5 v ∉ currentPath and v ≠ t and |
| | transition σ is invalid for DFA |
| 28: | break |
| 29: | case 6 v ∉ currentPath and v ≠ t and |
| | transition σ is valid for DFA |
| 30: | create node v (clone from q) |
| 31: | enqueue v onto Q |
| 32: | v.previousState ← v.currentState |
| 33: | v.currentState ← DFA takes transition σ |
| 34: | v.d + + |
| 35: | v.currentPath adds (q, v, σ) |
| 36: | v.stateHistory adds currentState |
| 37: | return FALSE |

and (k+1)th level nodes, the algorithm returns true; otherwise, it enqueues (k+1)th level nodes whose currentPath matches the prefix of pattern, and continues to examine edges leaving the next dequeued node, as right now the incremented d does not exceed Hopcount any more. If visiting one of the edges from (k+1)th nodes reaches t and the updated currentPath matches L(Path), the algorithm returns true. If currentPath matches only the prefix of L(Path), the corresponding (k+2)th node will be added to the queue. However, when the new node is dequeued later, the algorithm will halt with false, since d exceeds Hopcount. The algorithm eventually exits false as all other edges leaving (k+1)th level nodes are dropped during path checking. Therefore, the algorithm will terminate with true or false when Hopcount=k+1 as well.

Lemma 5.2:

At the start and end of each call in Algorithm 10 and during the execution of Algorithm 11, the DFA corresponding to Path is at currentState reachable from the starting state π₀ by transitions corresponding to the sequence of symbols in currentPath.

Proof:

The proof is straightforward. New edge is added to currentPath only when it reaches the target node (case 2) or it may possibly lead to the target node by examining the child of the current node (case 6). In both cases the DFA starting from π₀ will move to currentState by taking the transition regarding the edge. Removing the last edge on currentPath after all edges leaving the current node are checked always accompanies one step back-off of the DFA to its previous state in Algorithm 10 (lines 26-29), which can eventually take the DFA all the way back to the starting state π₀.

Theorem 5.3:

If Algorithm 10 or 11 returns true, currentPath gives a simple path of length less than or equal to Hopcount and the string described by currentPath belongs to the language described by L(Path). If Algorithm 10 or 11 returns false, there is no simple path p of length less than or equal to Hopcount such that the string representing p belongs to L(Path).

Proof:

Base case (Hopcount=1): At first, d=0, currentPath=NIL, and the DFA is at the starting state π₀. When d=0, case 1 requires that the edge being checked is a self loop which is not allowed in a simple graph. Both algorithms only return true in case 2, where edge (s, t, σ) to be added to currentPath finds the target node t in one hop. The transition σ moves the DFA to an accepting state. Case 6 cannot return true, because incrementing d by one will exceed Hopcount when the new node is being examined. When algorithms exit with true, due to Lemma 5.2, currentPath, which is (s, t, σ), can move the DFA from π₀ to an accepting state π₁, implying that σεL(Path). If the algorithms return false, they have searched all the edges leaving node s.

However, these examined edges either do not match the pattern specified by L(Path) (case 3, 4 and 5), or may possibly match L(Path) but require more than one hop (case 6). Hence, Theorem 5.3 is true when Hopcount=1.

Induction step: Assume when Hopcount=k (k≧1),Theorem 5.3 is true. For the same G, Path, s and t, executions of DFST( ) when Hopcount=k and k+1 only differ after invoking the recursive DFST( ) call in case 6 of Algorithm 10 or new nodes are added to the queue in case 6 of Algorithm 11. If an edge being checked can make the algorithm return true when Hopcount=k, currentPath is a string of length≦k which is in L(Path). When Hopcount is k+1, the same currentPath gives the same string and is of length<k+1, thus making the function exit with true as well. The only difference between Hopcount=k and Hopcount=k+1 is that adding edges that lie in case 6 to currentPath and incrementing d by one may not exceed the larger Hopcount during the examination of the new node. If taking one of these edges leads to the target node and its corresponding transition moves the DFA to an accepting state, the algorithm will return true. The new currentPath gives a simple path of length k+1 that connects node s and t. The algorithm only returns true in these two scenarios. In both scenarios, based on Lemma 5.2, the DFA can reach an accepting state by taking the transitions corresponding to currentPath, so the string corresponding to currentPath is in L(Path). If the algorithm returns false when Hopcount=k, there is no simple path p of length≦k, where the string of symbols in p is in L(Path). When Hopcount is k+1, given the same G, such a path still does not exist. By taking a recursive DFST( ) call in case 6 of Algorithm 10 or adding a new node to the queue in case 6 of Algorithm 11, both algorithms will go through all 6 cases again to check all the edges leaving the new node. If they return false, it means there is no simple path of length k+1 with its string of symbols in L(Path). Combining the results from all k+1 level recursive calls, there exists no simple path of length≦k+1 with its string of symbols in L(Path). Hence, Theorem 5.3 is true when Hopcount=k+1.

Complexity Analysis

In this algorithm, every possible path from s to t will be visited at most once until it fails to reach t, while every outgoing edge of a visited node may be checked multiple times during the search. In the extreme case, where every relationship type is acceptable and the graph is a complete directed graph, the overall complexity would be O(|V|^{Hopcount}). However, users in OSNs usually connect with a small group of users directly, thus the social graph is actually very sparse. We define the maximum and minimum out-degree of node on the graph as dmax and dmin, respectively. Then, the time complexity can be bounded between O(dmin^{Hopcount}) and O(dmax^{Hopcount}). Given the constraints on the relationship types and hopcount limit in the policies, the size of graph to be explored can be dramatically reduced. The BFS algorithm and the recursive DFST( ) call terminate as soon as either a matching path is found or the hopcount limit is reached.

Implementation and Evaluation

Disclosed herein are some of the results obtained from performance studies on the two path-checking algorithms. The algorithms were implemented in Java, and designed two sets of experiments to test the runtime execution of an access request evaluation using both algorithms. We deployed an access control decider with BFS and DFS path checkers on a virtual machine instance of an Ubuntu 12.04 image with 4 GB memory and a 2.53 GHz quad-core CPU. The social graphs to be tested are stored in MySQL databases on the testing machine along with the sample access control policies. We designed the sample policies and sample access requests that would require the access control decider to gather necessary information and crawl on the graph for the access decisions. We then measured the time the algorithms take to complete a path checking over the graph and return a result to the decider.

Datasets

When designing the experiments, we take into ac-count two parameters of the graphs: hopcount (depth) and degree (width). Although the total number of nodes in the system may influence the performance and scalability of many graph systems, in our system the algorithms are not to explore the whole graph but the paths with limited hops stemming from one node. Therefore, the total number of nodes is not significant with respect to the performance. In fact, it is the hopcount limit and the number of edges to be explored at each hop that contribute most to the size of the problem, and hence the performance of our system.

A significant issue in this evaluation consists in the selection of representative datasets. There are some public available datasets collected from real-world OSN systems with large amount of real data. However, most of them only consider single relationship type or do not support relationship type at all. In a related analysis [83], the original datasets were modified to add type information, where relationship types are uniformly distributed. However, manually adding type information to the real datasets may not reflect the actual user behaviors, and thus ruins the integrity of the datasets and diminishes the value of having real data. Moreover, different real datasets possess various properties, making them incomparable with each other. Hence, synthetic data becomes an alternative, where we can configure different social graphs under control, and analyze some specific properties of these graphs.

In the first set of experiments, we examine the performance of the BFS and DFS algorithms with respect to policies with different hopcount limit. In particular, we set the parameters to 1000 users and single relationship type for this set of experiments. Each user has the same number of neighbors, who are randomly selected among the rest 999 users. Two different kinds of path patterns, including enumeration and *-pattern, are used in the policies to investigate the impact of hopcount limit on the performance of the algorithms.

In the second set of experiments, we aim to study the performance of the algorithms against various number of edges that need to be traversed (i.e., the average degree of nodes in the graph) to show the scalability of our approach against dense graph. We keep the same 1000 users as in the previous experiments, but enable two types of relationships, namely “f(riend)” and “c(oworker)”, and randomly assign each relationship between users with one of these types. The number of neighbors for each user is set in the quantities of 100, 200, 500 and 1000. Consider the fact that there are only two types of relationship and the social graph in reality is usually a sparse graph, 1000 neighbors for each of 1000 users makes a relatively “dense” social graph for evaluation. We then run different policies on these four graphs to compare their differences.

Given an access control policy, we randomly pick 1000 different pairs of requester and target nodes from the graph, and run each algorithm 5 times on these 1000 pairs of nodes. Each measurement is the average results of these 5000 runs. To make fair comparison between true and false cases, we design different policies to get 5000 true cases and 5000 false cases. To evenly compare between true cases of different settings, we scale the number of selected users so that we can get results from the same amount of true cases.

Results

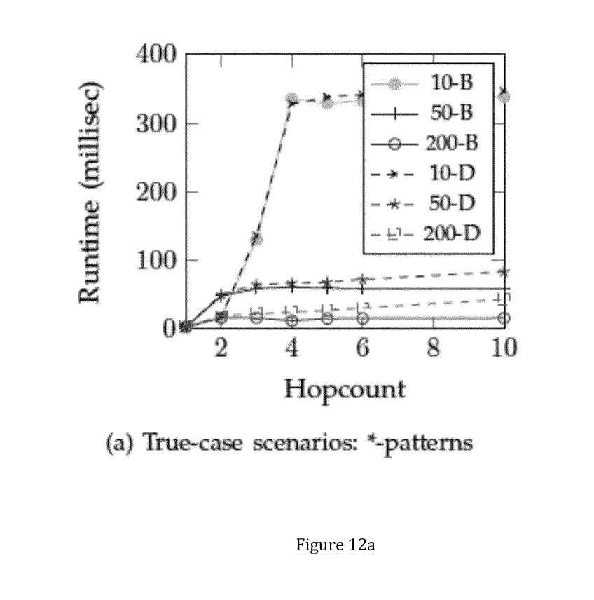

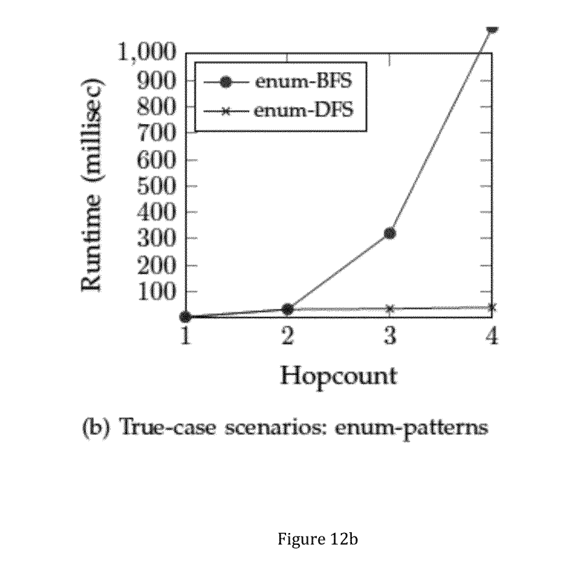

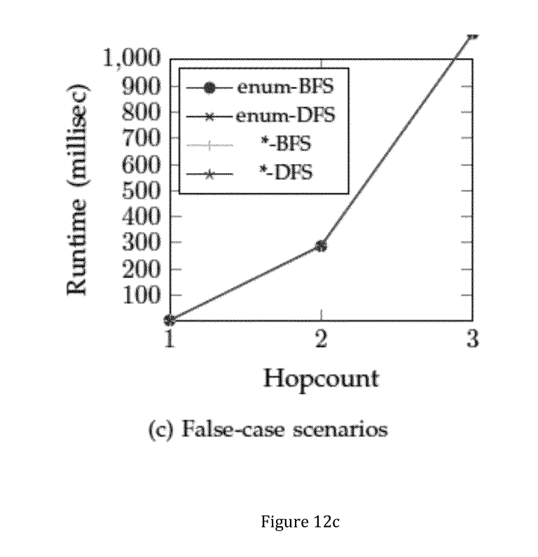

FIG. 12a-12c illustrates the results of the first set of experiments. We compare the BFS and DFS algorithms using policies with different hopcount limits in both the true-case and false-case scenarios. For true cases of *-pattern paths, FIG. 12 (a) shows how the average running time changes with respect to increase in hopcount limit. To make a more comprehensive comparison, in this particular test, we apply the following values 10, 50 and 200 (which is close to 190, the average number of friends claimed by Facebook [105]) to the number of neighbors for each user. *-pattern paths are known to be more flexible than enumeration paths in path-checking. In fact, the results for *-pattern record the time elapse of finding one of the shortest qualified path. As we expected, when hopcount increments, the average execution time required for both algorithms increases as well, but the trends tend to flatten after the hopcount reaches 4. It indicates that a qualified path can be always found between two users within 4 hops in this setting. A probability calculation also verifies this finding. In the case of 10 neighbors per user, the aggregate probability of finding a qualified path is 1%, 10.5%, 67.3% for the first three hops, respectively, and eventually 100% at the fourth hop. The probability reaches 100% within 3 hops in the other two denser graphs. We also find that the BFS algorithm works slightly better than the DFS algorithm for large hopcount limit in sparse graphs, as DFS takes many lengthy probes before finding a qualified path while BFS does not suffer from much overhead in sparse graphs.

According to the classic idea of “six degrees of separation” and the findings of “small world experiment” [99], [104], any pair of people are distanced by no more than six intermediate connections on average. A recent study by Backstrom et al [80] further indicates that the average distance on the current social graph of Facebook is smaller than the commonly cited six degrees, and has shrunk to 4.74 as Facebook grows. Based on these findings, for true cases of enumeration paths, we restrain the hopcount limit up to 4, as our dataset is relatively much smaller than Facebook. As shown in FIG. 12b, when hopcount limit increments, the time cost by the BFS algorithm increases significantly, due to the fact that it will not take the next hop without finishing search on all edges at the current level; whereas a greater hopcount does not worsen the performance of the DFS algorithm much.

FIG. 12c demonstrates the comparison between the two algorithms in false-case scenarios. The false-case scenarios actually represent the worst case scenario for path-checking, where both algorithms need to exhaustively search all possible paths within the hopcount limit from the starting node. Therefore, the two algorithms perform similarly in both enumeration and *-pattern settings. As hopcount increases, the time costs of the algorithms increase approximately in the magnitude of node degree, which match our expectation given in the complexity analysis.

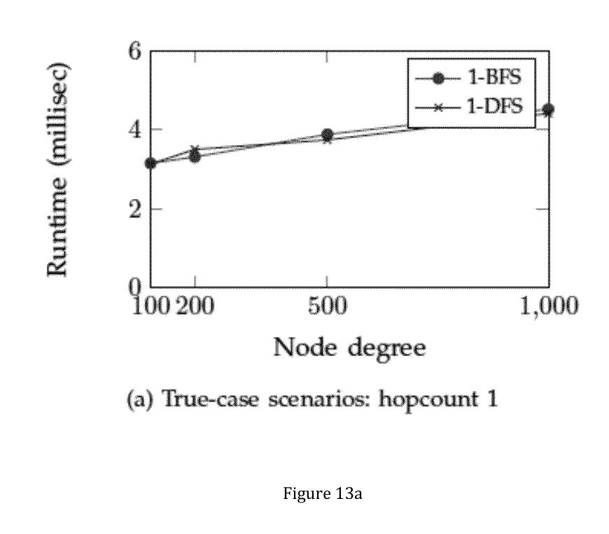

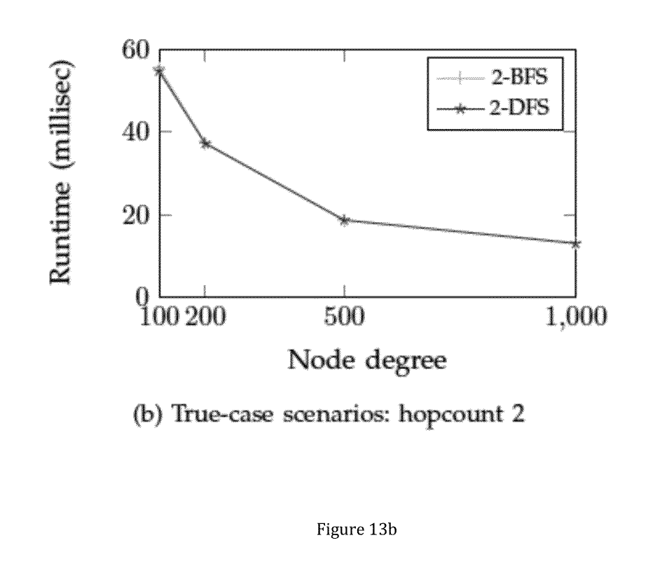

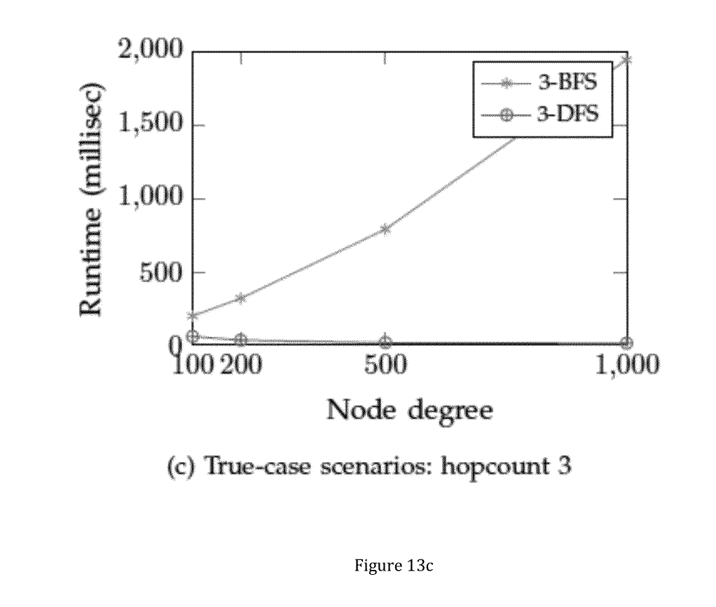

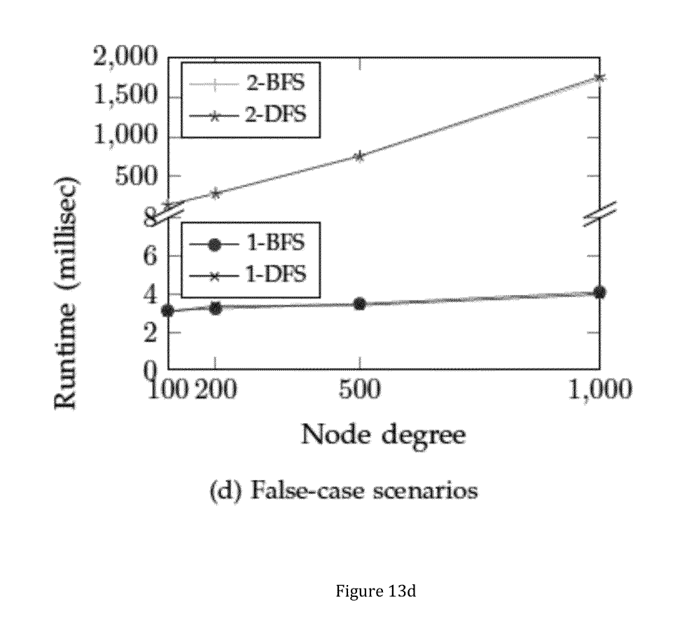

FIG. 13a-13d represents a comparison of the performance of the two algorithms on graphs with different node degrees. In true-case scenarios, as shown in FIGS. 13 (a, b and c), we notice that incrementing hop-count limit increases the time for both algorithms to find a qualified path, since the search space expands accordingly. We also observe that when dealing with 2-hop policies, the time cost declines gradually with an increase in node degree. This is mainly because it is more possible to find a qualified path between two nodes at an earlier time in denser graphs than sparser graphs, although the worst possible time for denser graphs is way larger. For 3-hop policies, however, BFS algorithm has to explore all possible paths at the first 2 hops until attempting the 3rd hop, thus spending much more time to find a match when node degree increases. DFS algorithm, on the other hand, does not suffer from the greater search space brought by the increase of node degree. In general, both algorithms perform similarly on 1 and 2-hop policies, but DFS algorithm outperforms its BFS counterpart when dealing with 3-hop policies and larger. Similar to the first set of experiments, we obtain similar results for both algorithms in false-case scenarios (13d), as both of them experienced an exhaustive search. Consistent with our previous analysis on complexity, the results we observed from the four different social graphs reveal an increase of time proportional to the node degrees as expected.

### REFERENCES

1. G. Bruns, P. W. Fong, I. Siahaan, and M. Huth. Relationship-based access control: its expression and enforcement through hybrid logic. In ACM CODASPY, 2012.
2. B. Carminati, E. Ferrari, R. Heatherly, M. Kantarcioglu, and B. Thuraisingham. A semantic web based framework for social network access control. In ACM SAC-MAT, 2009
3. B. Carminati, E. Ferrari, R. Heatherly, M. Kantarcioglu, and B. Thuraisingham. Semantic web-based social network access control. Computers and Security, 30(2C3), 2011. Special Issue on Access Control Methods and Technologies.
4. B. Carminati, E. Ferrari, and A. Perego. Rule-based access control for social networks. In OTM 2006 Workshops, volume 4278 of LNCS. Springer, 2006.
5. B. Carminati, E. Ferrari, and A. Perego. A decentralized security framework for web-based social networks. Int. Journal of Info. Security and Privacy, 2(4), 2008.
6. B. Carminati, E. Ferrari, and A. Perego. Enforcing access control in web-based social networks. ACM Trans. Inf. Syst. Secur., 13(1), 2009.
7. P. Fong, M. Anwar, and Z. Zhao. A privacy preservation model for Facebook-style social network systems. In ESORICS 2009. Springer, 2009.
8. P. W. Fong. Relationship-based access control: protection model and policy language. In ACM CODASPY, 2011.
9. P. W. Fong and I. Siahaan. Relationship-based access control policies and their policy languages. In ACM SACMAT, 2011.
10. C. E. Gates. Access control requirements for web 2.0 security and privacy. In Proc. of Workshop on Web 2.0 Security and Privacy (W2SP 2007), 2007.
11. S. Kruk, S. Grzonkowski, A. Gzella, T. Woroniecki, and H. Choi. D-FOAF: Dis-tributed identity management with access rights delegation. LNCS, 4185, 2006.
12. A. Masoumzadeh and J. Joshi. Osnac: An ontology-based access control model for social networking systems. In IEEE Social Computing (SocialCom), 2010.
13. J. Park, R. Sandhu, and Y. Cheng. Acon: Activity-centric access control for social computing. In Int. Conf. on Availability, Reliability and Security (ARES), 2011.
14. J. Park, R. Sandhu, and Y. Cheng. A user-activity-centric framework for access control in online social networks. Internet Computing, IEEE, 15(5), September-October 2011.
15. M. O. Rabin and D. Scott. Finite automata and their decision problems. IBM J. Res. Dev., 3, April 1959.
16. K. Thompson. Programming techniques: Regular expression search algorithm. Commun. ACM, 11, June 1968.
17. L. Backstrom, P. Boldi, M. Rosa, J. Ugander, and S. Vigna. Four degrees of separation. CoRR, abs/1111.4570, 2011.
18. S. Benferhat, R. El Baida, and F. Cuppens. A stratification-based approach for handling conflicts in access control. In Proceedings of the eighth ACM symposium on Access control models and technologies, SACMAT '03, pages 189-195, New York, N.Y., USA, 2003. ACM.
19. E. Bertino, S. Jajodia, and P. Samarati. Supporting multiple access control policies in database systems. ACM Transactions on Database Systems, 26:2001, 1996.
20. E. Bertino, S. Jajodia, and P. Samarati. A flexible authorization mechanism for relational data management systems. ACM Trans. Inf. Syst., 17(2):101-140, April 1999.
21. E. Bertino, P. Samarati, and S. Jajodia. Authorizations in relational database management systems. In Proceedings of the 1st ACM conference on Computer and communications security, CCS '93, pages 130-139, New York, N.Y., USA, 1993. ACM.
22. B. Carminati, E. Ferrari, R. Heatherly, M. Kantarcioglu, and B. Thuraisingham. A semantic web based framework for social network access control. In Proceedings of the 14th ACM symposium on Access control models and technologies, SACMAT '09, pages 177-186, New York, N.Y., USA, 2009. ACM.
23. B. Carminati, E. Ferrari, R. Heatherly, M. Kantarcioglu, and B. Thuraisingham. Semantic web-based social network access control. Computers and Security, 30(2C3):108-115, 2011. Special Issue on Access Control Methods and Technologies.
24. B. Carminati, E. Ferrari, and A. Perego. Rule-based access control for social networks. In R. Meersman, Z. Tari, and P. Herrero, editors, On the Move to Meaningful Internet Systems 2006: OTM 2006 Workshops, volume 4278 of Lecture Notes in Computer Science, pages 1734-1744. Springer Berlin/Heidelberg, 2006.
25. B. Carminati, E. Ferrari, and A. Perego. A decentralized security framework for web-based social networks. International Journal of Information Security and Privacy, 2(4):22-53, 2008.
26. B. Carminati, E. Ferrari, and A. Perego. Enforcing access control in web-based social networks. ACM Trans. Inf. Syst. Secur., 13(1):1-38, 2009.
27. Y. Cheng, J. Park, and R. Sandhu. A user-to-user relationship-based access control model for online social networks. In Proceedings of the 26th IFIP Annual WG 11.3 Conference on Data and Application Security and Privacy (DBSec '12), 2012.
28. F. Cuppens, N. Cuppens-Boulahia, and M. B. Ghorbel. High level conflict management strategies in advanced access control models. Electronic Notes in Theoretical Computer Science, 186(0):3-26, 2007. Proceedings of the First Workshop in Information and Computer Security (ICS 2006).
29. D. E. Denning, T. F. Lunt, R. R. Schell, W. R. Shockley, and M. Heckman. The seaview security model. In Proceedings of the 1988 IEEE conference on Security and privacy, SP '88, pages 218-233, Washington, D.C., USA, 1988. IEEE Computer Society.
30. P. Fong, M. Anwar, and Z. Zhao. A privacy preservation model for Facebook-style social network systems. In ESORICS 2009: Proceedings of 14th European Symposium on Research in Computer Security, Saint-Malo, France, Sep. 21-23, 2009, page 303. Springer, 2009.
31. P. W. Fong. Relationship-based access control: protection model and policy language. In Proceedings of the first ACM conference on Data and application security and privacy, CODASPY '11, pages 191-202, New York, N.Y., USA, 2011. ACM.
32. P. W. Fong and I. Siahaan. Relationship-based access control policies and their policy languages. In Proceedings of the 16th ACM symposium on Access control models and technologies, SACMAT '11, pages 51-60, New York, N.Y., USA, 2011. ACM.
33. C. E. Gates. Access control requirements for web 2.0 security and privacy. In Proc. Of Workshop on Web 2.0 Security and Privacy (W2SP 2007), 2007.
34. H. Hu and G.-J. Ahn. Multiparty authorization framework for data sharing in online social networks. In Proceedings of the 25th annual IFIP WG 11.3 conference on Data and applications security and privacy, DBSec '11, pages 29-43, Berlin, Heidelberg, 2011. Springer-Verlag.
35. S. Jajodia, P. Samarati, and V. S. Subrahmanian. A logical language for expressing authorizations. In Proceedings of the 1997 IEEE Symposium on Security and Privacy, pages 31-42, 1997.
36. S. Jajodia, P. Samarati, V. S. Subrahmanian, and E. Bertino. A unified framework for enforcing multiple access control policies. In Proceedings of the 1997 ACM SIGMOD international conference on Management of data, SIGMOD '97, pages 474-485, New York, N.Y., USA, 1997. ACM.
37. S. Kruk, S. Grzonkowski, A. Gzella, T. Woroniecki, and H. Choi. DFOAF: Distributed identity management with access rights delegation. Lecture Notes in Computer Science, 4185:140, 2006.
38. A. Masoumzadeh and J. Joshi. Osnac: An ontology-based access control model for social networking systems. In IEEE Social Computing (SocialCom), 2010.
39. S. Milgram. The small world problem. Psychology Today, 2(1):60-67, 1967.
40. J. Park, R. Sandhu, and Y. Cheng. Acon: Activity-centric access control for social computing. In Proceedings 5th International Conference on Availability, Reliability and Security (ARES), 2011.
41. J. Park, R. Sandhu, and Y. Cheng. A user-activity-centric framework for access control in online social networks. Internet Computing, IEEE, 15(5):62-65, September-October 2011.
42. F. Rabitti, E. Bertino, W. Kim, and D. Woelk. A model of authorization for next-generation database systems. ACM Trans. Database Syst., 16(1):88-131, March 1991.
43. H. Shen and P. Dewan. Access control for collaborative environments. In Proceedings of the 1992 ACM conference on Computer-supported cooperative work, CSCW '92, pages 51-58, New York, N.Y., USA, 1992. ACM.
44. A. C. Squicciarini, M. Shehab, and F. Paci. Collective privacy management in social networks. In Proceedings of the 18th international conference on World wide web, WWW '09, pages 521-530, New York, N.Y., USA, 2009. ACM.
45. J. Travers and S. Milgram. An experimental study of the small world problem. Sociometry, 32(4):pp. 425-443, 1969.
46. Facebook platform. http://evelopers.facebook.com/.
47. Opensocial. http://opensocial.org/.
48. P. Anthonysamy, A. Rashid, J. Walkerdine, P. Greenwood, and G. Larkou.

Collaborative privacy management for third-party applications in online social networks. In Proceedings of the 1st Workshop on Privacy and Security in Online Social Media, 2012.
49. A. Besmer, H. R. Lipford, M. Shehab, and G. Cheek. Social applications: exploring a more secure framework. In Proceedings of the 5th Symposium on Usable Privacy and Security, SOUPS '09, 2009.
50. B. Carminati, E. Ferrari, and A. Perego. Enforcing access control in web-based social networks. ACM Trans. Inf. Syst. Secur., 13(1), 2009.
51. Y. Cheng, J. Park, and R. Sandhu. Relationship-based access control for online social networks: Beyond user-to-user relationships. In Proceedings of the 4th IEEE International Conference on Information Privacy, Security, Risk and Trust (PASSAT), 2012.
52. Y. Cheng, J. Park, and R. Sandhu. A user-to-user relationship-based access control model for online social networks. In Proceedings of the 26th IFIP Annual WG 11.3 Conference on Data and Application Security and Privacy (DBSec '12), 2012.
53. M. Egele, A. Moser, C. Kruegel, and E. Kirda. Pox: Protecting users from malicious facebook applications. Computer Communications, 35(12), 2012.
54. A. Felt and D. Evans. Privacy protection for social networking apis. In Proc. Of Workshop on Web 2.0 Security and Privacy (W2SP '08), 2008.
55. P. W. Fong. Relationship-based access control: protection model and policy language. In Proceedings of the first ACM conference on Data and application security and privacy, 2011.
56. C. E. Gates. Access control requirements for web 2.0 security and privacy. In Proc. Of Workshop on Web 2.0 Security and Privacy (W2SP '07), 2007.
57. M. M. Lucas and N. Borisov. Flybynight: mitigating the privacy risks of social networking In Proceedings of the 7th ACM workshop on Privacy in the electronic society, WPES '08, 2008.
58. M. Shehab, A. Squicciarini, and G.-J. Ahn. Beyond user-to-user access control for online social networks. In L. Chen, M. Ryan, and G. Wang, editors, Information and Communications Security, volume 5308 of Lecture Notes in Computer Science. Springer Berlin/Heidelberg, 2008.
59. K. Singh, S. Bhola, and W. Lee. xbook: redesigning privacy control in social networking platforms. In Proceedings of the 18th conference on USENIX security'symposium, SSYM '09, 2009.
60. B. Viswanath, E. Kiciman, and S. Saroiu. Keeping information safe from social networking apps. In Proceedings of the 2012 ACM Workshop on online social networks, WOSN '12, 2012.
61. G. Bruns, P. W. Fong, I. Siahaan, and M. Huth. Relationship-based access control: its expression and enforcement through hybrid logic. In Proceedings of the second CODASPY, pages 117-124. ACM, 2012.
62. B. Carminati, E. Ferrari, R. Heatherly, M. Kantarcioglu, and B. Thuraisingham. A semantic web based framework for social network access control. In Proceedings of the 14th SACMAT, pages 177-186. ACM, 2009.
63. B. Carminati, E. Ferrari, and A. Perego. Rule-based access control for social networks. In OTM 2006 Workshops, pages 1734-1744. Springer, 2006.
64. B. Carminati, E. Ferrari, and A. Perego. Enforcing access control in web-based social networks. ACM TISSEC, 13(1):6, 2009.
65. Y. Cheng, J. Park, and R. Sandhu. Relationship-based access control for online social networks: beyond user-to-user relationships. In PASSAT 2012, pages 646-655. IEEE, 2012.
66. Y. Cheng, J. Park, and R. Sandhu. A user-to-user relationship-based access control model for online social networks. In DBSec 2012, pages 8-24. Springer, 2012.
67. P. W. Fong. Relationship-based access control: protection model and policy lan-guage. In Proceedings of the first CODASPY, pages 191-202. ACM, 2011.
68. P. W. Fong, M. Anwar, and Z. Zhao. A privacy preservation model for facebook-style social network systems. In ESORICS 2009, pages 303-320. Springer, 2009.
69. P. W. Fong and I. Siahaan. Relationship-based access control policies and their policy languages. In Proceedings of the 16th SACMAT, pages 51-60. ACM, 2011.
70. C. Gates. Access control requirements for Web 2.0 security and privacy. IEEE Web 2.0, 2007.
71. J. Golbeck and J. Hendler. Inferring binary trust relationships in web-based social networks. ACM Transactions on Internet Technology (TOIT), 6(4):497-529, 2006.
72. J. A. Golbeck. Computing and Applying Trust in Web-based Social Networks. PhD thesis, University of Maryland at College Park, College Park, Md., USA, 2005.
73. X. Jin, R. Krishnan, and R. Sandhu. A unified attribute-based access control model covering DAC, MAC and RBAC. In DBSec 2012, pages 41-55. Springer, 2012.
74. S. R. Kruk, S. Grzonkowski, A. Gzella, T. Woroniecki, and H.-C. Choi. D-FOAF: distributed identity management with access rights delegation. In The Semantic Web-ASWC 2006, pages 140-154. Springer, 2006.
75. A. Masoumzadeh and J. Joshi. OSNAC: an ontology-based access control model for social networking systems. In SocialCom 2010, pages 751-759. IEEE, 2010.
76. J. Park, R. Sandhu, and Y. Cheng. ACON: activity-centric access control for social computing. In Availability, Reliability and Security (ARES), 2011 Sixth International Conference on, pages 242-247. IEEE, 2011.
77. J. Park, R. Sandhu, and Y. Cheng. A user-activity-centric framework for access control in online social networks. Internet Computing, IEEE, 15(5):62-65, 2011.
78. H. Shen and F. Hong. An attribute-based access control model for web services. In PDCAT 2006, pages 74-79. IEEE, 2006.
79. E. Yuan and J. Tong. Attributed based access control (ABAC) for web services. In Proceedings of the IEEE ICWS, pages 561-569. IEEE, 2005.
80. L. Backstrom, P. Boldi, M. Rosa, J. Ugander, and S. Vigna. Four degrees of separation. CoRR, abs/1111.4570, 2011.
81. d. m. boyd and N. B. Ellison. Social network sites: Definition, history, and scholarship. Journal of Computer-Mediated Commu-nication, 13(1):210-230, 2007.
82. G. Bruns, P. W. Fong, I. Siahaan, and M. Huth. Relationship-based access control: its expression and enforcement through hybrid logic. In Proceedings of the second CODASPY, pages 117-124. ACM, 2012.
83. B. Carminati, E. Ferrari, and J. Girardi. Performance analysis of relationship-based access control in osns. In Information Reuse and Integration (IRI), 2012 IEEE 13th International Conference on, pages 449-456, 2012.
84. B. Carminati, E. Ferrari, R. Heatherly, M. Kantarcioglu, and B. Thuraisingham. A semantic web based framework for social network access control. In ACM SACMAT, 2009.
85. B. Carminati, E. Ferrari, R. Heatherly, M. Kantarcioglu, and B. Thuraisingham. Semantic web-based social network access control. Computers and Security, 30(2C3), 2011. Special Issue on Access Control Methods and Technologies.
86. B. Carminati, E. Ferrari, and A. Perego. Rule-based access control for social networks. In OTM 2006 Workshops, volume 4278 of LNCS. Springer, 2006.
87. B. Carminati, E. Ferrari, and A. Perego. Rule-based access control for social networks. In R. Meersman, Z. Tari, and P. Herrero, editors, On the Move to Meaningful Internet Systems 2006: OTM 2006 Workshops, volume 4278 of Lecture Notes in Computer Science, pages 1734-1744. Springer Berlin/Heidel-berg, 2006.
88. B. Carminati, E. Ferrari, and A. Perego. A decentralized security framework for web-based social networks. Int. Journal of Info. Security and Privacy, 2(4), 2008.
89. B. Carminati, E. Ferrari, and A. Perego. Enforcing access control in web-based social networks. ACM Trans. Inf. Syst. Secur., 13(1), 2009.
90. Y. Cheng, J. Park, and R. Sandhu. A user-to-user relationship-based access control model for online social networks. In Data and Applications Security and Privacy XXVI, pages 8-24. Springer, 2012.
91. P. W. Fong. Relationship-based access control: protection model and policy language. In Proceedings of the first CO-DASPY, pages 191-202. ACM, 2011.
92. P. W. Fong, M. Anwar, and Z. Zhao. A privacy preservation model for facebook-style social network systems. In Computer Security-ESORICS 2009, pages 303-320. Springer, 2009.
93. P. W. Fong and I. Siahaan. Relationship-based access control policies and their policy languages. In Proceedings of the 16th SACMAT, pages 51-60. ACM, 2011.
94. H. Gao, J. Hu, T. Huang, J. Wang, and Y. Chen. Security issues in online social networks. Internet Computing, IEEE, 15(4):56-63, 2011.
95. C. Gates. Access control requirements for Web 2.0 security and privacy. IEEE Web 2.0, 2007.
96. M. Hart, R. Johnson, and A. Stent. More content-less control: Access control in the Web 2.0. IEEE Web 2.0, 2007.
97. S. R. Kruk, S. Grzonkowski, A. Gzella, T. Woroniecki, and H.-C. Choi. D-FOAF: Distributed identity management with access rights delegation. In The Semantic Web-ASWC 2006, pages 140-154. Springer, 2006.
98. A. Masoumzadeh and J. Joshi. OSNAC: An ontology-based access control model for social networking systems. In Social-Com 2010, pages 751-759. IEEE, 2010.
99. S. Milgram. The small world problem. Psychology today, 2(1):60-67, 1967.
100. J. Park, R. Sandhu, and Y. Cheng. ACON: Activity-centric access control for social computing. In Availability, Reliability and Security (ARES), 2011 Sixth International Conference on, pages 242-247. IEEE, 2011.
101. J. Park, R. Sandhu, and Y. Cheng. A user-activity-centric framework for access control in online social networks. In-ternet Computing, IEEE, 15(5):62-65, 2011.
102. M. O. Rabin and D. Scott. Finite automata and their decision problems. IBM journal of research and development, 3(2): 114-125, 1959.
103. K. Thompson. Programming techniques: Regular expression search algorithm. Communications of the ACM, 11(6):419-422, 1968.
104. J. Travers and S. Milgram. An experimental study of the small world problem. Sociometry, 32(4):425-443, 1969.
105. J. Ugander, B. Karrer, L. Backstrom, and C. Marlow. The anatomy of the facebook social graph. CoRR, abs/1111.4503, 2011.

The system as described herein may be comprised of a processor, a network interface, a data storage device, and memory.

The disclosed system and method of use is generally described, with examples incorporated as particular embodiments of the invention and to demonstrate the practice and advantages thereof It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications of the disclosed system and method of use are directed to resource management of physical and data systems.

Consequently, any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods disclosed and claimed herein can be made and executed without undue experimentation in light of the present disclosure. While the system and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A relationship-based sharing control system comprising:
a computing device configured to receive an action from an accessing user having a first user device; said computing device configured to apply relationship-based access controls that are user-to-user, user-to-resource, and/or resource-to-resource, and determine whether to grant received action.

2. The system of claim 1, wherein the relationship-based access controls are further configured by a model comprising the components of accessing user, action, target user, target resource, and control user.

3. The system of claim 1, wherein the relationship-based access controls is further configured by system wide policies.

4. The system of claim 1, wherein the relationship-based access controls is further configured by target resource policies.

5. The system of claim 1, wherein the relationship-based access controls is further configured by target user policies.

6. The system of claim 1, wherein the relationship-based access controls is further configured by accessing user policies.

7. The system of claim 3, wherein the system wide policies is further comprised of system policies for users and system policies for resource.

8. The system of claim 1, wherein the relationship-based access controls is further configured by system wide policies, target resource policies, target user policies, and accessing user policies.

9. The system of claim 1, wherein the relationship-based access controls is further configured by system wide policies comprised of system policies for user and system policies for resource, target resource policies, target user policies, and accessing user policies.

10. The system of claim 1, wherein the relationship-based access controls are further configured by a model comprising the components of accessing user, action, target user, target resource, and control user and wherein the relationship-based access controls is further configured by system wide policies comprised of system policies for user and system policies for resource, target resource policies, target user policies, and accessing user policies.

11. The system of claim 3, wherein said system wide policies are defined by an expression based policy specification language.

12. The system of claim 4, wherein said target resource policies are defined by an expression based policy specification language.

13. The system of claim 5, wherein said target user policies are defined by an expression based policy specification language.

14. The system of claim 6, wherein said accessing user policies are defined by an expression based policy specification language.

15. The system of claim 9, wherein said system wide policies comprised of system policies for user and system policies for resource, target resource policies, target user policies, and accessing user policies are defined by an expression based policy specification language.

16. The system of claim 10,
wherein the relationship-based access controls are further configured by a model comprising the components of accessing user, action, target user, target resource, and control user and;
wherein the relationship-based access controls is further configured by system wide policies comprised of system policies for user and system policies for resource, target resource policies, target user policies, and accessing user policies and;
wherein said system wide policies comprised of system policies for user and system policies for resource, target resource policies, target user policies, and accessing user policies are defined by an expression based policy specification language.

17. The system of claim 1, wherein said relationship-based access controls are applied to administrative activities.

18. The system of claim 1, wherein said relationship-based access controls is further configured by system wide policies, target resource policies, target user policies, and accessing user policies and wherein aforementioned policies are applied to administrative activities.

19. The system of claim 1, wherein said relationship-based access controls is further configured by system wide policies, target resource policies, target user policies, and accessing user policies and wherein aforementioned policies are based on patterns of relationship paths on social graphs and the hopcount limits of these paths.

20. A relationship-based sharing control system method comprising:
the first step of a computing device receiving an action from an accessing user having a first user device; said computing device applying relationship-based access controls that are user-to-user, user-to-resource, and/or resource-to-resource to said action, and determining whether to grant said received action.
